(19) United States
(12) Patent Application Publication
(10) Pub. No.: US 2007/0277152 A1
(43) Pub. Date: Nov. 29, 2007

(54) Self-scheduled real time software using real time asynchronous messaging

(75) Inventor: Chitoor V. Srinivasan, Port Saint Lucie, FL (US)

Correspondence Address: Chitoor V. Srinivasan, 2031 SE Kilmallie court, Port Saint Lucie, FL, 34952, US

(73) Assignee: EDSS., Inc., Port Saint Lucie, FL (US)

(21) Appl. No.: 11/809,445

(22) Filed: May 31, 2007

Related U.S. Application Data
(63) Continuation-in-part of application No. 11/320,455, filed on Dec. 28, 2005.

(51) Int. Cl. G06F 9/44; G06F 15/16

(52) U.S. Cl. 717/119; 709/230; 717/124

(57) ABSTRACT

TICC™ (Technology for Integrated Computation and Communication), a patented technology [1], provides a high-speed message-passing interface for parallel processes. TICC™ does high-speed asynchronous message passing with latencies in the nanoseconds scale in shared-memory multiprocessors and latencies in microseconds scale over distributed-memory local area TICCNET™ (Patent Pending, [2]. Ticc-Ppde (Ticc-based Parallel Program Development and Execution platform, Patent Pending, [3]) provides a component based. parallel program development environment, and provides the infrastructure for dynamic debugging and updating of Ticc-based parallel programs, self-monitoring, self-diagnosis and self-repair. Ticc-Rtas (Ticc-based Real Time Application System) provides the system architecture for developing self-scheduled real time distributed parallel processing software with real-time asynchronous messaging, using Ticc-Ppde. Implementation of a Ticc-Rtas real time application using Ticc-Ppde will automatically generate the self-monitoring system for the Rtas. This self-monitoring. system may be used to monitor the Rtas during its operation, in parallel with its operation, to recognize and report a priori specified observable events that may occur in the application or recognize and report system malfunctions, without interfering with the timing requirements of the Ticc-Rtas. The structure, innovations underlying their operations, details on developing Rtas using Ticc-Ppde and TICCNET™ are presented here together with three illustrative examples: one on sensor fusion, the other on image fusion and the third on. power transmission control in a fuel cell powered automobile.

### BACKGROUND AND SUMMARY OF INVENTION

Real time software systems (Rtas) [4,5] are increasingly being based on Actor-models [9,10]. Actors receive and respond to asynchronous messages that arrive at their input buffers. Messages in the buffers may be serialized based on time stamps that specify the origination time of the messages, Actors would be activated by a scheduler, to receive and respond to messages at the input buffers at the right times. The scheduler itself would be usually managed by an operating system that is not a part of the Rtas. It is common to refer to a (message, time stamp) pair (m, t) as an event. The scheduler will thus determine the temporal order in which events are processed in an Rtas by Actors and impose a causal relationship among events in an Rtas that is consistent physical requirements, in order to correctly model (or control) the physic system that the Rtas is intended to model. The objective is to use the Rtas either to simulate operations of the physical system it is modeling or use it to control, direct and coordinate activities in the physical system. For example, the software system could be a flight simulator, or it could be a part of the aircraft flight control system, which is used to relay messages from a pilot to various part of the aircraft to control and regulate its flight, or it could be a part of a fighter aircraft which automata responds to potential enemy threats as detected from messages recess from a distributed sensor systems, or it could be a part of an interplanetary satellite navigation and control, or robotic system.

All operations in such systems are time critical and cost of errors caused by software bugs could be prohibitive. Producing real time software systems that are certified bug free and are guaranteed to operate correctly is an extremely expensive time consuming enterprise. This invention proposes a method for developing self Rtas using TICC [1] Cells. Cells are automatically activated by receipt of messages at their inputs, in an environment in which messages are delivered asynchronously to the cells within a priori known time bounds, and messages are transmitted immediately as soon as they are ready. We refer to this as real time messaging. Cells in the Ticc-model of Rtas replaces Actors used in the Actor mode. It offers the advantages:
1. Cells in a Ticc-based Rtas (Ticc-Rtas) may communicate with each other asynchronously, in parallel with each other; at any time.
2. Each cell may receive simultaneously several messages in parallel without buffer contention.
3. Communication will be in real time in the following sense:
   i. Messages may be exchanged immediately as soon as they are generated with precisely predicable latencies of the order of nanoseconds in shared environments with 2-gigahertz CPU's and 100 megabits/sec memory bus, or a few microseconds in distributed-memory environments, without need for synchronization sessions or resolution of resource contentions; as many as a trillion bytes of data may be transmitted in every 100 seconds using 10-gigabytes/sec transmission lines, over a geographical area with 300 kilometers diameter.
   ii. Cells that receive messages would be automate activated by receipt of the messages and would respond to the messages appropriately after they are received in a manner that is consistent with the requirements of real time operation of the physical system that is being modeled, thereby eliminating the need for schedulers, and
   iii. Cells in an Rtas together with communication pathways that interconnect them would constitute the Rtas-work. Message traffic in this network would determine the causal relationship among events that may occur in the Rtas and their temporal ordering. By suitably designing this network, one may guarantee that causality among events in an Rtas and their temporal ordering would always faithfully reflect causal and temporal ordering of corresponding observable events in the physical system that is being modeled or controlled by the Rtas.
4. The Ticc-Rtas design and development platform provides a three stage design and development process Stage (i) Design and development Rtas-network and specification of cell interactions in the Rtas, Stage (ii) design and programs executed by the cells, and Stage (iii) System integration and certification.
   i. Design and development of Rtas-network and cell interactions: Rtas-network is specified by defining needed cell subclasses in an object oriented programming language, and installing instances of cells and pathways that interconnect them in the Rtas-network. Not all programs executed by cells would be defined at this stage; only cell interactions would be defined. Cell interactions are specified at a level of abstraction chosen by a system designer in an executable programming language of the programs that cells might execute to receive and process messages. Programs executed by cells to receive and process messages are called pthreads, for parallel threads, no pthread would ever contain statements that refer to cell interactions. Thus, pthreads and interaction specifications would constitute two distinct and mutually independent parts of an Rtas.
   Interaction specifications may be executed using simulated pthread execution times, before the pthreads are defined. Such interaction executions are called “design test and verification runs”. The design test and verification runs may be used to determine required timing bounds for communication latencies; timing bounds for pthreads, and synchronization/coordination requirements that the network should satisfy in order to correctly perform its functions. The design test runs may also be used to determine input/output constraints, which pthreads shod satisfy. Based on these runs a designer may modify the network and go through several such design/modification and verification cycle before the Rtas-network is finalized.
   ii. Design and implementation of Pthreads: Since no pthread would contain statement specifying cell interactions, they will all be passe mutually independent of each other. Thus, each pthread may be designed, implemented, tested and verified independently of all other pthreads. Each pthread would be designed and implemented to satisfy the timing and input/output constraints developed for it in the design test and verification runs.
   iii. System Integration and Certification: Once all the pthreads needed for an Rtas are implemented and tested, simulated execution of cell interaction specifications may be replaced with executions that actually run the implemented pthreads. One may then test the integrated Rtas for race conditions and resource sharing conflicts and modify the Rtas-network to eliminate them. This may, of course, require one to go through the entire design cycle, repeating steps (i), (ii) and (iii). After this is done, the Rtas may be tested for certification.
This three-stage process simplifies program development and system certification, and can shrink the time needed for system development and certification, and costs associated with them.

Ticc-Rtas uses TICC™ (Technology for Integrated Computation and Communication) [1] and TICCNET™ [3] for distributed memory communications, and Ticc-Ppde (Ticc-based Parallel program development and execution platform) [2] for parallel program d it. For each fully specified Rtas, Ticc-Ppde will automatically construct an event monitoring and reporting subsystem, called Rtas Self-monitoring system, which may be used to monitor specified events and report their occurrence in the Rtas while it is running, and also monitor and report deviations in event timings, if any, from their defined specifications. This will work in parallel with the Rtas without distorting its timing characteristics.

### DRAWINGS

FIG. 1: Structure of Cell

FIG. 2: Structure of virtual Memory

FIG. 3: A Ticc-network.

FIG. 4: Simple point-to-point TICCNET™ pathway

FIG. 5: Semantics of CCP; FIG. 5A: Augmented Sequential Machine

FIG. 6: Port Dependencies

FIG. 7: TICC™ and Conventional Systems

FIG. 8: Π-Calculus Components

FIG. 9: A point-to-point TICCNET™ pathway

FIG. 10: State diagrams of non-deterministic Sequential Machines for Network Agents and Ports

FIG. 11: A Group-to-Group shared-memory Pathway

FIG. 12. Group-to-Group Distributed Memory Pathway

FIG. 13. A fragment of Network Switch Array, NSA

FIG. 14. State diagram of non-deterministic sequential machine of a network switch

FIG. 15. Dedicated network pathways between L.config and Y[i].config for 1≦i≦(N−1)

FIG. 16. interconnections between Y[i].config and other cells in Y[i]

FIG. 17. Path from Y[i].config to interruptPorts of Source Probe

FIG. 18. Network Arrangement for communication with eb-cell.

FIG. 19. Sequential Machines used for signaling the self-monitoring system

FIG. 20. A typical processing cell in a sensor fusion network

FIG. 21. Image Fusion Network

FIG. 22. Network for Power Regulation in a fuel cell driven automobile

FIG. 23. Network for the Producer/Consumer Solution

FIG. 24. Networks used for Parallel FFT

FIG. 25. Synchronization with external events

FIG. 26. Synchronizing the start of a sequential computation

FIG. 27. Synchronization of parallel computations in more than one sequential ring

FIG. 28. Network Arrangement for Dynamic Updating

FIG. 29. Simple Events at a generalPort Group

FIG. 30. FunctionPort group F spawns new Computations

FIG. 31 Group-to-group spawning with port-vectors

FIG. 32 Illustrating complex interactions

FIG. 33 Alleop for Sensor Fusion

FIG. 34 Alleop for Producer/Consumer Solution

FIG. 35 Alleops for Non-scalable and Scalable FFTs in FIG. 24.

FIG. 36 Forks

FIG. 37 Alleop Structures

FIG. 38 Loop Structures in an Alleop

FIG. 39 Illustrating expansion of an iteration loop.

FIG. 40 Lattice ALLEOP(N) [c₁,c₂, . . . cₙ]

FIG. 41 A network dependency Ring and External Triggering

FIG. 42 Illustrating local dependencies, which should be removed

### 1. INTRODUCTION

We propose here a fundamental shift in programming methodology to build self-scheduled self-synchronized distributed real-time parallel processing software with real-time asynchronous messaging. The objective is to simplify parallel programming, and realize scalability, high efficiencies and verifiability. The methodology is based on TICC™¹, a new Technology for Integrated Computation and Communication, where the dichotomy between computation and communication is eliminated. Component units, called cells, perform both computations and communications, and computations are performed not just by the CPU's that run the cells, but also by hardware embedded in a distributed communication network. The entire network is the computer and it can function with no need for an operating system to coordinate and manage its computations.
¹ Patented, Chitoor V. Srinivasan, TICC™, “Technology for Integrated Computation and Communication”, U.S. Pat. No. 7,210,145, patent issued on Apr. 24, 2007, patent application Number 102,655/75, dated Oct. 7, 2002, International patent application under PCT was filed on Apr. 20, 2006, International application No. PCT/US2006/015305.

TICC™ introduces two new programming abstractions: One is Causal Communication Primitive (CCP) and the other is pathway. CCPs are used to specify exchange of signals between any two software/hardware components. Ability to exchange signals programmatically between software/hardware components has a significant potential to dramatically change the programming landscape, by enabling direct communications between software and hardware, which lead to new ways of organizing software and hardware. For example, it eliminates the need to use operating system (OS) for many tasks. The Parallel Program Development and Execution platform (TICC™-Ppde²) does not use OS for task scheduling, process and pthread (parallel thread) activations, interrupt handling, managing communications, enforcing data security, resource allocations, synchronization, coordination, etc. Yet, it simplifies parallel program development, verification and maintenance cycles for any kind of software, even if it is a real time or embedded software.
² Chitoor V. Srinivasan, Ticc-Ppde, “Ticc-based Parallel Program Development Execution platform”, “Patent Pending, patent application Ser. No. 11/320,455, filed Dec. 28 2005; published on Jul. 13, 2006, publication number US2008-0156284-A1. International patent application under PCT was filed on Feb. 22, 2006, International application No. PCT/US2006/006067.

In the rest of this paper, we shall explore TICC™ in more detail. It is at the heart of the system. The begin in Section 2 with an overview, introducing pathways and defining the semantics of CCPs. A major part of this paper is devoted to specification of TICC™ protocols using CCPs embedded in TIPs (Thread Interaction Primitives). Section 3 introduces the TIP formats and CIP (Cell Interaction Protocols) structure. Section 4 compares TICC™ architecture with those of other systems. Section 5 introduces the unique features of pathway protocols for shared-memory and distributed-memory communications. Section 6 introduces augmented protocols defined in TICC™-Ppde and the concept of self-monitoring system.

Section 7 presents three examples of Rtas (Real time application system), sensor fusion, image fusion and automobile power transmission control in a fuel cell driven power system, and two simple parallel programs: Producer/Consumer problem solution and FFT (Fast Fourier Transform). Section 8 describes synchronization facilities provided in TICC™. Section 9 summarizes the significant characteristics of TICC™ and TICC™-Ppde, which are later used in Section 11 for establishing the semantics of TICC-Ppde programs and the self-monitoring system. Section 10 illustrates the structure of parallel computations as they are captured by activity diagrams and introduces the concept of Allowed Event Occurrence Patterns (Alleops). Section 11 defines the denotational fixed point semantics of TICC™-Ppde programming paradigm. Section 12 establishes conditions for scalability and illustrates use of scalability conditions in two applications: one for the producer/consumer problem and the other for parallel FFT (Fast Fourier Transform). Section 13 concludes the manuscript with comments on what has been done and its consequences.

### 2. AN OVERVIEW

TICC™-Ppde uses two languages to specify two functionalities. Both are deterministic sequential programming languages. The first languages is used to specify interactions among cells using Thread Interaction Primitives (TIPs). TIP uses guarded statements [6,7] in a format similar to Π-Calculus [8]:
Asynchronous TIP: f:mR?( ){f:r( ).s( );}, (1a)
Synchronous TIP: f:mR?( ){f:r( ).s( );}, (1b)
where f is a functionPort of a cell, f:mR?( ) (‘mR?’ for ‘messageReady?’) is the guard and f:r( ).s( ); =f:r( ); f:s( ); is the body of the TIP. At the time a cell polls its port f, if f:mR?( ) is true then there is a pending service request message at port f, in a designated memory associated with the port. The cell then executes the body of the TIP: f:r( ) (‘r’ for ‘respond’) invokes and executes the pthread (parallel thread) to process and respond to the service request, based on the message subclass of the service request using the polymorphism feature of the underlying OO-language. Then, f:s( ) (‘s’ for ‘send’) sends off the response message, written into the designated memory of f, back to the port g that sent the service request using the same pathway through which it received the service request. f:s( ) uses pathway protocols that are defined using CCPs. Cell executes f:s( ) by itself without assistance from the operating system (OS) or any other process or thread. Message is sent immediately, as soon as it is ready with latencies of the order of 350 nanoseconds in a 2-gigahertz computer.

If f:mR?( ) is false then the cell immediately abandons the TIP and proceeds to poll one of its other ports.

In the case of the synchronous TIP, f:mR?^{⋆}( ) specifies that the cell should wait for a service request message and respond to it when it arrives. Asynchronous TIPs define asynchronous computations and synchronous TIPs define synchronous computations. Other kinds of TIPs spawn new computations, fork and join pthreads, and gather and share resources. They are discussed in Section 3.

A TICC™-network is a collection of cells interconnected by pathways connected to ports attached to them. A collection of packaged pathway and protocol components needed for any parallel program implementation is provided to an application programmer by TICC™-Ppde. TIP formats are independent of pthread, pathway, protocol and message definitions. TIPs only specify interactions among pthreads. Pthreads will be free of interaction statements, since all interactions are specified by TIPs. Thus, pthreads are mutually independent and may therefore be independently verified.

TIPs use virtual functions, like f:r( ), to refer to pthreads. Messages are defined at the time pthreads are defined and integrated with the TICC-network and TIPs. Each port of a cell will have a TIP defined for it. The collection of all TIPs for a cell together with its initialization method is called the Cell Interaction Protocol (CIP).

System design thus involves three independent components: TICC™-network definition (this defines the cells and pathways that interconnect them), CIP definition for each cell subclass in the TICC™-network, and pthread and message definitions. TIPs may be executed with simulated pthread execution timings to check and verify coordination in a TICC™-network.

Once a system design for an application is completed, TICC™-Ppde automatically generates a self-monitoring system for the application, which monitors the application in parallel with it while it is running. It can detect patterns of behavior that call for alarms to be issued, and detect and report even unanticipated system malfunctions. It can be used as the basis to develop self-diagnosis and self-repair facilities for an application system.

The two abstractions, pathway and CCP (Causal Communication Primitive) make it possible to Integrate independently defined TICC™-network, TIPs, pthreads, protocols and messages into a well organized application. We introduce these in the next subsection.

2.1. Software Signaling and CCPs

It is common practice in hardware systems to use signals to control, synchronize and coordinate activities. In synchronous hardware, time signals are used and in asynchronous hardware, start and completion signals are used. What if one introduced a programming primitive, similar to assignments, which can be executed very fast and can be used to assign (send) signals to software and hardware components? Then, in principle, it should be possible to run software directly on a hardware network with out the need to use an operating system, by programmatically controlling signal exchanges between software and hardware components. This is what we try to do with Causal Communication Primitives, CCPs.

This idea was first proposed by B. Gopinath [14], and S. Das [15] first defined the structure of pathways used here. They implemented their systems in a single processor with interrupt control for concurrent thread activation and scheduling. Interrupt driven scheduling and activation introduced non-determinism in message exchanges. Messages could not be delivered within bounded latencies and messages were sometimes missed. Gopinath and Das did not introduce the concept of Causal Communication Primitives (CCPs) and the concept of defining pathway protocols using CCPs. The signal exchange protocols used in TICC™ are different from the ones used by Gopinath and Das. TICC™ adapts and modifies the framework introduced by Gopinath and Das for application to parallel programming of distributed real-time systems in the context of an object oriented programming language.

Use of CCPs is intimately tied to the concept of pathways through which signals and data travel. Therefore, we begin with an introduction to pathways.

2.2. Introduction to Pathways: Cells, Ports, Agents and VirtualMemories

Ports that send service requests are called generalPorts, g; each generalPort will receive a response message for each service request it sends. Ports f that receive service requests and respond to them are called functionPorts. InterruptPorts, i, constitute a subclass of functionPorts that receive and respond only to interrupt messages. Every cell should have at least one port g, one f and one i. Each port may be attached to only one cell, called the parent cell of the port (prevents port contention). As a rule, attached components may freely share each others data.

[image]

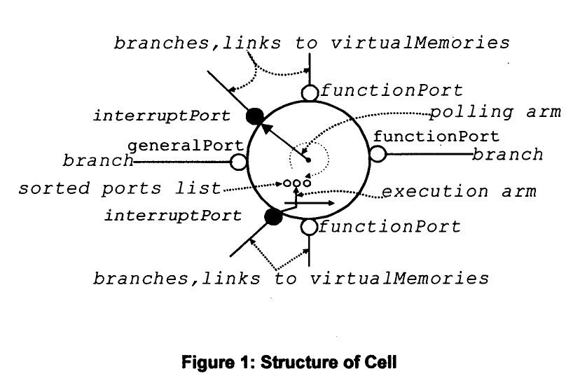

Each port comes with exactly one branch, as shown in FIG. 1. The port is connected to a pathway by connecting its branch to an agent on the pathway. Each port may thus be connected to only one pathway (prevents message interference). The port holds the CCP-protocol for message transfer through the pathway that is connected to it. These CCP-protocols cause signals to be exchanged among the components of a pathway and travel over pathways that connects port pairs, (g,f).

The pathway connecting a pair (g,f) will always be unique. Message sent by one port is delivered to the other when the protocol defined at the sending port is executed by its parent cell. Every pathway in a shared-memory environment has a unique designated memory associated with it. In a distributed memory environment, each pathway interconnecting two or more machines in a network, will have one designated memory in each machine. These designated memories are called virtualMemories.

VirtualMemories hold messages, and pthreads used to respond to and construct messages. They provide execution environments for pthreads. The designated memory of a port of a cell is the same as the virtualMemory of the pathway connected to that port. Real memories, message subclasses and pthreads are allocated to virtualMemories during initialization time.

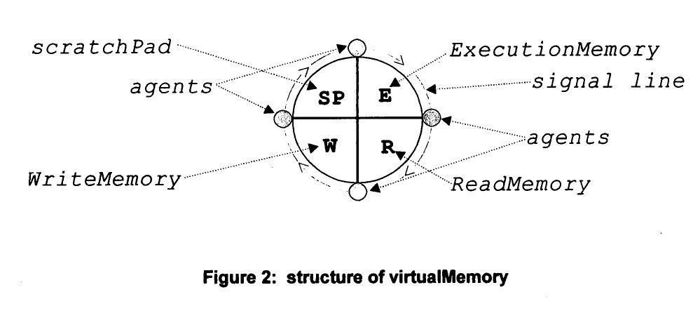

FIG. 2 shows the structure of virtualMemories. It has a readMemory R, a writeMemory W, a scratchPad SP and an executionMemory E. Messages delivered to ports are always in R, messages sent out are always in W, SP is used to exchange intermediate data by groups of cells that use the same virtualMemory, and E provides execution environment for pthreads. When a message is delivered to a port, R and W are switched. Thus, every port will read its input message from R.

Each virtualMemory has one or more agents attached to it. Agents route messages, enforce data security, coordinate message transfers and synchronize them, activate processes, communicate with the self-monitoring system and coordinate dynamic updates. No agent may be attached to more than one virtualMemory, but each virtualMemory may have many agents attached to it. Agents attached to the virtualMemory are connected by h-branches (hidden branches). They exchange signals via h-branches.

Every cell operates concurrently and autonomously in its own assigned CPU (or microprocessor), in parallel with other cells in a network. Cells are thus endowed with intrinsic concurrency.

Each cell may have several ports. Thus, each cell may be connected to several pathways. Each cell may simultaneously receive several messages, one via each one of its ports. Each one of these messages will reside in the readMemory of the pathway that delivered the message, until it is responded to. The parallel messages delivered to a cell at its ports will have no intrinsic order associated with them. There is no buffer contention. The cell is free to impose any order it chooses on pending messages at its ports. While it polls its ports, it will install the ports with pending messages in the ordered ports list shown in FIG. 1 and execute them in that order. This order may be determined by time stamps associated with the messages or any other ordering criteria chosen by the cell. The order chosen by a cell may be changed at any time by interrupt signals received by a cell. Such an interrupt might result, for example, based on event patterns recognized in the activity diagram of the self-monitoring system.

Once a pending message had been responded to, the port will be removed from the ordered ports list. When the list is cleared, the cell will start its next polling cycle. While processing a message at one of its ports, the cell will use the virtualMemory of the pathway connected to that port to execute the pthread needed to respond to that message. No cell may be interrupted while it is servicing a pending message. Besides this, the only other requirement is that in every polling cycle each cell executes all pending messages in its ordered ports list, before starting the next cycle.

Usually, it takes about 10 to 100 microseconds to execute a pthread in a 2-gigahertz computer. Use of low grain sizes without loss of efficiency is made possible by message exchange latencies in the hundreds of nanoseconds range. All activities of agents and ports in a pathway are programmatically controlled through CCPs that cause signals to be exchanged among them. In shared-memory environments, cells, ports and agents are all software components. In distributed memory environments, some of the agents are hardware components implemented by embedded microprocessors. Cells and virtualMemories may be software or hardware components.

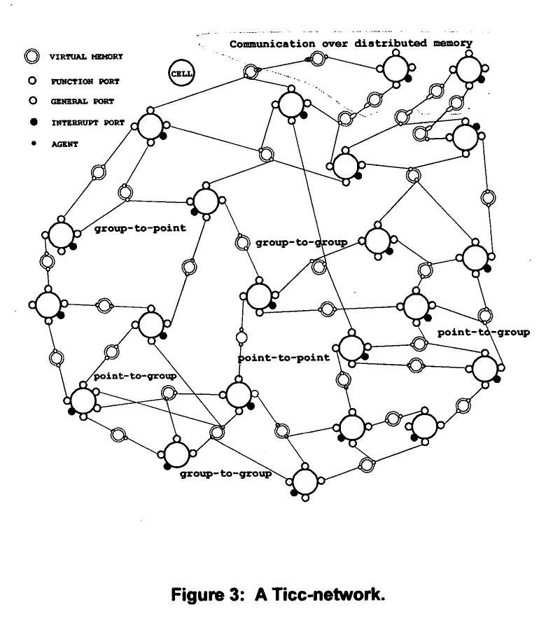

A TICC™-network is a collection of cells whose ports are interconnected by pathways. As shown in FIG. 3, an agent may be connected to several ports, each belonging to a distinct cell. Ports thus connected to the same agent form an ordered port-group. Clearly, no port may belong to more than one port-group and all ports in a port-group will share the same designated memory. Ports in a port-group should be the same kind of ports, all generalPorts, or all functionPorts or all interruptPorts. Thus, in general, a pathway will interconnect pairs, (G, F), where G is a group of generalPorts and F is a group of functionPorts. The group-to-group pathway protocol guarantees coordinated, synchronized message transfers between G and F.

[image]

On the top right corner of FIG. 3 there are pathways, which connect ports of cells via TICCNET™³ (TICC™-based wide area network) pathways. These pathways contain two virtualMemories each, one in the message sending machine and other in the message receiving machine. The two virtualMemories on each TICCNET™ pathway are connected to each other by an h-branch.
³ Patent Pending, Chitoor V. Srinivasan, “TICCNET™: Network Communications using TICC”, Patent Pending, Provisional Patent Application number 60/851,164, dated Oct. 13, 2006.

One or more virtualMemories interconnected by h-branches, together with all branches connected to all of their agents is a pathway. No two pathways will share branches, ports, agents or h-branches in common; thus, no two pathways will intersect with each other (isolates pathways).

Each TICC™-network is a digraph defined by the triplet <C,M,B>, where C is a set of cells, whose ports are connected to agents on a set of virtualMemories, M, by a set of branches, B, one for each (port, agent) pair. This characterization ignores the h-branches, which are internal to the virtualMemories. Only signals will travel through branches and h-branches.

As a rule, pairs of components, whether software or hardware, connected by a branch or h-branch are tuned to each other. Such tuned pairs always listen to each other at the right times, so that each may immediately receive and respond to a signal sent by the other at any time. This facilitates high-speed message transmissions over pathways with no need for synchronization sessions.

Cells, ports and pathways may be dynamically installed/removed in a TICC™-network. Pathways may be dynamically moved from one set of ports to another set of ports, thus introducing mobility.

With this brief introduction, we may now proceed to introduce CCPs.

2.3. Semantics of CCPs

Each CCP is of the form, ‘X:x→Y;’, where x is a cell, port or an agent, x is a one or two bit software or hardware signal and Y is a port or an agent. There are two kinds of signals: start and completion signals; each may have up to two subtypes defined for it. Each CCP is like an assignment; it assigns (sends) a signal to an agent or port. Agents and ports to which signals are sent are 2-state non-deterministic finite state machines with states, s for send and R for receive. On receipt of a signal, they change state and send out an appropriate signal to the next machine on the pathway. Thus, execution of CCPs in a protocol causes signals to travel along a pathway and eventually establish a context in which message in the virtualMemory of the pathway is delivered to its recipients.

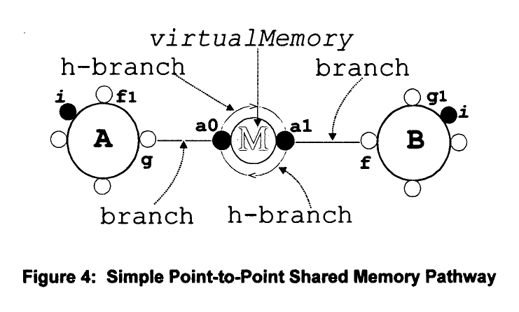

A point-to-point shared-memory pathway is shown in FIG. 4. The pathway connects port g of cell A to port f of cell B. It contains the virtualMemory M with two agents a0 and a1, which are connected to each other by h-branches. Each port is connected to one of the agents by a branch. The pathway from port g to port f is [g,a0,a1,f] and the pathway from port f to port g is [f,a1,a0,g]. Agents and ports on the pathway are tuned to each other, so that each can receive and immediately respond to signals sent by another, with no need for dynamic state checking and synchronization sessions. As we shall see, this holds true for all pathways in TICC™.

[image]

The protocol at port g for message transmission over this pathway is a sequence of four CCPs, as shown in (2), with the method a1:swm( ), ‘swm’ for ‘switch memories’, embedded in it. This switches the read/write memories of the virtualMemory M.
A:c→g:c→a0:s→a1:swm( ).s→f; (2)

Let us first consider the sequential machine model for CCPs, without ‘a1:swm( )’ embedded in it, and later see how such embedded methods are incorporated into the sequential machine model. One may rewrite (2) in TIP format as,
g:tC?*( ){g:c→a0:s→a1:swm( ).s→f;} (3)
where g:tC?*( ) (‘tC?’ for ‘taskCompleted?’) becomes true when port g receives the completion signal. The ‘*’ in g:tC?*( ) indicates that g is waiting for this signal.

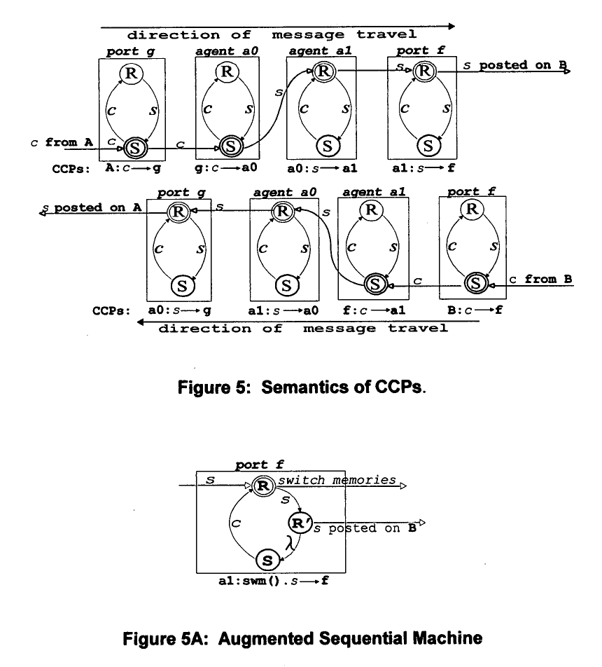

The parent cell of port g executes the protocol in (2) to send message over the pathway. This causes the signal transmission shown in the top row of FIG. 5. Double-circled states in FIG. 5 are the initial states. The CCP, A:c→g, causes the port sequential machine to forward the completion signal c to a0 and move from its state s to state R. Successive sequential machines do similar operations when they receive a signal from the previous machine, as shown in the top row of FIG. 5. This causes the state of the pathway to change from [S,S,R,R] to [R,R,S,S]. In this new state, the pathway is ready to transmit message from port f back to port g. The protocol for the response message transmission is,
f:tC?*( ){f:c→a1:s→a0:swm( ).s→g;} (4)
The parent cell of port f executes (4) to send back the response message. Message transmission occurs as shown in the bottom row of FIG. 5. This puts the state of the pathway back to [S,S,R,R].

[image]

Augmentation of the two state machine for agent a1 is shown in FIG. 5A. Here R sends the ‘switch memories’ signal to some unit, hardware or software, that switches memories, and moves to R′. R′ posts the start signal and then moves over to s; λ is the null-symbol that causes this internal state transition from R′ to S. In Sections 5 and 6 we will encounter a variety of augmentations, for a variety of pathways, all of which may FIG. 5A: Augmented Sequential Machine be understood in terms of signaling by hidden states, as shown in FIG. 5A.

[image]

As mentioned earlier, no two pathways will share components and this holds true for all TICC™-pathways. Thus, no two protocols will interfere with each other, when executed in parallel. Thus, the number of parallel messages that may be sent over a TICC™-network would be limited only by the number of cells in that network. This contributes to scalability.

A pathway connected to a port will be ready to send a message only if that port is in state S. Thus, after sending its service request, port g can send its next service request only after it had received a response to its first request. We will say, a transaction is successfully completed when response is delivered back to port g. Once started in the initial state [S,S,R,R], successive transactions will maintain the pathway in the same initial state.

Maintaining such an invariant initial state for a pathway is called tuning. This kind of tuning holds true in TICC™ for all shared-memory and TICCNET™ pathways. Tuning is not just an incidental characteristic of the above pathway. Tuning is enforced by the format of TIPs and by the structure and operation of the non-deterministic sequential machines. TIP formats would guarantee that no cell would ever attempt to send a message via a port, unless the pathway connected to that port was ready and every service request message receives a response and thus completes the transaction.

The sequential machines in FIG. 5 are non-deterministic only because state transitions and outputs are not defined for the machines for all possible inputs, and they may contain hidden states. Again, tuning enforced by the transaction convention and the TIPs would guarantee that no component on a pathway would ever get a signal, when that component is not in the right state to receive and respond to it. Thus, no synchronization sessions, or state checking are necessary. This facilitates high-speed message exchanges.

A pathway may be dynamically changed (for example, may be moved from one port to another port, or destroyed and removed) only if all generalPorts connected to that pathway are in state S. This would indicate that there are no pending service requests sent by those generalPorts. Thus, not only is it true that a generalPort g that sent a service request to a functionPort f may send another service request only after it had received a response to its first request, no other port may send a service request to f until it had fully responded to the one sent by g. This guarantees, no virtualMemory will ever hold more than one pending message.

2.4 Consequences of Using Pathways and CCPS

It takes about 50 nanoseconds to execute a CCP implemented in software (measured in PROLIANT 760 multiprocessor with 2-Gigahertz CPUs), and it will take no more than 2 nanoseconds to execute a CCP implemented as a machine instruction in such a machine (estimated). It takes no more than four CCP executions to deliver a message over software pathways in shared-memory environments. It may take as many as six to ten CCPs in the TICCNET™.

The 350 nanoseconds latency we measured in PROLIANT 760, instead of the expected 200 nanoseconds, is because the protocols included facilities for enforcing data security, cell activation, synchronization, coordination, and managing dynamic updating. These were specified through CCP augmentations, by embedding CCPs into other programming statements much like the way we embed ordinary assignments into programming statements.

One may wonder why agents are necessary. For the simple task performed above agents are not necessary. In general, in more complicated pathways, agents are used to coordinate message transfers, synchronize message deliveries, activate cells, enforce data security, distribute tasks, coordinate dynamic updating and communicate with the self-monitoring system. We will see, point-to-point message exchange is just a special case of more general group-to-group message exchange. We will also see how agents may be used to coordinate and synchronize high-speed data transmissions in a hybrid TICCNET™ pathway, which contains both software and hardware components.

Since the early days of programming, we have had two ways of synchronizing and coordinating concurrent programs: One is by using semaphores [16] and other is by employing the rendezvous [7] technique. These two are well rooted in current programming technology. In TICC™ CCPs directly interact with any hardware or software component. This should give rise to new methods of synchronization and coordination. Indeed, they do. We discuss in Section 8 synchronization and coordination techniques available in TICC™. It is possible, as we understand CCPs better more methods of synchronization and coordination will emerge.

Signaling using CCPs punctuates computations, activates components, distributes tasks, coordinates and synchronizes activities, all programmatically driven. These activities are captured by communication protocols and cell interactions using TIPs. This is the reason, one can progressively dispense with the operating system for resource allocation and task management. In the proof of concept prototype TICC™-Ppde we do not use operating system for task scheduling, for process/thread activation, for data security enforcement, for interrupt handling, for communications, for driving the self-monitoring system, or for dynamic updating.

One might wonder why this does not further complicate programming and increase a programmer's programming load. Just as right computing hardware and the right programming abstractions simplify a programmer's work load, the pathway and CCP abstractions also simplify a programmer's work load, by making it possible to isolate programs into its components: networks, CIPs, messages, pthreads and protocols, and view programs as a combination of these independently defined components working in a computing network, with no programming primitives needed to coordinate their interactions, other than CCPs.

Protocols and pathways are given to a programmer as prepackaged components. Protocols are defined using CCPs. Pathways are invoked and installed at the time of program initialization, in the TICC™-network establishment phase. The network, once established, may be saved, invoked, installed again and used over the lifetime of an application, just as a hardware component may be used repeatedly. A graphical user interface is provided to establish and edit networks.⁴
⁴ TICC™-Ppde has a graphical use interface called TICC™-GUI. This was designed and implemented by Mr. Rajesh Khumanthem, Mr. Kenson O'Donald and Mr. Manpreet Chahal.

Programmer need not define protocols or pathways. Programmer has to define only the TICC™-network needed for an application, TIPs, pthreads and messages. Once installed in a program, protocols and pathways automatically perform all necessary task management together with TIPs, without invoking the operating system.⁵ Thus, even though operating system is not used to perform any of the management tasks, a programmer has no responsibility to specify task management. Tasks are self-scheduled, self-coordinated and self-synchronizing. This simplifies programming.
⁵ Mr. Rajesh Khumanthem implemented the cell (process) activation system for TICC™, which activates processes and manages them without using the operating system.

Large applications are hard to program and verify using current programming techniques where software interaction primitives appear inseparably mixed with other programming statements throughout a program [17-21]. TICC™ simplifies development of software and certification of software systems, through a clean separation among network structures, component interaction structures, protocols, messages and pthreads, where each can be defined, tested and verified independently. In addition, it provides facilities for self-monitoring, program updating and maintenance.

For an Rtas a note of caution is needed. We must have precision timed program executions in real time systems, because programs should have precise predictable execution times for satisfactory real-time performance. Thus, many hardware design technologies (like look-ahead instruction scheduling, multiple instruction streaming, and cache memory executions) that came into vogue during the last few decades to speed up program throughput in single processors are not appropriate for TICC™-Rtas. Program execution times cannot be reliably predicted in high-speed systems with such features. Indeed, we found that in TICC™-based parallel programs, caching is a hindrance. With pthread execution times of 10 to 100 microseconds, machines wasted too much time in cache replenishments, and cache incoherence was a frequent problem. We had to often write data directly into designated main memory addresses, in order to prevent cache incoherence.

Avoiding features that promote high-speed instruction executions will not hurt performance or cost. With TICC™ software, increased parallelism and self-scheduled asynchronous execution can more than compensate for the lost speed when compared to single processor systems. Additionally CPUs can be simpler, smaller, and cheaper, thereby using less energy and being more densely packed in multi-core chips.

Another point to take note of is the following: We set time stamps at various places during the operation of a cell. These time stamps do not refer to times associated with any particular process. They refer to the absolute time in a clock⁶ in the processor that runs the cell. Facilities should be provided to read this clock from any port attached to a cell without having to invoke assistance from an operating system. The prototype TICC-Ppde does not have facilities for time stamping.
⁶ This clock could simply be a 64-bit or a 128-bit hardware counter in the CPU.

All of the features, (a) networks defined by cells and pathways, (b) cell interactions defined by TIPs, (c) message processing defined by mutually independent pthreads, (d) mutually independent CCP-protocols, (e) guaranteed high-speed real time messaging, (e automatic pthread activation by message receipts, (g) parallel messaging limited only by the number of cells in a network, (h) uninterrupted message processing and protocol executions, and (i) automatically generated self-monitoring system, together contribute to simplification of design, development and maintenance of self-scheduled self-synchronized scalable real-time distributed parallel processing software with real-time asynchronous messaging.

The computing paradigm proposed here comes with a formal theory that establishes the denotational semantics for TICC™-programs. The self-monitoring system constructed by TICC-Ppde for an application, is based on this theory. The theory exhibits the execution structures of parallel programs, which may help a system designer to define system behavior and prospective programmer to design correct programs.

### 3. TICC-PPDE: TIPs AND CIPs

All computations in a TICC™-network are driven by service request messages sent by generalPorts. As we shall later see, every service request sent by a generalPort, the port is guaranteed to receive a response. Thus, to trace computations in a network it is enough if one traced the message sending and message receiving events at generalPorts. Thus, we will describe computations in a parallel processing system in terms of message sending and receiving events that occur at generalPorts in a TICC™-network. These will be the only events we will consider. We will use small icons to represent events associated with TIPs: The empty brackets in the icons are slots for filling the times at which the associated events occurred. We use g for generalPorts and f for functionPorts. The superscript S is for ‘send’ and R is for ‘receive’.

‘g^{S}[ ]→’: generalPort g has sent out a message;

‘→g^{R}[ ]’: generalPort g has received a response.

‘g^{R}[ ]→’: Response at g causes another message event to occur

These icons, and its variants, are later used to build Allowed Event Occurrence Patterns (Alleops) and activity diagrams for a TICC™-network. Alleops and activity diagrams are used, to define the denotational semantics for TICC™-programs and construct its self-monitoring system.

We present below the TIP formats and icons associated with them, with a brief note on TIP activities they represent. In the following, we use phrases “executed by port”, “sent by port” or “received by port”. They should always be understood as “executed by the parent cell of port”, “sent via port by the parent cell of the port” or “received at port by the parent cell of the port”, respectively. We will not enumerate the synchronous TIPs, like the one in (1b) below, for all the TIPs, but they exist.

Simple TIPs at a functionPort: We have already seen these in statements (1a) and (1b). They are reproduced below for convenience.

| f:mR?( ) {f:r( ).s( );}, where f:r( ).s( ) ≡ f:r( );f:s( ); | | (1a) |
|---|---|---|
| f:mR?*( ) {f:r( ).s( );} | | (1b) |
| Icon: | ‘→gⱼ^{R}[ ]’ | (1c) |
| Event: | A gⱼ receives a response. This is the generalPort | |
| | connected to f by a pathway | (1d) |
| f:mR?( )& gᵢ:mR?( ){f:r(gᵢ).s( );} | | (1e) |
| Icon: | ‘→gᵢ^{R}[ ]→gⱼ^{R}[ ]’ | (1f) |
| Event: | Uses response at port gᵢ to send response to a gⱼ, | |
| | connected to f by a pathway. | (1g) |

In (1e) the connective ‘&’ stands for logical conjunction. As we saw in Section 2.3, any time a functionPort f receives a service-request, f will become ready to send back a response. Thus, when f:s( ) is executed in the above TIPs, the pathway connected to the functionPort f will be ready to send back the response message. Since the response message is always sent immediately after it is written into the writeMemory, and no other process or thread may interrupt the activities of cell while it is processing a TIP, there is an upper bound on the time needed for a functionPort f to respond to a received service request. If a service request is not processed for some reason the cell should send back an empty message as acknowledgement. Only functionPorts have to respond to a received message. GeneralPorts do not have this obligation.

Our next format looks at how new computations are spawned.

TIP variants at a functionPort, Spawning new computations: The guard g:pR?( ) (‘pR?’ for ‘pathwayReady?’) is true only if pathway at g is ready to send a message.

| (f:mR?( )& g:pR?( )){f:r(g);f:spn?( ){g:s( );}else {f:s( );}} | | (5a) |
|---|---|---|
| Icon: | ‘g^{S}[ ]→’ if f:spn?( ) is true | (5b) |
| Event: | Spawns a new computation via generalPort g. | (5c) |
| Icon: | ‘→gⱼ^{R}[ ]’ f:spn?( ) is false | (5d) |
| Event: | A gⱼ connected to f receives response. | (5e) |

The functionPort f may spawn a new computation via generalPort g, while responding to a received message. At the time f:r(g) execution is started, message at g will be empty. If spawning is needed then f:r(g) will write a service request into the virtualMemory of the pathway connected to g at some point during its computation, and set f:spn?( ) (‘spn?’ for ‘spawn?’) to true, and g:s( ) will send it off. Later, when g receives a response to its service request, f will resume operations and complete responding to the message at f using the response received at g, as shown in statements (7). Before completing the response, the parent cell may go through an arbitrary number of spawning iterations.

If no spawning is needed then f:spn?( ) will be false. In this case, the response message is written by the parent cell of f into the virtualMemory of the pathway connected to f. This message is sent when f:s( ) is executed. In all cases, message is sent immediately, after it becomes ready and every service request is responded to.

TIPs at a generalPort

Asynchronous:

| g:pR?( ){g:x( ).s( );} or | | (6a) |
|---|---|---|
| Icon: | ‘g^{S}[ ]→’ | (6b) |
| Event: | g sends a service request | (6c) |
| g₁:mR?( )& g₂:pR?( ){g₁:spn?( ){g₂:x(g₁).s( )}} | | (6d) |
| Icon: | ‘g₁^{R}[ ]→g₂^{S}[ ]→’ if g₁:spn?( ) is true else nothing. | (6e) |
| Event: | g₁ uses the response it received to spawn a new | |
| | computation through g₂, if g₁:spn?( ) is true. | |
| | g₁ cannot iterate spawning through g₂. | (6f) |
| g₁:mR?( ){g₁:spn?( ){g₁:x(g₁).s( )}} | | (6g) |
| Icon: | ‘g₁^{R}[ ]→g₁^{S}[ ]→’ if g₁:spn?( ) is true else nothing. | (6h) |
| Event: | g₁ uses the response it received to iterate spawning | |
| | if g₁:spn?( ) is true. | (6i) |
| g:mR?( ){f:r(g);f:spn?( ){g:s( );}else{f:s( );}} | | (7a) |
| Icon: | ‘g^{R}[ ]→g^{S}[ ]→’ if f:spn?( ) else ‘→g^{R}[ ]→gⱼ^{R}[ ]’ | (7b) |
| Event: | Port f Uses response at g to iterate spawning | |
| | through g if f:spn?( ) is true, else | |
| | a gⱼ connected to f receives response. | (7c) |

Generalized TIPs: In the generalized TIP below, f and g are port-vectors containing ports belonging to the same parent cell, C: f=[f₁,f₂, . . . ,fₙ] and g=[g₁,g₂, . . . ,gₙ] for n≧1 and m≧0. Port-vectors with one or more ports are classes in the OO-language. Thus, virtual methods may be defined on port-vectors as well. All ports in a port-vector should be ports of the same kind and no port may belong to more than one port-vector. In the following, for any port-vector p=[p₁,p₂, . . . ,pₙ], n≧1,
p:mR?( )=[p₁:mR?( ) & p₂:mR?( ) & . . . & pₙ:mR?( )], (8a)
p:mR?*( )=[pᵢ₁:mR?*( ) & pᵢ₂:mR?*( ) & . . . & pᵢₙ:mR?*( )]. (8b)
where a particular subset, \tilde{p}⊂p is a priori specified.

In every one of the TIPs enumerated above one could replace any port by a port-vector. We will use \tilde{g} to denote an a priori specified subset of g. Thus, the TIP (5a) and (7a) will have the form,
(f:R?( )& \tilde{g}:pR?( )){f:r(\tilde{g});f:spn?( ){\tilde{g}:s( );} else {f:s( );}} (9a)
\tilde{g}:mR?( ){f:r(\tilde{g});f:spn?( ){\tilde{g}:s( );} else {f:s( );}} (9b)
where \tilde{g} is a known subset of g. If no is \tilde{g} known then g will be used.
f:s( );≡f₁:s( ).f₂:s( ) . . . fₙ:s( ); and (10a)
\tilde{g}:s( );≡gᵢ₁:s( ).gᵢ₂:s( ) . . . gᵢₖ:s( ); (10b)
where {i1,i2, . . . ,in}⊂{1, 2, . . . , n}. The icons for the various TIPs with port-vectors are obtained by substituting g or \tilde{g} for g as needed. We use I as the iteration variable, for an integer, 0≦I≦∞, which specifies the number of spawning iterations.

A general restriction on spawning is, no two distinct ports (port-vectors) of a cell may use the same g or \tilde{g} to spawn computations.

In a spawning iteration the parent cell of a generalPort vector, need not use all the ports in the vector. It is not hard to see how a cell could keep track of ports through which it had spawned computations, and look for response messages only at those ports. This kind of use of \tilde{g} does not introduce non-determinism.

Non-determinism in Parallel Computations: One way this can happen is when a cell orders resources in advance through its generalPorts, but does not use all of them. A classic example of this occurs in the Producer/Consumer solution, discussed in Section 10.3. Responses received by generalPorts would be preserved in their respective virtualMemories until used. A generalPort would become ready to send the next service request only after the response it had received, if any, had been used up. Where it is possible to use this strategy, it avoids the need to spawn computations and suspend/resume activities at functionPorts. In addition, this may provide timely service in cases where time is important. The general forms of TIPs for this are,
The parent cell places order for resources at the generalPort vector g:
   g:pR?( ){g:x( ).s( );} (11)
FunctionPorts use the resources and place orders to replace used resources.
   f:mR?( )& \tilde{g}:mR?^{⋆}( ){f:r(\tilde{g}).s( ); \tilde{g}:pR?( ){s( );}} (12)

In this case, functionPorts wait for the resources to be ready at the generalPort vectors, as indicated by the use of the guard \tilde{g}:mR?^{⋆}( ). Since, at any time a cell will be processing the TIP at only one of its port-vectors no resource contention will arise. One can even make the guard Vg:mR?^{ø}( ) checking for message, at any one of the generalPorts in g. Replacement orders are placed only at generalPorts where the pathway is ready (resource has been used up), as indicated by the pR?( ) guard in (12). In this case, any functionPort vector may use the resources provided by g, depending on how the CIP (Cell Interaction Protocol) is written, but only one functionPort vector at any one time.

Another way of introducing non-determinism into CIPs is by using disjunctions at functionPorts. We forbid this. They unduly complicate analysis of the system. Any time there is a need for a disjunction at certain functionPorts, one may always define a port-vector using those functionPorts, where the TIP at the functionPort vector does whatever needs to be done, even a disjunction. The difference between the port-vector approach and the disjunction approach is that in the case of port-vectors a cell may respond only after all ports in the vector had received service requests. Thus, it can examine all messages and take the appropriate action. More significant, every message is responded to. In the case of disjunctions, these will not be true.

Fork and Join Operations: The TICC™ protocols perform coordination and synchronization of group-to-group communications. This is discussed in Sections 5 and 6. The perfectly synchronized dispatch and distribution in group-to-group communications may be used for fork and join operations. We will use generalPort groups and vectors for fork operations and functionPort groups and vectors for join operations. Let G(G) denote any generalPort group (vector) and F(F) to denote functionPort group (vector).

Any time G has more than one port in it, the joint service request message sent out by G will cause a fork operation, because the parent cells of functionPorts in the group F that receive this message will respond to this message, each processing the joint service request, or different components of the service request, in parallel with others. When F responds to this joint service request a join operation will occur, since all ports in G will receive this response message.

Similarly, when ports in a generalPort vector G spawn computations, the cells that respond to the spawned computations will all work in parallel, each executing appropriate pthreads in parallel to compute the responses. The functionPort vector F, in the parent cell of G, that makes use of the responses received by G will in this case represent a join operation. TIP icons for such port groups and vectors are obtained by simply replacing g by G or G, as needed, and replacing the single arrow ‘→’ by a group of arrows that either fan out or fan in. We use these icons in sections 10 and 11 to build Alleops and activity diagrams.

General Comments: In all cases, no cell waits at a port for a message, unless the synchronous guard is used; they should be used with care, since they can cause deadlocks. This problem does not arise with asynchronous guards, where it is quite possible that one or more ports has no pending messages at the time of polling. The cell simply skips those ports or port-vectors. It is possible, however, for a cell to keep spinning through its polling cycles without finding any pending messages. We refer to this as livelock.

While a cell is evaluating and responding to pending messages in its sorted ports list, new messages may arrive at other ports of the cell not in the list. These newly delivered messages are preserved in their respective virtualMemories until the ports are polled and serviced in an ensuing polling cycle.

At the risk of over-repeating, all messages are always sent immediately after they become ready. Cell itself executes the protocol for message transmission with no assistance from OS or any other thread or process. In all practical systems, spawning of new computations has to stop eventually. Otherwise, some parts of the system would be stuck in an infinite loop. Thus, deterministic pthread and protocol executions with no interruptions should guarantee that every message received at a functionPort vector is always responded to, even if the vector spawns new computations. As we will see in Section 9 every service request message sent out by a generalPort will always result in that generalPort receiving a response message, even when the same resource is shared by different pthreads. If service-requests stop coming then there can be a deadlock or a livelock.

In the following, we will represent the evaluation of a TIP-body at a port p by the expression p:tip( ) and evaluation of the TIP-body at a port-vector p by p:tip( ).

3.1 A Canonical CIP:

The CIP (Cell Interaction Protocol) for a cell class may have the form shown below (we use C++ conventions, where convenient). The CIP shown below has three local variables: initializeFlag, stopPolling and sortedPortList. These are variables defined in the Cell class. The guard initialize?( ) will be true if the Boolean variable initializeFlag is true. The method initialize( ) may install new cells, install pathways, initialize pathways and activate the cells it installed. This will cause the network to grow in parallel. The port i0 is the interruptPort, which is used to activate the cell instance when it receives its first message. The method i0:s( ) acknowledges this activation. The method pollAndSortPorts( )constructs the sortedPortsList in each polling cycle. A functionPort vector f, is placed in the sortedPortsList only if all ports in the port-vector had pending messages.

In general, CIPs may use several local variables, all defined in Cell. Local variables may be used in a TIP to perform computations conditionally, or perform computations based on local results obtained from previously processed messages with the proviso that every pending message is eventually responded to. No response or acknowledgements are needed for messages received at generalPorts, since they will always be responses to service-requests sent earlier.

```
void Cell::CIP( ){
    /*initialization is done only at the time a cell is activated; i0:s( )
    acknowledges activation of the cell instance.*/
    initialize?( ){i0:s( );initialize( );initializeFlag = false;}
    while (!stopPolling){
      /*polls its ports and sorts them into the sortedPortsList/*
      pollAndSortPorts( );
      for (unsigned int i; i < sortedPortsList.size( ); i++){
          sortedPortsList[i]:tip( );}
    /*Terminates on receipt of an interrupt signal from port i0.*/
    i0:mR?( ){stopPolling = true; i0:s( ); prepareToTerminate( );}
    }
} (13)
```

A cell may have several interruptPorts. The above CIP does not poll all interruptPorts the cell may have; only the start/stop interruptPort is polled. Interrupts received from other interruptPorts would be responded to using the built-in interrupt mechanisms of the cell. These built-in mechanisms would use the hardware interrupt handling facilities in the CPU that runs the cell, without using the operating system. Interrupts may be used only to change the order of pending messages in the sorted ports list. No cell servicing a port in the sorted ports list can be interrupted, while it is servicing. These rules guarantee that all ports in a sorted ports list will always be serviced. It is possible that a cell terminates by itself instead of waiting for the stop signal from its interruptPort or suspends itself based on a locally defined condition, as in the case of spawning. Thus, CIP definition for different Cell subclasses could be quite different from each other.

A general requirement on all CIPs is that no CIP ever misses sensing a pending request at any of its ports. CIPs may always be written and checked to satisfy this condition.

At this point, it is useful to note the following characteristics of TIPs and CIPs:
(i) Each TIP and CIP invocation and execution is sequential and deterministic;
(ii) TIP executions can never be interrupted;
(iii) All message exchange specifications occur only in CIPs.
(iv) Each message is sent out immediately, soon after it becomes ready.
(v) Every service request message sent out by a generalPort is responded to (proof in Section 9).
(vi) When a cell orders resources in advance and uses them as and when needed, it may not use all the resources it ordered. This can give rise to non-determinism. This is the only kind of non-determinism allowed in TICC™-Ppde.
(vii) No pthread will contain interaction or message sending/receiving statements. Input/output and timing for each pthread may be independently verified.
(viii) By analyzing the CIPs of cells in an application, one may determine an upper bound for the time needed for a generalPort to receive its response, after it had sent out a service request.
(ix) By analyzing the CIPs of cells, one may automatically generate the Allowed Event Occurrence Patterns (Alleops) associated with a parallel program.
(x) By definition, an event is either a message sending or a message receiving operation at a generalPort group or a generalPort vector.

3.2 Port Dependence, Independence and Coordination

For any cell, let the data defined in the cell be called its local data. For each functionPort vector fₖ, with one or more functionPorts, there may be local data generated by fₖ:tip( ). This data will be saved locally in the parent cell of fₖ. If C is the parent cell of fₖ then let S^{c}ₖ(n) be the partial state of C defined by local data at fₖ after fₖ had processed its n^{th} message vector, for n≧0. This local data may not be a part of the response messages. Let φₕ be the function such that for the n^{th} message vector, mₙ, received at fₖ,
φₖ(mₙ, S^{c}ₖ(n−1))=[mₙ′, S^{c}ₖ(n)] (14)
where mₙ′ is the vector of response messages. If ports in fⱼ are dependent on ports in fₖ then
φⱼ(mₙ, S^{c}ₖ(n−1), S^{c}ₖ(n−1))=[mₙ′, S^{c}ⱼ(n)] (15)

In general, it is possible that ports in fⱼ are dependent on more than one other port-vector. If a port-vector fᵢ is not dependent on any other port-vector in a cell, then it is independent. In this case, (14) would hold. We will prohibit dependencies of the form,
φⱼ(mₙ, S^{c}ⱼ(n−1), S^{c}ₖ(n)), and (16a)
φₖ(mₙ, S^{c}ₖ(n−1), S^{c}ⱼ(n)), (16b)
where the response for the n^{th} message at fⱼ(fₖ) depends on the no state of fₖ(fⱼ). Cells in TICC™ may have independent port-vectors. In the following, to simplify the diagrams, we will use only singleton port-vectors and denote them using fᵢ, fⱼ, gᵢ, gⱼ, etc.

Arrows showing direction of information flow

[image]

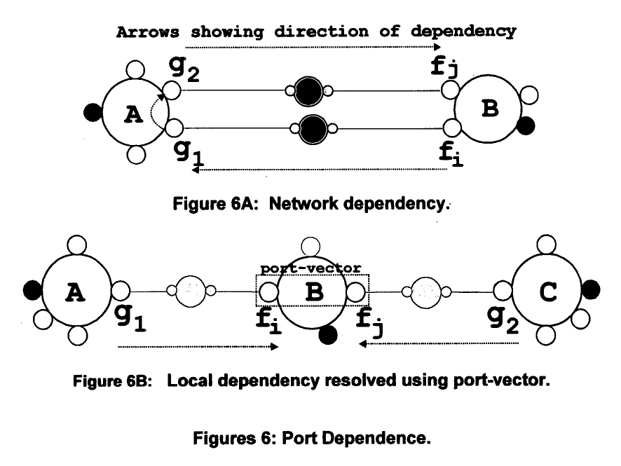

If fⱼ is dependent on fᵢ then two kinds of dependencies may arise: we refer to one as network dependency, shown in FIG. 6A and the other as local dependency, shown in FIG. 6B. In FIG. 6A, after fᵢ responds to a message received from g₁, g₁ spawns a new computation through g₂ using the response it received from fᵢ. The TIPs for this is,
Cell A: g₁:mR?( )& g₂:pR?( ){g₂:x(g₁).s( );}, (17a)
Cell B: fᵢ:mR?( ){f:r( ).s( );}, (17b)
Cell B: f:mR?( ){fⱼ:r( ).s( );}, and (17c)
φⱼ(mₙ, S^{c}ⱼ(n−1), S^{c}ᵢ(n−1))=[m′ₙ, S^{c}ⱼ(n)] (17d)

The order in which the two TIPs appear in B does not matter, since fⱼ will receive its n^{th} message only after fᵢ had responded to its n^{th} message. Of course, this kind of network dependency can travel through many cells starting from cell A before it reaches cell B.

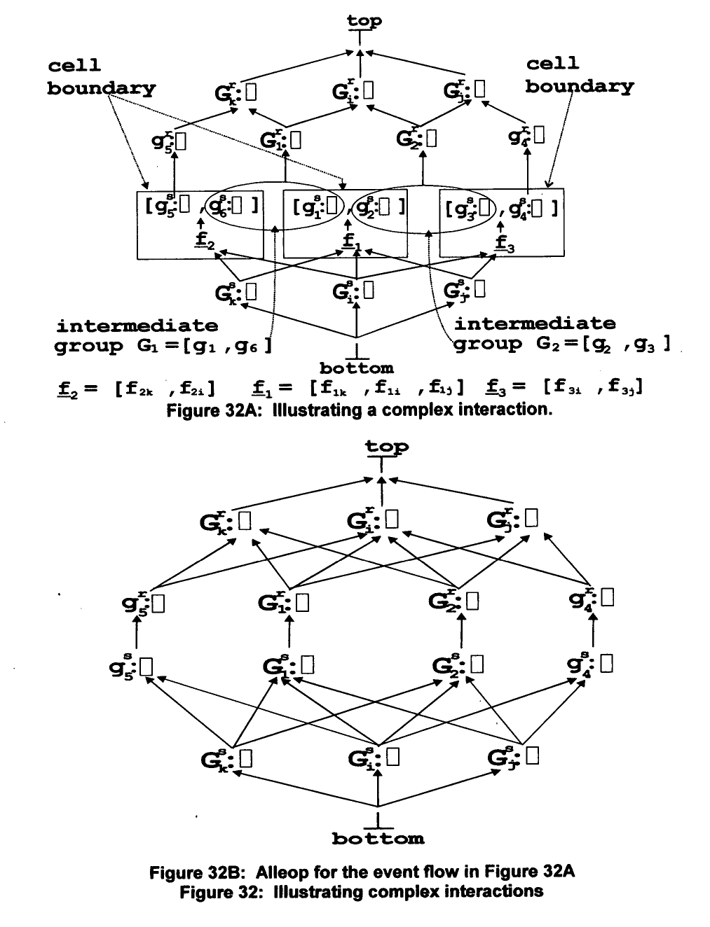

In FIG. 6B, the messages received by fᵢ and fⱼ are not dependent on each other. Here, one may define a port-vector, f=[f₁,f₂] and define the TIP in cell B as,
f:mR?( ){fᵢ:r( ).s( ); fⱼ:r( ).s( );} (18)
and the function φⱼ is the same as the one in (17d). An example of complex dependency is shown in FIGS. 32A and 32B.

The two kinds of dependencies enumerated above are the only kinds of port dependencies that can arise in a cell. In all cases, the sequential TIP evaluation restrictions imposed by port dependencies may be incorporated into the structure of TIPs used in a CIP.

We introduced the restriction that no two distinct ports (port-vectors) of a cell may spawn new computations using the same generalPort or generalPort vector. With this restriction, one may prove the following theorem (proof in Appendix I).

Theorem 1: Ticc-networks may be designed to be deadlock and livelock free.

We will associate with each cell two specially designated functionPorts: One called the statePort and the other called the diagnosisPort. By sending an interrupt signal to the statePort, one may obtain the current state of a cell. By sending a message to the diagnosisPort the self-monitoring system may initiate a cell diagnosis, based on suitably written diagnosis programs (pthreads).

### 4. TICC™ AND OTHER SYSTEMS

Before we proceed to discuss TICC™ protocols it is useful to compare TICC™-Ppde with other parallel programming systems, in the light of what we already know about TICC-Ppde. We do this in this section.

4.1 Conventional Systems

[image]

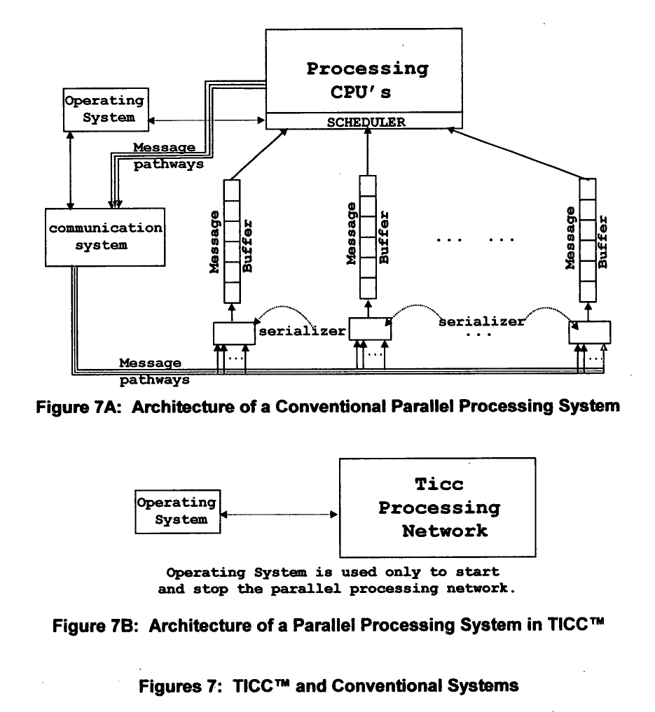

By conventional systems, we refer to multithreaded programming systems for parallel and concurrent programs, where an operating system and a scheduler are used to schedule and activate threads, allocate resources and manage communications. A schematic diagram of this architecture is shown in FIG. 7A. In these systems, the CPUs in the processing network execute programs; hardware and software in the communication system perform message exchanges; and the operating system coordinates and synchronizes activities of the two and performs scheduling as specified by the scheduler. Even though message deliveries are guaranteed, one may not be able to predict when a message might be delivered. Messages may not be sent immediately, as soon as they are ready to be sent. There may be non-determinism in both thread executions and message transmissions.

FIG. 7B shows the architecture of a parallel processing system in TICC™; the situation is quite different. CPUs, communication hardware, cells and pathways together constitute the TICC™-processing network. All activities in the network are self-scheduling, self-synchronizing and self-coordinating with precisely defined bounds on their execution times. No operating system is needed to mediate message exchanges, to schedule processes and pthreads, and no process external to TICC™-Ppde is needed for task management. The software that defines and operates a TICC™-network, like the one shown in FIG. 3, is the only software needed to run an application system. The operating system is used only to start and stop the processing network. It is necessary to use the operating system for this purpose, only because it is the only way to gain access to services provided by CPUs in modem computers. If the operating system kernel is itself implemented in TICC™ then this would not be necessary. One may simply replace the operating system by an ON/OFF switch.

In TICC™ there is no difference between computation and communication. TICC™-Ppde defines all protocols needed to implement and run parallel programs, to activate cells, to schedule processes and pthreads, to coordinate and synchronize their activities, to share resources, to enforce data security, to drive the self-monitoring system and to manage interrupt control and input/output.⁷
⁷ In the current proof of concept prototype TICC™-Ppde input/output uses the operating system. It is not hard to install driver calls within TICC™ to perform these tasks.

4.2 TIPs and Π-Calculus Interaction Statements

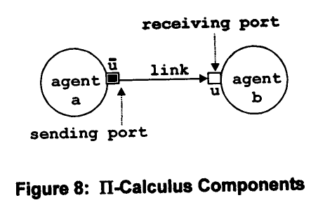

The basic components in Π-calculus [8] are called agents and links, as shown in FIG. 8. Every agent has exactly one port, which may be used as a sending port or a receiving port depending upon the context in which it is used. In the diagram above both agents have a port named u. Pairs of ports with same names will be connected by a link in a Π-calculus network; the links are used to exchange messages. When they are connected, it will signal a possible message exchange via the link. The message exchanged will always be a single identifier, called name. Names of ports and links are dynamically established. The only operations an agent may perform are name exchange operations and name substitution operations. Activities performed by an agent are the following:
By agent a: u̅y.P(z); and By agent b: u(c).Q(w) (19)
where agent a sends name y to agent b via its port u, and agent b receives name y via its corresponding port u. Agents a and b here share the port name u, which may also be used as the name of the link. The operation u̅y is the name sending operation at port u of agent a, and the operation u(y) is the name binding operation at the corresponding port u of agent b. Both P(z) and Q(w) would be sequences that contain only name sending and name binding operations with different names.

[image]

All agents would operate in parallel. Thus, parallelism is intrinsic to the Π-calculus network. When agents a and b, in the above figure, operate in parallel, after name exchange and name binding, they perform the following:
Agent a: P(z), Agent b: {y/c}.Q(w), (20)
which means: After sending out the name y agent a proceeds to execute P(z). After receiving name y agent b substitutes y for name c in Q(w) and then executes Q(w). It is quite possible that name c does not appear in the vector of names w, in which case the received name y will have no effect on the Q(w) execution. If the name c appears in Q(w), the received name y may itself be used as the new name of the port in Q(w), which will then be connected by a link to a different agent, also containing a port named y; thus, ports and links are dynamically established as computations evolve. There is no distinction between names of constants and names of links (ports). Π-calculus also provides facilities to define hidden links and bindings. We will not go into details here. A general requirement for describing computations using this framework is that agents who operate in parallel should have an a priori agreement about how to share and use names.

Prof. Robin Milner together with his collaborators [8] proved that all parallel computations and parallel computational phenomenon, including mobility, could be described using only name sending, name binding and name substitution operations. Prof. Milner thus established the fundamental framework and theory for parallel computations using communication of names and name substitutions as the only primitive operations, just as Turing [13] established the fundamental framework and theory for sequential computations using finite state sequential machines and a potentially infinite memory tape.

An obvious difference between calculus and TICC™ is that whereas Π-calculus statements contain only send/bind primitives and use substitutions when activated, TIPs contain send/receive and pthread execution statements. Thus, name exchanges and name substitutions are not the only basis for defining computations in TICC™. While Π-calculus defined all of parallel computations in terms of name exchanges, it did not define communication itself as a computation within its framework; it is taken as a given primitive. In TICC™, it is the other way around: communication is reduced to programmatically specified sequential computations, in the sense of Turing, and integrated with computations.

Since all computations may be described in Π-calculus, at attempt is made in Appendix II to describe TICC™ protocol computations in x-calculus and integrate it with the calculus. This points out the difficulties in reconciling the two. It also points out why signaling is implicitly assumed in the π-calculus execution scheme.

4.3 Cells and Actors

Cells are like Actors that are used in the Actor formalism [9,10] of distributed parallel computations with the following differences:
(i) Actors receive and respond to their inputs one by one in the order they appear in its asynchronous input buffer. A synchronization and coordination mechanism, called the serializer, is used to synchronize message deliveries to buffers, and resolve buffer contentions when more than one message attempts to append itself to the buffer at the same time. When the message at the head of its buffer is processed by an Actor, the message is removed from the buffer. Messages in the buffer queue of an Actor, which have not been processed by the Actor, are called pending messages. For each Actor its buffer queue may contain an arbitrary number of pending messages.
(ii) Unlike an Actor, each cell in a TICC™-network may receive several messages simultaneously, in parallel. Each port will receive at any time only one message. There are no port contentions. The cell will respond to pending messages one by one in an order of its own choosing. No port of a cell will have more than one pending message at any time, even though all the ports, taken together, may have several pending messages.
(iii) Since each cell may have an arbitrary number of ports, and each cell may dynamically add new ports and pathways to itself at any time, cells may have an arbitrary number of pending messages.
(iv) Communication mechanism is external to the actor formalism, as shown in FIG. 7A. In TICC™, protocols used for message deliveries are built into computations performed by cells.
(v) As mentioned earlier, ports in a cell may be organized in TICC™ into port-groups and port-vectors. These are useful to explicitly define, combine and coordinate correct implementation of causal chains of events, where one event is caused by a combination of other preceding events. Such explicit controls are not available in the Actor formalism; they have to be incorporated by writing appropriate scheduling routines.
(vi) Non-determinism in parallel computations and parallel execution control structures are intrinsic to the Actor framework of computations [12]. As we shall see, only a restricted form of non-determinism is intrinsic to TICC™-Ppde.
(vii) Security breaches and partial system breakdowns may be dynamically detected and reported by the event self-monitoring system in TICC™. No such built-in facility exists for the Actor formalism.

The features of TICC™-Ppde are well suited not only to design and build reliable real time application systems, but also to design and build any parallel programming system, using either multi-core chips or multicomputer networks.

### 5. COMMUNICATIONS DEFINED AS SEQUENTIAL COMPUTATIONS USING CCPs

Before we present examples of parallel programs in TICC™-Ppde it is necessary to understand the communication mechanisms used in TICC™-Ppde and their important properties. Therefore, we present the TICC™ communication mechanisms first. The protocols used for communications show various ways of using CCPs and their effectiveness in coordinating both hardware and software components.

5.1 Point-to-Point Distributed Memory TICCNET™ Pathway

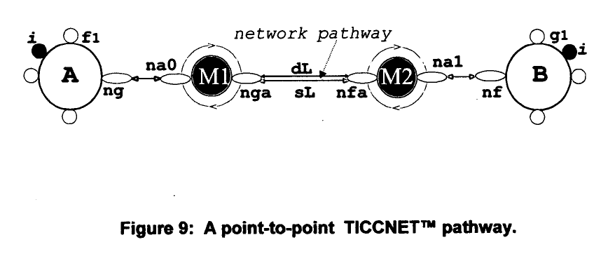

We have already seen point-to-point shared-memory communication in TICC™. FIG. 9 shows a point-to-point distributed TICCNET™ pathway (these are also referred to as network pathways). Network transmission lines in TICCNET™ come in pairs: A high bandwidth data line called dL and a low bandwidth signal line called BL. The agents, nga and nfa that are attached to virtualMemories in FIG. 9 are network general and network function agents, each running in its own microprocessor. Agents nga and nfa are a part of the embedded network hardware. Agents na0 and na1 in FIG. 9 are network agents attached to the virtualMemories and tuned to ports. Ports ng and nf are network general and network function ports attached to cells. These are all software components. As we shall see, the network agents and ports are different from shared-memory agents and ports; they are 4-state sequential machines.

[image]

Network transmission lines are attached to network agents, nga and nfa. The diagram shows a network pathway from generalPort ng of cell A to functionPort nf of cell B. The pathway has two virtualMemories, one in the memory environment of the processor of cell A, and the other in the memory environment of the processor of cell B. Signals exchanged through the signal line sL will set the context for data exchange through the data line dL as described in the protocol shown below. Messages are exchanged between the write and read memories of the virtualMemories on the network pathway.

Different components of the protocol are executed by sending and receiving cells and the microprocessors that run the network agents nga and nfa coordinated through signal exchanges using CCPs. A TIP at generalPort ng of cell A might be, for example, ng:pR?( ){ng:z( ).s( );} where s( ) is the point-to-point TICCNET™ protocol described below. The TIP format is independent of the medium through which messages are exchanged, and network hardware participates in computations with no need for operating system intervention, as described below.

Protocol for Point-to-point Distributed Memory Pathway: Different parts of the protocol for message transmission along the network pathway shown in FIG. 9 are executed by different components in the pathway as described below. Some of the components are software components and others are hardware components.

Part i) Executed by parent cell of port (software):
ng:tC?^{⋆}( ){ng:c [symbol] na0:s [symbol] nga;}. (21)

When the parent cell of port ng completes its task, the port sends the completion signal c to port ng, which causes ng:tC?^{⋆}( ) to become true, and ng forwards c to agent na0 on the pathway in FIG. 9, which then sends the start signal s to the network general agent nga.

Part ii) Executed by the microprocessor of network agent, nga (hardware):
nga:mR?^{⋆}( ){nga:s [symbol] sL; M1.nga:data [symbol] dL; nga:e [symbol] sL;} (22)

The guard nga:mR?*( ) would become true when nga receives the start signal sent by na0. The ‘^{⋆}’ in the guard condition indicates that nga would be waiting for this signal to arrive. At this point nga will be in its send state, S. After the signal arrives, nga applies signal s to its signal line, sL, to mark the beginning of data transmission and then applies data from memory M1 to its data line, dL, (see FIG. 9) and at the end of data transmission it applies the end of data signal e to signal line sL. After sending the end of data signal, nga will move to it's receiving state, in which it will be expecting to receive a response to the message it sent.

Part iii) Executed by the microprocessor of agent nfa (hardware):
nfa:mR?( ){while( [symbol] nfa.sL:mC?( )}{dL.nfa:data [symbol] M2;}nfa:s [symbol] na1:s [symbol] nf;}. (23)

The guard condition, nfa:mR?^{⋆}( ), will become true when nfa senses the start signal s on its signal line, sL; nfa will be waiting for it, as indicated by the ‘^{⋆}’ in the guard condition. At this point nfa will be in its receive state, R. In this part of the protocol nfa reads the message arriving via its data line, dL; transfers it directly to its own local memory, M2, and then informs port nf in FIG. 9, via agent na1. The logical negation symbol, [symbol] , in the guard condition, [symbol] nfa:mC?( ) (‘mC?’ for ‘messageCompleted?’) in this part of the protocol is used to continue receiving data until the end of data signal is received. After sending the start signal s to na1, nfa will move to its send state.

The response message from cell B in FIG. 9 will be sent using the protocol described below. TIP at the functionPort nf of cell B might be, for example, nf:mR?( ){nf:r( ).s( );}, where s( ) would send signals and data using the following protocol:

Part iv) Executed by the parent cell of port nf (software):
nf:tC?^{⋆}( ){nf:c→na1:s→nfa;} (24)

When the parent cell B of port n completes its task (‘tC?’ for ‘task Completed?’), nf sends completion signal c to agent na1 in FIG. 9, which sends signal s to the network agent nfa.

Part v) Executed by the microprocessor of network agent. nfa (hardware): At this point nfa will be waiting in its send state to receive a start signal from nfg.
nfa:mR?*( ){nfa:s→sL; M2.nfa:data→dL; nfa:e→sL;}. (25)

Part vi) Executed by the microprocessor of agent nga (hardware): Receives the response data, stores it directly into M1 and informs port ng.
nfg:mR?*( ){while( [symbol] nfg.sL:mC?( )}{nfg.dL:data→M1;}nfg:s→na0:s→ng;}. (25a)

Part vii) Executed by parent cell of ng (software):
ng:mR*( ){ng:Accepted?( ){ng:c→na0:c→nga;} else {s→na0:s→nga;} (26)
Parent cell of ng checks whether the received response message has been accepted. If it is then it sends the completion signal c to nga, signifying that transaction had been successfully completed, else sends the start signal s to restart the transaction.

Part viii) Executed by nga (hardware):
nga:mR?*( ){nga:tC?( ){nga:c→sL;} else {nga:s→sL;}} (27)
Agent nga waits for signal from na0. The guard nga:tC?( ) (‘tC?’ for ‘transaction completed?’) checks for the receipt of completion signal. The received signal is applied to sL.

Part ix) Executed by nfa (hardware):
nfa:mR?( ){nfa:tC?( ){nfa:c→na1:c→nf;} else {nfa:s→na1:s→nf;}} (28)
If transaction was completed successfully then sends completion signal to nf else sends start signal.

Part x) Executed by parent cell of nf (software):
nf:mR*?( ){nf:tC?( ){ } else {nf:r( ).s( );}} (29)
If transaction was completed then nf does nothing; it will move to its receive state R. If transaction was not completed, computations are restarted on the previously received message. This message would have been preserved in the virtualMemory of port nf until transaction was completed.

[image]

The initial state configuration of ports and agents, [ng, na0, nga, nfa, na1, nf] on the pathway in FIG. 9 is [S, S, S, R, R, R]. This will go through the following sequences of state changes:
[S, S, S, R, R, R]->[R′, R′, R′, S′, S′, S′], (30a)
when the port nf in FIG. 9 is notified of new message in virtualMemory M2;
   [R′, R′, R′, S′, S′, S′]->[S′, S′, S′, R′, R′, R′], (30b)
when response message was delivered to port ng in FIG. 9,
   [S′, S′, S′, R′, R′, R′]->[R′, R′, R′, S′, S′, S′] (30c)
if transaction has to be recomputed, else
   [S′, S′, S′, R′, R′, R′]->[S, S, S, R, R, R] (30d)
if transaction had been successfully completed.

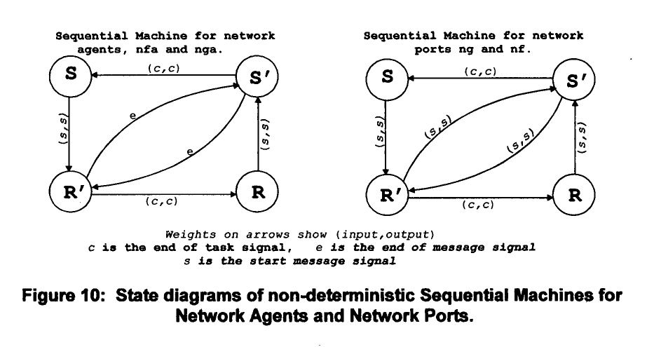

The non-deterministic sequential machine of agents and ports for network message exchange is shown in FIG. 10. All network agents and ports that participate in data exchange over the network pathway, have here four states: S, S′, and R, R′. The network agents, (nga, nfa) have the additional capability to read from and write into the virtualMemories, and apply signals to transmission lines. All ports and agents on a pathway will always remain tuned to each other.

TICC™ has facilities to set up point-to-point network pathways dynamically, when needed. TICCNET™ contains embedded network switches, which are used to set up network connections on the network. We will see how this happens in the group-to-group TICCNET™ protocol described in Section 5.3. Once a TICCNET™ pathway is established it will remain in the network until it is removed by the application program. We now consider group-to-group shared-memory pathway in TICC™.

5.2 Group-to-Group Shared-Memory TICC™ Pathway

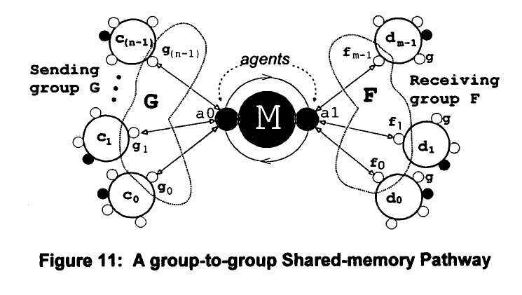

FIG. 11 shows a TICC™ group-to-group shared-memory pathway. The pathway connects the ordered generalPort group, G=[g₀,g₁, . . . ,gₙ₋₁] belonging to cells [c₀, c₁, . . . ,cₙ₋₁], respectively, to the ordered functionPort group, F=[f₀,f₁, . . . ,fₘ₋₁] of cells [d₀,d₁, . . . ,dₘ₋₁]. It has one virtualMemory with agents, a0 and a1, attached to it. The basic protocol for message transmission from ports in G to ports in F is described below.

[image]

Preliminaries: Parent cells of ports in port-group G will here write a joint message into the writeMemory of the virtualMemory M. Each parent cell may complete its task at a different time. The agent a0 is used to coordinate message dispatch making sure that the joint message in M would be sent only after all parent cells of ports in G had completed their tasks and the joint message is ready to be sent. We refer to this as dispatch coordination. When the message is dispatched by a0 the agent a1 will make a synchronized delivery to all functionPorts in F. The method used by agent a0 to perform dispatch coordination is described below. The methods used by the agents to conduct different modes of message dispatch and perform delivery synchronization, are described in Section 6. Just as in the point-to-point situation, message exchange will occur exactly once. Thus, point-to-point message exchange is a special case of group-to-group exchange, in which each group is a singleton group. The protocol described below refers to agents and ports in FIG. 11.

Method used by agent a0 in group-to-group pathway for dispatch coordination: Let cᵢ be the completion signal sent by port gᵢ in G to agent a0 in FIG. 11, for 0≦i≦(n−1). Port gᵢ will do this as soon as gᵢ:tC?*( ) becomes true, i.e., as soon as its parent cell completes its task and sends a completion signal c to gᵢ. Each port gᵢ in G will do this in parallel with all other ports in G, each driven by the processor of its parent cell. Since the parent cells of ports in G may complete their respective tasks at different times, agent a0 will receive these signals at different times. To make sure that message would be sent only after all ports in G had sent their respective completion signals, agent a0 will use an agreement protocol, called a0:AP1?(c₀,c₁, . . . ,cₙ₋₁), which is defined as follows:
a0:AP1?(c₀,c₁, . . . ,cₙ₋₁)=∀(j)(0≦j<n)(cⱼ>0), (31)
where cⱼ is the completion signal sent to a0 by port gⱼ; cⱼ will be greater than zero only if completion signal cⱼ had been received by a0. The group-to-group protocol a0 will use AP1? to sense when all ports in G had completed sending their, respective, completion signals. We will define a guard condition, gᵢ:readyForDispatch?( ) for group-to-group protocol evaluation as follows:
gᵢ:readyForDispatch?( )=gᵢ:tC?*( ){gᵢ:cᵢ→a0; return a0:AP1?(c₀,c₁, . . . ,cₙ₋₁;)} (32)
and define the protocol evaluated by parent cell of each gᵢ as,
gᵢ:readyForDispatch?( ){<body-of-g-to-g-protocol>} (33)
We will soon see what the body of this protocol would be.

Note that this protocol is evaluated in parallel by the parent cells of all ports in G. gᵢ:readyForDispatch?( ) returns true or false depending on whether a0 had received completion signals from all ports in G or not at the time it was evaluated. Parent cells of ports gᵢ for which the guard gᵢ:readyForDispatch?( ) evaluated to false will immediately abandon evaluation of the group-to-group protocol. It is, of course, possible that more than one port gᵢ found the guard gᵢ:readyForDispatch?( ) to be true. This may cause the message to be delivered to its recipients more than once. To prevent this confusion, we will non-deterministically choose one gᵢ and use this to execute the body of the protocol. To do so, we must modify gᵢ:readyForDispatch?( ) as follows:

Let gᵢ:selected?( ) be a method that evaluates to true only for the non-deterministically selected port. Let us arbitrarily choose go to be this selected port. We will now define gᵢ:rfD?( ) (‘rfD?’ for ‘ready for Dispatch?’) as follows:

```
gᵢ:rfD?( ) = (gᵢ:tC?*( ){gᵢ:cᵢ→a0;
                        return (gᵢ:selected?( ) &
                                a0:AP1?*(c₀,c₁,...,cₙ₋₁);))} (34)
```

This new guard condition will be true only for g₀ and only g₀ will wait for AP1?* to become true. Parent cells of all the other ports in G will be forced to abandon evaluation of the group-to-group message delivery protocol. Thus, message will be delivered exactly once. The simple protocol that does all of this is shown below.
gᵢ:rfD?( ){a0:s→a1:s→[f₀,f₁, . . . ,fₘ₋₁]}. (35)

We will refer to this protocol as the basic group-to-group protocol. Here the expression, “a1:s→[f₀,f₁, . . . ,fₘ₋₁]” represents broadcasting of start signal, s, to all the ports fᵢ in F. When this broadcasting is completed message delivery to intended recipients would be complete. The protocol for the response message transmission is similar to the above protocol. The invariant initial state configuration of ports and agents on the pathway, preserved during message exchanges, is [S,S,R,R] and thus agents and ports on the pathway are tuned to each other and high-speed message delivery with a bounded latency is guaranteed. Agent and port sequential machines for group-to-group shared-memory exchange are identical to those of point-to-point shared-memory message exchange.

It may be noted that extra time needed for group-to-group message transmission over and above the time for point-to-point message transmission is the time needed for successful evaluation of the guard, g₀:rfD?( ), and time needed to broadcast the start signals to all the receiving ports. Agent a0 dispatches the message as soon as evaluation of a0:rfD?( ) returns the truth-value true. The interval between the time when the first completion signal c was received by agent a0 to when evaluation of g₀:rfD?( ) returns the value true is unpredictable, because it is not possible to precisely predict when the parent cells of ports in G will all complete their tasks. It is reasonable to take the time at which agent a0 dispatched the message as the time of message dispatch. In this case, the extra time needed for group-to-group message transmission would be the time needed for broadcasting start signals to the receiving ports. For m receiving ports, this time is about km nanoseconds for some k>0. When no time stamps are used k=2 in a 2-gigahertz CPU. Group-to-group communications in TICC™ thus have almost the same latency as point-to-point communications for groups of size ≦10.

As mentioned earlier, after task completion, if gᵢ:rfD?( ) returns false then the parent cell of gᵢ abandons evaluation of the group-to-group protocol. At that point, the parent cell of gᵢ could immediately begin servicing its next port. We will see in Section 6 methods to introduce automatic synchronization into the protocols so that the parent cells of ports in G begin servicing their respective next ports only after the message had been delivered to all of its intended recipient ports in F. Similarly, parent cells of ports in F would be able to sense their, respective, pending messages at the ports in F only after the message had been delivered to all ports in F.

5.3 Group-to-Group Distributed Memory TICCNET™ Pathway

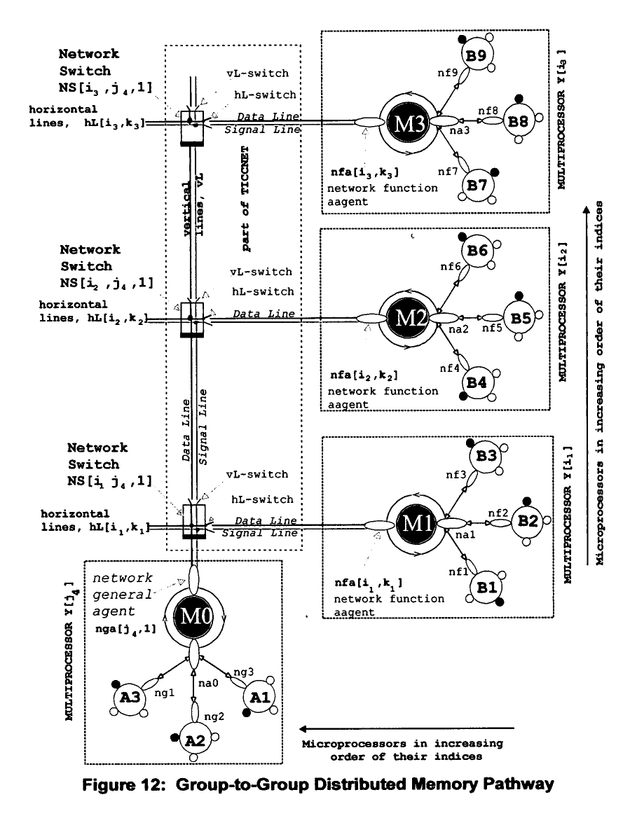

Let us now consider group-to-group distributed memory message exchanges. We will present the protocols both for pathway establishment and for message exchange over an already established pathway. As shown in FIG. 12, group-to-group distributed memory TICC™ pathways interconnect a collection of multiprocessors in a grid. We will refer to the collection of N shared-memory multiprocessors for some N>1, interconnected by a TICCNET™, as the parallel processing grid and use Y[i] to refer to each multiprocessor, for 0≦i<N. The message sending generalPort group, [ng1, ng2, ng3] at the bottom of FIG. 12, is in the multiprocessor, Y[j₄]. This is called the source group of the network pathway, since service-request messages will originate here. Let G[h₁] refer to this source group, G[h₁]=[ng1, ng2, ng3]. The message receiving functionPort groups are distributed among multiprocessors Y[i₁] Y[i₂] and Y[i₃] on the right side of FIG. 12. Let us call these functionPort groups F[h₂]=[nf1,nf2,nf3], F[h₃]=[nf4,nf5,nf6], and F[h₄]=[nf7,nf8,nf9]. Ports in G[h₁] are connected to (tuned to) the agent na0 at the bottom of FIG. 12. Such a port-group with an agent connected to it is called a network probe. We will use the name of a port-group to also refer to the probe that contains that group. Thus, G[h₁] will be the name of the generalPort probe at the bottom of FIG. 12; this is a source probe. Similarly, on the right side of FIG. 12, we have functionPort probes F[h₂], F[h₃] and F[h₄], with agents na1, na2 and na3, respectively. They are called destination probes.

Each group G[#] and F[#] will have a group leader. We will choose the first port in each group as its group leader. Thus, ng1 will be group leader of G[h₁],nf1 will be group leader of F[h₂] and nf1 will be the group leader of nF[#] as well. We will call the pathways used for such communications as point-to-group network pathways since it will always be between one sending multiprocessor and a group of receiving multiprocessors. We will use the name nF[#] of the network functionPort group to also refer to the pathway that connects to this group. The definition of this pathway is given below.

We use Y[i].G[#] to refer to the source probe G[#] in the multiprocessor Y[i] and Y[i].F[#] to refer to the destination probe in Y[i], where ‘#’ is an integer. These probe names will be unique over all the multiprocessors in the grid. The union of the functionPort groups in FIG. 12 will constitute the network functionPort group nF[#] of the pathway in FIG. 12.

[image]

The pathway, nF[#], is
nF[#]=[Y[j₄].G[h₁],[Y[i₁].F[h₂],Y[i₂].F[h₃],Y[i₃].F[h₄]], (37)
where
nF[#].src=Y[j₄].G[h₁], ‘src’ for the ‘source’ probe and (38)
nF[#].dstnv=[Y[i₁].F[h₂], Y[i₂].F[h₃], Y[i₃].F[h₄]], (39)
‘dstnv’ for ‘destination vector’. Entries in the destination vector will appear in the order of increasing multiprocessor indices. In general, the definition of a point-to-group network pathway will have the form,
nF[#]=[Y[j].G[#],[Y[i₁].F[#],Y[i₂].F[#], . . . ,Y[iₘ].F[#]] (40)
where ‘#’ stands for integers such that all the port-group names are distinct from each other.

The grid may contain as many as 512 multiprocessors, each with 32 to 64 CPUs⁸. A TICCNET™ for a grid of this size was designed with the following criteria: Every message should be sent immediately, as soon as they are ready with precisely predictable latencies. Number of messages that could be sent in parallel should be limited only by the number of independent pathways in the TICCNET™. In the network we designed, there were 2048 independent point-to-point channels. The number of point-to-group pathways would depend on group sizes. If the average group size is n (i.e. each multiprocessor in the grid communicated on the average with n other multiprocessors) then the average number of independent channels will be 2048/n. We have assumed, since hardware is much cheaper than software we may use as many hardware components as we please, even though most of them remain idle in most applications.
⁸ Such a TICCNET™ has been design, but has not been implemented yet.

We will now discuss the protocols used to set up point-to-group distributed memory network pathways and the protocols used to exchange messages over already established point-to-group pathways. In this discussion, we use the agent nga[j₄,1],at the bottom of FIG. 12, as the source nga. We do not describe hardware details of the network switch array in which pathway connections are established. Only the software aspects are described here. We begin in section 5.3.1 with a description of the structure of point-to-group network pathway shown in FIG. 12 and notations used to refer to its various components.

5.3.1 TICCNET™Structure

The pathway in FIG. 12 has four virtualMemories, M0, M1, M2 and M3, one in each multiprocessor. In this figure, messages are exchanged between the writeMemory of virtualMemory MO at the bottom, and readMemories of ordered group of virtualMemories [M1,M2,M3] on the right. Message exchanges would occur through direct memory-to-memory data transfers. The same message in M0 will be transmitted in parallel to every virtualMemory in the group [M1,M2,M3] and multiplexed responses from each Hi for i=1,2,3 will be gathered together in M0 in sequence. The network transmission lines that interconnect these virtualMemories come in pairs. In this example, the pairs are a signal line, sL, and a data line, dL.

The pathway has a network general port nga[j₄,1] at its bottom. This is the 1^{st} nga of the multiprocessor Y[j₄]. We assume, each multiprocessor will have four (an arbitrarily chosen number) nga'S and four nfa'S. The pathway has three network function agents on the right, nfa's, nfa[iⱼ,kₗ], called the destination agents, one in each multiprocessor Y[iⱼ]. The destination agents, nfa[iⱼ,kₗ] would receive messages sent by the source agent nga [j₄,1]. Each nga and nfa will be a hardware object, a dedicated microprocessor. Ports ng, nf and agents na in FIG. 12 are network ports and network agents; these will be software objects. For each agent na we will write na.vM to refer to the virtualMemory M attached to na and write na.next to refer to the next agent in clockwise direction that is also attached to na.vM. Thus, at the bottom of FIG. 12 nga[j₄,1].vM=M0,nga[j₄,1].next=na0 and na0.next=nga[j₄,1].

Each one of these network ports ng's, nf's, network agents na's, network generalPorts nga's and network functionPorts nfa's will be a four state non-deterministic sequential machine, as in the case of point-to-point network pathways, shown in FIG. 10. Messages exchanged will be coordinated through signals exchanged among the agents on the network pathway via signal lines. All agents and ports on a network pathway will always be tuned to each other.

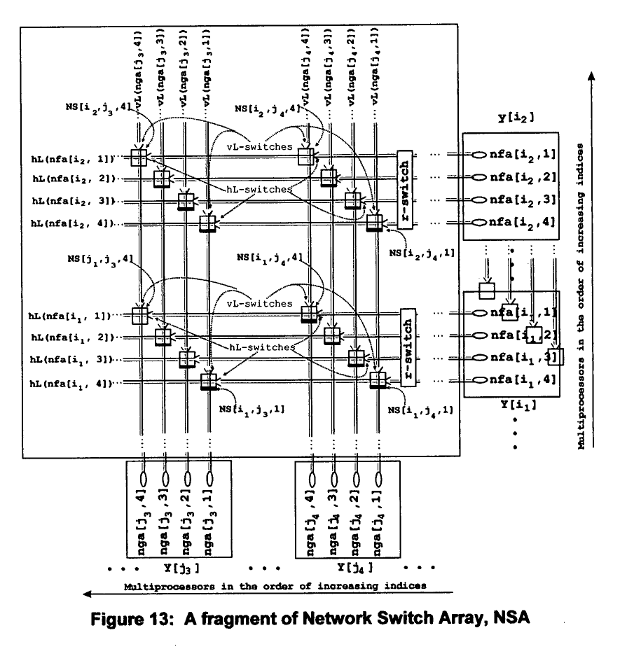

We use vL(nga) to refer to the vertical pair of lines connected to an nga. In FIG. 12, the pair of vertical lines vL(nga[j₄,1]) are connected to nga[j₄,1] at the bottom of FIG. 12. We will use hL(nfa) to refer to the horizontal pair of lines connected to an nfa. If a computing grid has N multiprocessors, then the network switch array will have 4N vertical line pairs, vL(nga), and 4N horizontal line pairs, hL(nfa), since each multiprocessor will have 4 nga's and 4 nfa's. These vL(nga)'s and hL(nfa)'s are organized into an array of vertical and horizontal lines, as shown in FIG. 13. At the intersection of each vertical and horizontal line (nga[j,k₁], nfa[i,k₂]) for 1≦k₁,k₂≦4 (please see FIG. 13), there will be a network switch, NS[i,j,k₁], as shown in FIG. 13. The index, i, here will be used by the network switch NS[i,j,k₁] as its local identity, called local-id. All network switches, in any one row of the network switch array, connected to a multiprocessor Y[i] through a horizontal line, will have the same local-id, i. Since there will be no network pathways from a multiprocessor to itself, the total number of switches in a Network Switch Array (hereafter referred to by the acronym, NSA) for a grid with N multiprocessors will be [(N×4)×(N×3)].

Each network switch in FIGS. 12 and 13 has a small vertical line switch, VL-switch, on top of it, a small horizontal line switch, hL-switch, and a small rectangular dark band at its bottom. This band is a modulo k counter for some k<m<N, where m is the number of elements in the description vector of the pathway definition shown in (40). We will later see how these VL-switches and hL-switches, and the counters are used to send multiplexed response messages in sequence from the destination multiprocessors to the source multiprocessor. Initially, all the VL-switches in a network switch array will be in closed position, all hL-switches will be in the open position and all counter contents will be zero.

Each group of four horizontal lines, go through a router switch, marked r-switch, in FIG. 13. This router switch will connect a vertical line to the first available free nga on the multiprocessor to which it is connected, when requested by a network switch on that vertical line. Since we have assumed that there would be no more than four pathway requests from any multiprocessor, no more than four pathways will connect to any multiprocessor, and all pathways would be non-intersecting. There will be no contention for horizontal line connections. If we allow dynamic network pathway establishment, then special facilities should be provided to resolve possible horizontal line contentions. We will not discuss them here.

5.3.2 Network Switch and Pathway Establishment Protocol

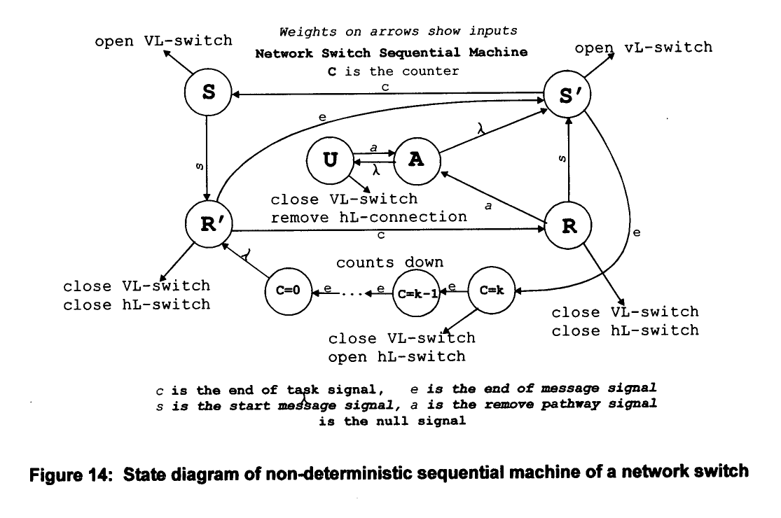

We now present the structure of a network switch and describe how pathway connections are made. In this discussion, we will choose nga[j₄,1] in FIGS. 12 and 13 as the candidate source nga that is seeking to establish pathway connections. Each network switch, NS[i,j₄,1], for i=i₁,i₂, . . . , in FIG. 13 will be a (6+k) state non-deterministic sequential machine, shown in FIG. 14, with a counter C which counts down from an integer 0≦k<m≦N−1, where m is the number of elements in the description vector of pathway definition, shown in (40). Each NS[i,j₄,1] will be in its active state, A, when there are no horizontal pathways connecting its pair of vertical lines, vL(nga[j₄,1]), to any of the horizontal lines. All the vL-switches on vertical lines will be closed, all the hL-switches will be open and all counters will be at zero. All network switches on vertical lines will be monitoring the vertical lines for signals that may flow through them, requesting a pathway to be established.

When a pathway needs to be established, the source nga[j₄,1] will broadcast to all network switches on vL(nga[j₄,1]) the destination vector, nF[#].dstnv of the pathway definition nF[#] shown in (40). This will consist of a sequence of pairs of multiprocessor indices and functionPort group indices: We will assume, each one of these indices will be a 16-bit integer. Thus, each element of the destination vector will be a 32-bit integer. Let
[i₁#₁ i₂#₂ . . . iₘ#ₘ] 1≦m≦(N−1) (41)
be this sequence of 32-bit integers, for i₁<i₂< . . . <iₘ. The indices #j for j=1, 2, . . . m will be indices of destination probes in the multiprocessors Y[iⱼ].

Each network switch, NS[i,j₄,1] for i=0, 1, . . . , N−1 on the vertical line nga[j₄,1] will be listening to this broadcast, in its receive state A. It will respond to the broadcast only if its own local-id, is included in the indices i₁<i₂< . . . <iₘ. If it is included, then it does the following: save the 32-bit integer, iⱼ#ⱼ for which iⱼ=local-id, in its local memory and start counting the number of 32-bit words that follow this selected iⱼ#ⱼ in the destination vector. This number is the integer k used by the counter of NS[i,j₄,1], in the range 0≦k<N. When the end of data signal is recognized, NS[i,j₄,1] does the following sequence of actions: (i) save the count k in a local register, (ii) open vL-switch and close hL-switch, (iii) get its vertical line, vL(nga[j₄,1]), connected to a horizontal line, hL(nfa[i,j]) of a free nfa[i,j], for 1≦j≦4, via its router switch, r-switch, and (iv) send the destination probe index #ⱼ to the destination agent nfa[i,j]. After this, NS[i,j₄,1] moves to its state S′ through a λ-transition, as shown in FIG. 14. The input λ in is the null symbol, i.e. no input is received. These transitions, called null transitions, are internal to the sequential machine. At this point, the counter of each network switches, NS, on the vertical line vL(nga[j₄,1]), that is connected to a horizontal line, will have the count k for that NS in its counter. No other network switch could again connect to the same horizontal line and the just established connection will remain until the pathway is removed.

[image]

If the local-id of a network switch did not match with any of multiprocessor indices i₁<i₂< . . . iₘ in the received destination vector, then the network switch moves to its mute state, U, through a λ-transition, as shown in FIG. 14. This closes its VL-switch and opens hL-switch. In state U the switch becomes inactive, henceforth, listening only to signal, a, on the vertical signal line. Receipt of this signal, a, would indicate that the previously established pathway is being destroyed and removed. The network switch would then move back to its active state A, after removing the hL-connection. In state, A the switch waits for information on a new pathway that may have to be established. These transitions are shown in FIG. 14.

[image]

At this point, each network switch on vL(nga[j₄,1]), which made connection to nfa[i,j], will be waiting to receive a signal from nfa[i,j] to which it had sent the functionPort probe index #ⱼ. Thus, each network switch on the vertical line vL(nga[j₄,1]) would have either opened the vL-switch on its top, closed its hL-switch, made a connection with a horizontal line, and moved to state S′, or moved to the mute state U and closed its VL-switch.

All the VL-switches on top of network switches that made the horizontal line connection to a multiprocessor, will be open. Only the network switch connected to the multiprocessor with the smallest local-id in the destination vector of the pathway definition, will now be connected via the vertical line vL(nga[j₄,1]) to the source agent, nga[j₄,1] at the bottom in FIG. 13. This switch will be the only one for which nfa:pR?*( ) (pathway Ready?) will be true. It and only it will be ready to transmit signals.

When nfa[i,j] has established the requested connection to the destination probe, and if nfa[i,j]:pR?*( ) is true, it will send an end of data signal, e, to the network switch, NS[i,j₄,1]. This signal will also reach the source network general agent, nga[j₄,1]. Receipt of this signal will cause NS to move to its state C=k, as shown in FIG. 14. The protocol for this part of the interactions is described in the next subsection.

5.3.3 Protocol for Network Pathway Establishment

All the switches, NS[i,j₄,1] for i=0, 1, . . . , N−1, on the vertical line vL[j₄,1] execute the protocol given below in parallel. The virtualMemory of the source nga[j₄,1] at this time will contain the bit string of the pathway destination vector shown in (41), and the source probe will be connected to the virtualMemory of nga[j₄,1]. (We will later see how this would happen). The method rfD?( ) used below is the ‘ready for Dispatch?’ guard defined in (34). We use vsL and vdL for vertical signal and data lines, and hsL and hdL for horizontal signal and data lines and use vL and hL to denote the respective pairs of lines. We simply use a generic nga in the code instead of nga[j₄,1]. Similarly, we will use generic network switch NS, nfa, ng, nf and na (please see FIG. 12).

Executed by parent cells of generalPorts in the source probe (software): ng is the network generalPort in the source probe; nga.next is the network agent, na (see bottom of FIG. 12); ng sends off whatever is in the virtualMemory by executing ng:s( ).
(1) This causes the following to happen: ng:rfD?( ){s→nga.next:s→nga;}
Executed by the source network agent, nga (hardware):
(2) nga:mR?*( ){s→nga.sL; nga.vM.data→nga.dL; e→nga.sL;}
Executed by all network switches NS on the vertical line, vL(nga) (hardware): At this point NS will be in its state A. The guard [symbol] mC?( ) (message Complete?) checks for the end of data signal; r1, r2 and r3 are local registers of the network switch NS; data is stored in r1 in 32-bit words; we assume that the maximum number of words r1 can hold is N and we use r1[i] to access the word at index i in r1. The first 32 bit zero encountered in r1 will mark the end of data; r3 is a 32-bit register. NS:match?( ) will be true if the first sixteen bits of a 32-bit word in register r1[i] matches with the local-id of the NS. We assume that r2 and r3 would be initialized to 0.

(3)

```
NS:mR?*( ){while( [symbol] NS.vsL:mC?( )){NS.vdL.data →r1;}
                unsigned int i = 0; Bool b = false; r2 = 0;
                open(vL-switch); close(hL-switch);
            while (r1[i]≠0){
                  NS:match?( ){r1[i]→r3; //saves r1[i] in r3.
                        b = true; }//a match has been found.
                  i++;}
            /*counts non-zero words after the match; r2 will be equal
            to (m − i), where m is the number of 32-bit elements in
            r1.*/
            if (b) {while (r1[i]≠0){r2++;}
            /* NS.r-switch sets up a connection between NS and an nfa.
            No arguments are needed.*/
            NS.r-switch:connect( ); r1:clear( );/*clears r1.*/
            /*once connected to an nfa sends the 32-bit word in r3 to
            nfa.  This will contain the identity of the destination group
            to be connected to nfa. After doing this, NS moves to its
            state S′ through a λ transition, as shown in Figure 14.*/
            NS.hsL:pR?*( ){s→NS.hsL; r3→NS.hdL; e→NS.hsL;}
        }//At this point all vL-switches will be open,
```

Executed by all nfa's connected to NS's (hardware): At this point, each nfa connected to an NS on vL(nga) will be in its receive state, R It receives the identity of the destination group sent to it by the NS that is connected to it, and forwards this to whoever is tuned to nfa. next. After doing this, nfa moves to its send state S′.

(4)

```
nfa.hsL:mR?*( ){while( [symbol] nfa.hsL:mC?( )){
                          nfa.hdL.data: →nfa.vM;}
                nfa:s→nfa.next:s→ nfa.next:tunedPorts( );}
```

Before we describe what happens next, we need to know who receives the information on the destination probe and acts on it. This is described below.

As described in Section 5.3.4, there is a dedicated subclass of Cell called Configurator. Each multiprocessor Y[i] contains an instance of this cell. We call it Y[i].config, and refer to it as the local configurator of Y[i]. Y[i].config is responsible to install all required cells and pathway connections in Y[i]. As explained in Section 5.3.4, at the time a network switch NS forwards the contents of its register r3 (namely, the identity of the destination probe) to an nfa, the local configurator, Y[i].config, will be connected to the agent nfa.next on the virtualMemory attached to nfa. In FIG. 12, the network agent na1=nfa[i₁,k₁].next, in the first multiprocessor at lower right, is such an agent referred to by nfa.next. Thus, the message specifying the functionPort probe index will be delivered to Y[i].config, which will respond to this message by detaching itself from nfa.next and tuning (connecting) in its place, the destination probe with the specified probe index in the received message, and activating all the cells in that probe. This will be done in parallel by every Y[iⱼ].config for the indices iⱼ=i₁,i₂, . . . ,iₘ that appeared in the destination vector.

Now we can continue the protocol from where we left off. We use config for a generic Y[i].config and config.f for a generic function port of the config.
Executed by all Y[i].config's connected to nfa.next (software): The method r( )(‘r’ for respond) here switches the Y[i].config with the destination probe specified in the received message and activates all cells in that probe, and initializes the stated of the functionPorts in the destination probe to state S′.
(5) config.f:mR?^{⋆}( ){config.f:r( );}
nf:s( ); is executed by each cell in destination probe while its port, nf, is in state S' (software): nf:s( ); causes a completion signal c to be sent to nfa via nfa.next. After doing this nf moves to state R′.
(6) nf:rfD?( ){nfa.next:c [symbol] nfa;}
Executed by each nfa connected to vL(nga) (hardware): nfa is ready to send data. It checks to see whether the pathway to nga is ready, by evaluating the, guard nfa.hsL:pR?^{⋆}( ). At the beginning pathway will be ready only for the multiprocessor with the smallest index in the destination vector. nfa sends an empty message. After sending the empty message nfa goes to its state R′ (see FIG. 10).
(7) nfa.hsL:pR?*( ){s [symbol] hsL; e [symbol] hsL;}
Executed by all network switches, NS's connected to nfa's (hardware): The mC?^{⋆}( ) guard checks for an end of data signal on vL(nga). When NS sense this signal it moves to c=k state (see FIG. 14), closes its VL-switch and opens its hL-switch. In this state, NS looks only for end of data signals on vL(nga). Closing the VL-switch connects the next NS on vL(nga) to the source nga. This causes the next nfa to execute the code in line (7) above, which causes another end of data signal to be sent via vL(nga). Every time each NS on vL(nga) senses the end of data signal on the signal line of vL(nga), its counter decrements its count by 1 (see FIG. 14). When all the nfa's connected to vL(nga) had sent the end of data signals, all the counters of all NS on vL(nga) will be zero. This will cause all the NS to move to state R′ (See FIG. 14), at which point connection between hL and vL is reestablished. This is the multiplexing scheme used to send back response messages.
   NS.vsL:mC?*( ){ }
Executed by nga (hardware): The source nga will be expecting responses in the order the destination multiprocessors appeared in the destination vector. It will have the number of multiprocessors that the destination vector had. Let n be this number. It uses this number in the code below. No message is saved because the messages would be empty.
(8) unsigned int i=0;
   nga:mR?*( ){while(i<n){nga.sL:mC?( ){i++;}nga:s [symbol] nga.next:s [symbol] nga.next:tunedPorts( );}
This informs the cells in the source probe that pathway has been established. The source probe cells will simply send back a completion signal indicating that they accept task completion.
Executed by ports c.ng of cells c in the source probe (software):
(11) C.ng:c [symbol] nga.next:c [symbol] nga;
Executed by NS's, destination nfa's and destination probes (hardware):
(12) NS.vsL:tC?^{⋆}( ){ }//simply changes its state to R and does nothing else.
(13) nga.hsL:mR?*( ){nga:c→nga.next:c→nga.next:tunedPorts( );}
(14) nf:tC?*( ){ }

The completion signal travels to all the NS on vL(nga) since all the vL-switches will now be closed. It also travels to all nfa's connected to vL(nga). Eventually this signal reaches the cells in the destination probes. When it does, the functionPorts in the destination probes are reset to state R. The agents they are tuned to, all nfa's, and all NS are reset to state R, in parallel. The source nga, agent na0 and port ng all move to state s, thus enabling the source probe to send a message at any time it pleases.

[image]

The entire protocol has about 20 lines of code and operations automatically occur in parallel with no scheduling or operating system intervention, triggered every time by signals sent by CCPs. Agents and ports that exchange signals on a pathway are always tuned to each other and thus no synchronization sessions are needed. Execution of the entire protocol should not take more than a few microseconds (estimated). Thus, pathways may be established quite fast as long as contention for nfa's are avoided.

We will now describe the computational infrastructure that is needed to define network pathway definitions, and start parallel execution of the protocol defined above in all the multiprocessors in a grid.

5.3.4 Computational Infrastructure for Network Pathway Definitions

As mentioned earlier, each multiprocessor Y[i] will contain an instance of Configurator called Y[i].config. Let Y[0]=L, be the leader of all multiprocessors in a grid and let L.config refer to the local configurator in L. L.config will be responsible to define, install and manage all network port-groups and network pathways.

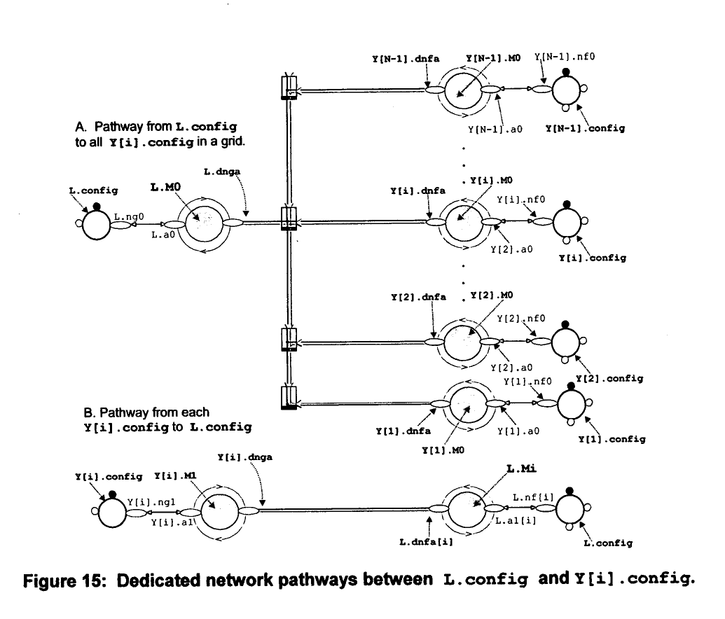

The leader L and each multiprocessor Y[i] will have certain number of dedicated nga's and nfa's, in addition to the four mentioned earlier. These dedicated nga's and nfa's, called dnga's and dnfa's, are used for communication between Y[i].config's and L.config. L will have one dedicated source nga, called L.dnga, and (N−1) dedicated destination nfa's, L.dnfa[i] for 1≦i≦(N−1). Each Y[i] other than L, will have one Y[i].dnga and one Y[i].dnfa. The dedicated network pathways that interconnect these dedicated network agents are shown in FIGS. 15A and 15B. L will use the pathway in FIG. 15A to broadcast messages to all Y[i], i≠0. Each multiprocessor Y[i], i≠0, will use its dedicated pathway, shown in FIG. 15B, to send messages to L.config.

We will assume that all multiprocessors come equipped with the necessary hardware network agents, nga, nfa, dedicated agents, dnga and dnfa, and the network comes equipped with the necessary network switch hardware. All software ports and agents are installed at the time the shared-memory TICC™-pathways are installed and initialized. We assume that the TICCNET™ has the dedicated pathways interconnecting the appropriate dedicated network agents, shown in FIGS. 15A and 15B, already installed in it.⁹ Application programmers define and install the application dependent cells, pathways, and the Configurator cell in the multiprocessor for each application, using a TICC™-Gui (Graphical user interface), which displays the network as it is being created. The network may be constructed and modified by editing the diagram on the display.
⁹ The current proof of concept prototype TICC™-Ppde runs in only one multiprocessor. The TICCNET™ has not yet been implemented.

When the main program of an application is started in the leader L, using the operating system, it installs the local config, L.config and activates it to run in a CPU of L and then activates the main program in each multiprocessor Y[i], i≠0. The starting and ending times area the only times the operating system is used by TICC™-Ppde. All resource allocations are done at the time or program compilation.

The main program of each Y[i], installs and activates the local config, Y[i].config, for each multiprocessor Y[i] for 0<i<N. Each Y[i].config will be aware of the index i of the multiprocessor Y[i] to which it belongs. The initialization routine of L.config installs the pathways [L.ng0, L.a0, L.dnga] at left in FIG. 15A, and the pathways [L.nf[i], L.a1[i], L.dnfa[i]] at right in FIG. 15B, together with the necessary virtualMemories. Similarly, the initialization routines in Y[i].config installs the pathways [Y[i].nf0, Y[i].a0, Y[i].dnfa] on the right side of FIG. 15A, and pathways [Y[i].ng1, Y[i].a1, Y[i].dnga] on the left side of FIG. 15B. This connects all the already existing designated pathways in TICCNET™ to L.config and Y[i].config for 0<i<N.

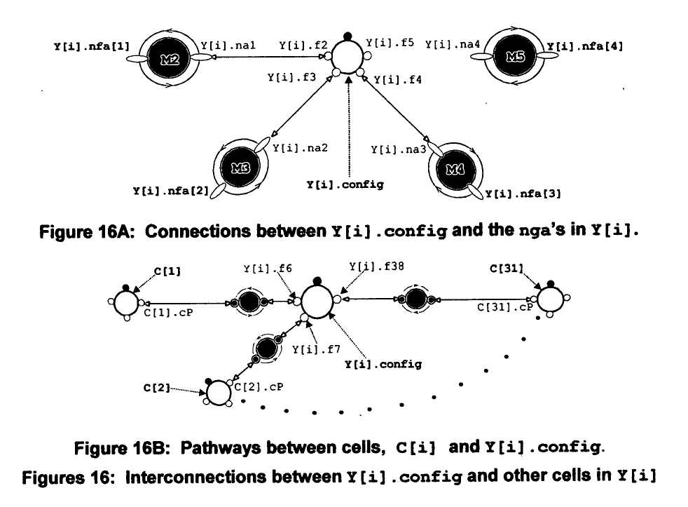

Y[i].config for 0≦i<N also installs the pathways [nfa[i,j], Y[i].a(j+1), Y[i].f(j+1)] shown in FIG. 16A, for 1≦j≦4 (we have assumed that each Y[i] has four nfa's and four nga's). This connects each nfa in Y[i] to a functionPort in Y[i].config. This guarantees that when network pathways are later established interconnecting the nfa's and nga's in the multiprocessors of the grid, pathways connected to Y[i].nfa's will each have a functionPort of the Y[i].config connected to that pathway, to receive a message and respond to it. Thus, as we have seen, the first message that is sent by any cell via a network pathway will be responded to by Y[i].config.

Each cell installed in a multiprocessor Y[i] for 0≦i<N is connected to a functionPort of Y[i] config as shown in FIG. 16B. Each cell, C[i], 1≦i<32 (we are assuming, each multiprocessor has 32 CPUs, and one is used to run the config) has a designated generalPort called C[i].cP (‘cP’ for ‘config Port’), which is connected to a functionPort of its local configurator. This pathway is used by cells in a multiprocessor Y[i] to communicate with their local configurator, Y[i].config.

Each Y[i].config has a Cell Interaction Protocol, CIP, defined for it that contains an initialization routine. By completing the execution of initialization routines, each Y[i].config installs in Y[i] all shared-memory cell-groups and shared-memory pathways that are used in the application. Some of these shared-memory cell-groups are used in the local shared-memory TICC™-network in Y[i]. For others, Y[i].config constructs network probes and keeps them ready to be connected to network pathways, when they are later defined and installed. Each such network probe has a unique identity. As mentioned earlier, shared-memory generalPort probes in a multiprocessor Y[i] have identifies of the form Y[i].G[#], shared-memory functionPort probes have identifies of the form Y[i]i F(#, where ‘#’ is an integer. These identities of port-groups are communicated to L.config using the dedicated pathways. Each probe may have arbitrary number of ports. In practice, they will have no more than five ports in it.

[image]

The number of cells in each multiprocessor, not counting the config, is always less than the number of CPUs in that multiprocessor, since each cell runs in its own assigned CPU. With multicore chips, this number may be much higher than 32 in each multiprocessor.

It is the responsibility of application programmer to define appropriate initialization routines for the config subclasses and cell subclasses used in each multiprocessor of their application. Using the interface provided, the application programmer defines network port-groups and pathways in the initialization routine of L.config, using identities of shared-memory port-groups communicated to L.config. Once all such network pathways are defined, L.config broadcasts the set of all pathway definitions to all multiprocessors using its dedicated pathway in FIG. 15A.

The local configurator Y[i].config of multiprocessor Y[i] that receives this message elicits from the message those pathway definitions that contain the source probe Y[i].G[#], and saves the definitions in its local memory. The broadcast by L.config thus defines the source and destinations of all point-to-group network pathways in the TICCNET™. Since we have assumed, each Y[i] contains only four nga's there should never be more than four network pathway definitions for each Y[i] and more than four source probes Y[j].G[#]. Let Y[j].G[1], Y[j].G[2], Y[j].G[3] and Y[j].G[4] be the source probes in multiprocessor Y[j].

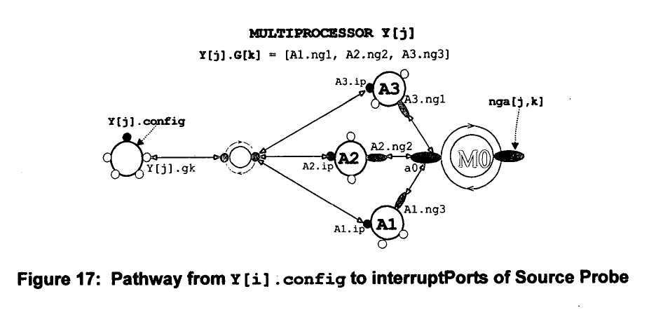

After picking up the pertinent pathway definitions, the first task Y[j].config performs is the following: For each source probe Y[j].G[k], for 1≦k≦4, each Y[j].config sets up a local shared-memory pathway from one of its generalPorts to all the interruptPorts of the parent cells of ports in Y[j].G[k]. For example, the pathway thus established by Y[j].config in the multiprocessor Y[j] at the bottom of FIG. 12, for the source probe shown in that figure, is shown in FIG. 17. After doing this, all configurators Y[j].config for 0≦j<N begin in parallel the task of network pathway establishment for source probes Y[j].G[k] for 0≦j<N and 1≦k≦4. This happens as follows.

[image]

Each Y [j].config for 0≦j<N connects the source probe Y[j].G[k] for 1≦k≦4 to the source agent nga[j,k] via the virtualMemory attached to nga[j,k], as shown at the bottom of in FIG. 12. After making the attachments each Y[j].config broadcasts to the interruptPorts of cells in each probe Y[j].G[k] for 1s k<4, the pathway definition associated with the probe Y[j].G[k], using the shared-memory pathway shown in FIG. 17. Receipt of this message activates all the cells in each Y[j].G[k]. Each cell in each Y[j].G[k] then begins executing its initialization routine. All the cells in Y[j].G[k], except the leader of Y[j]. G[k] immediately sends back an acknowledgement to Y[j].config. The leader copies the pathway definition message in the virtualMemory of its interruptPort into the virtualMemory attached to nga[j,k] and then only sends back acknowledgment to Y[j].config. This step installs in the virtualMemory of each source nga the bit string in (41). After this, all the cells in each Y[j].G[k] send out in parallel the message just written into the virtualMemory, nga[j,k].vM. This begins the execution of the pathway establishment protocol in Section 5.3.2. The methods executed by Y[j].config and source probes are defined below.

Executed by Each Y[j].config:

```
void Configurator::setUpPathway( ){
    /*When the port Y[i].config receives the pathway description message
    from L.config (see Figure 15A) it picks up definitions that are
    pertinent to Y[i] and saves the definitions in the local vector PDV
    (pathway definition vector) using the getDefinitions( ) method, and
    acknowledges receipt of message back to L.config. */
    nf0:mR?*( ){nf0:getDefinitions( ).s( )}
    for (int i=0; i < PDV.size( ); i++){
        //tunes (attaches) probe PDV[i].src to the virtualMemory of
        nga[i].
        tune(PDV[i].src, nga[i].vM);
      /*Activates all cells in the probe PDV[i].src by sending an interrupt
      message to them, via its generalPort, g[i]. g[i]:x( ) will write the
      pathway definition, PDV[i], into the virtualMemory of g[i] before
      the message is sent.. */
        g[i]:pR?( ){g[i]:x( ).s( );}}
  }
```

Each cell in each source probe in every multiprocessor now begins to execute its initialization routine. This invokes and executes the following Cell:setUpPathway( ) methods.

Part ii) Executed by each cell in each source probe: We assume, in each source probe the generalPort in the port-group of the probe is ng. This port is connected through the agent nga. n t to nga, similar to the way port ng1 in FIG. 12 is connected to its nga via nga.next=na0; iP is the interruptPort through which the parent cell of ng received the activation message from its local config.

The leader of the source probe executes the following in parallel with all other cells in the probe: There is no need to check pathway readiness. Copies message in the virtualMemory of iP into the virtualMemory connected to ng, and sends it off; acknowledges receipt of interruptPort message to its config.
void LeadingSourceCell::setUpPathway( ){true{ng:copy(iP).s( ); iP:s( );}}

All other cells in the source probe execute the following in parallel: Acknowledges receipt of interruptPort message and sends off message via the network port ng.
void SourceCell::setUpPathway( ){true{iP:s( ); ng:s( );}}

These methods start the parallel execution of the pathway establishment protocol defined in Section 5.3.2 in every multiprocessor of the grid. When this is completed, all needed network pathways would have been established. It is assumed here that pathways use no more than four source probes and no more than four destination probes in each multiprocessor, and port-groups in no two probes intersect. Coordination is achieved through signals exchanged through the signal lines. For every signal sent by a sender, its recipient receives and responds to it immediately. No state checking or synchronization sessions are necessary. These features combined with self-scheduled parallel executions enable high-speed pathway establishment.

As mentioned earlier, it will take no more than a few microseconds to establish a pathway. Pathways may be installed and removed dynamically. However, this will require the network switches to be modified to account for possible nfa contentions, when more requests to make connections to nfa appear than the available number of nfa's in a multiprocessor. Dynamic installation and removal are not discussed further here. Suffice to say, in this case, pathway establishment might no longer occur in the order the requests arrived, even though pathway establishment would be guaranteed. We now present the message exchange protocol over a point-to-group distributed memory pathway.

5.3.5 Protocol for Message Exchange Over a Point-to-Group Network Pathway

When a pathway from a source nga to destination nfa's is established, the signal and data lines of the source nga are connected to all the destination nfa's. They remain so connected, except when response message are being sent back one by one through the multiplexing arrangement controlled by the VL-switches and counters in each network switch. Any time the source nga needs to send a message, it does so without having to go through any synchronization sessions. All the switches and destination agents on the pathway are ready to receive the message sent by the source nga. Of course, the source probe can initiate a message exchange session only if all of its network general ports are in state, S, indicating that the pathway is ready. TIPs in each CIP make sure that every port in a grid sends its message only when the pathway connected to that port is ready to send a message. Multiplexed message response in every message exchange session is automatic. Responses always are sent in the order of increasing multiprocessor indices. Note that every cell in a source probe has saved in its local memory the pathway definition, nF[#], for the pathway it is connected to.

Let nga:dv.size=n, be the local variable of each nga, which holds the size of the destination vector in its pathway definition. We use C to refer to a generic cell in the source probe and C.ng to refer to a generic generalPort of C. We use D to refer to a generic destination cell and D. nf to a generic destination functionPort. Let us assume, the TIP at C.ng was C.ng:pR?( ){C.ng:x( ).s( )} where C.ng:x( ) constructs and writes the service request message in the virtualMemory of C.ng. The protocol for C.ng:s( ) is,
C.ng:rfD?( ){C.ng:c→nga.next:s→nga;} (42)
where rfD?( ), stands for ‘ready for Dispatch?’, is the guard defined in (34); ng and nga.next change state from S to R′. The message exchange protocol coordinated by nga, may now be written as given below: We use sL and dL for generic vertical signal and data lines. We use NS to denote a generic network switch. The NS need not forward the signals on sL and dL to the nfa's since these lines are connected to the corresponding lines of the nfa, except when response messages are being sent in the multiplexed mode. However, the NS will have to monitor the signals on sL in order to change its own state in the appropriate manner to conduct the multiplexed response message sending protocol.

Message Exchange Protocol for Point-to-Group Distributed Net Pathway:

Executed by nga (hardware): Does not check for pathway readiness: nga moves from state S to R′ after executing the following.
(1) {nga:s→sL; nga.vM:data→dL; nga:c→sL;}
Executed by NS to change its state from R to S′ (hardware):
(2) sL:mR?*( ){ }
Executed by the nfa: nfa would be waiting for the signal; nfa, nfa.next and nfa.next:tunedPorts( ) all change state from R to S′.
(3) nfa:mR?*( ){while ( [symbol] nfa.sL:mC?( )}{nfa.dL:data→nfa.vM;}nfa:s→nfa.next:s→nfa.next:tunedPorts( );}
Executed by each destination probe functionPort (software). D.f and nfa.next change state from S′ to R′.
(4) D.f:rfD?( ){nfa.next:s→nfa}
Executed by nfa's to send response messages and change state from S′ to R′ (software):
(5) nfa:mR?*( ){nfa:pR?*{nfa:s→sL; nfa.vM.data→dL; nfa:e→sL;}}

Executed by NS to change its state from so to counter state (c=k) (FIG. 14) (hardware): See FIG. 14.
(6) NS.vL:mC?*( ){ }
Executed by Ns: See FIG. 14
(7) NS.vsL:mC?*( ){ }//decrements counter, if >0.
Executed by nga (hardware): dv-size is the destination vector size. Receives responses in the order multiprocessors appear in the destination vector.

(9)

```
unsigned int i=0;
while (i < dv-size){
    nga.sL:mR*?( ){while( [symbol] nga.sL:mC?( )){
                    nga.dl.data →nga.vM;}
                    i++;}}
  nga:s →nga.next:s → nga.next:tunedPorts( );
```

Executed by each source cell C at its port na (software):

(10)

```
C.ng:mR?*( ){C.ng:Accepted?( ){//changes state from S′ to S.
            C.ng:c→nga.next;nga.next:rfD?( ){c→nga:c →sL;}
            else{C.ng:s→nga.next;//changes state from S′ to R′
                  nga.next:rfD?( ){s→nga:s →sL;}}
```

Executed by NS to change its state (hardware):
(11) sL:tC?*( ){ }/*R′ to R*/ else sL:R?( ){ }/*R′ to S′ */
Executed by nfa (hardware): Will change state from R′ to R if task was completed, else from R′ to S′.
(12) nfa:tC?( ){nfa:c→nfa.next:nfa.next:c→nfa:tunedPorts( );}else{{nfa:s [symbol] nfa.next:nfa.next:s [symbol] nfa:tunedPorts( );}
Executed by D.nf (software):
(13) D.nf:tC?( ){ }/*R′ to R*/ else {D.nf:r( ).s( );}/*R′ to S′*/

This is the complete message exchange protocol, where if the transaction was not successfully completed it would be repeated as many times as necessary. It is similar to the point-to-point distributed memory message exchange protocol that was described in Section 5.1. In the protocol described in Section 5.1 we did not show the participation of network switches, since we had not at that time described the network switch structure and operation, and no multiplexed response message transmission was necessary. Throughout the protocol above, the network switches play a passive role: they just sense signals and change states as described in the sequential machine diagram in FIG. 15.

This completes our discussion of all the basic communication protocols used in TICC™. Please note, in all protocols all components that exchange signals are always tuned to each other and always messages are sent immediately when they are ready, except during the multiplexed response message transmission in network pathways. It is instructive at this point to analyze the message transmission times and latencies in network message exchanges. We do this in the next subsection.

5.3.6 Message Transmission Times and Latencies

Let us assume we had 10 gigabytes/sec transmission lines and the grid was distributed over a geographical area with a 300 kilometers radius. The travel time for messages, limited by the speed of light, 3×10⁸ meters/sec, to travel from one end to another of this geographical area is about 1 millisecond, i.e. the message will begin to arrive at its destination 1 millisecond after it was sent. Let us assume, pathway on the TICCNET™ had been already set up. Then, after a latency of 1000 microseconds data will begin arriving at its destination at the rate of 10 gigabytes/sec. At this rate, a terabyte of data may be sent to its destination in 100 seconds. Since there is no synchronization and coordination necessary, data may be transferred through direct memory-to-memory transfers. In one hour, one may transmit 36 terabytes.

At this rate, the latency of 1000 microseconds can be ignored. This kind of high-speed data transmission becomes possible because the pathway is established once, all ports and agents on the pathway are tuned to each other. The amount of hardware used in a TICCNET™ is much larger than the amount used in conventional data transmission networks and not all the hardware are in use at any given time. However, hardware is relatively inexpensive and becoming even more so. The benefit is a dramatic reduction in latency.

In the next section, we present augmentations for the basic protocols we have described. These augmentations enable security enforcement, automatic cell activation when necessary, synchronization, communication with the self-monitoring system, and facilities for coordinating dynamic pathway modifications. We illustrate the augmentations using the group-to-group shared-memory protocol. Similar augmentations may be incorporated into all other protocols.

### 6 AUGMENTED COMMUNICATION PROTOCOLS

We have provided for three types of completion signals: r for a reply message, f for forwarding the current message in readMemory, and h for halting computations. In shared memory environments, the read/write memories of the virtualMemory of the pathway are switched with each other when in the reply mode. In the halt mode, computations are halted; no message is sent. In distributed-memory message exchanges there is no forward mode or halt mode, instead there are end of data signals and signal a to remove pathways and force the network switches to go their active state A.

The following additional variables and methods are used: A local Boolean variable called a:dC (‘dC’ for ‘delivery Complete’) is associated with agents a. It becomes true when the message had been delivered to all receiving ports by the agent. The guard condition, a:dC?( ) checks the truth-value of a:dC. The second agreement protocol function, a0:AP2(c₁,c₂, . . . ,cₙ), where signals cᵢ for 1≦i≦n the completion signals sent by the message sending ports tuned to the agent a0. It is defined as follows:
a0:AP2(c₁,c₂, . . . ,cₙ)=r if ∃i, 1≦i≦n, for which cᵢ=r. (43a)
a0:AP2(c₁,c₂, . . . ,cₙ)=f if ∀i, 1≦i≦n, cᵢ=f, else (43b)
a0:AP2(c₁,c₂, . . . ,cₙ)=h. (43c)

The guard condition, a0:r?( ) checks whether a0:AP2(c₁,c₂, . . . ,cₙ)=r, and a0:h?( )checks whether a0:AP2(c₁,c₂, . . . ,cₙ)=h.

There is a security check protocol. It is used to deliver messages only to ports that satisfy the security check, defined as follows: For every port, p, p:level, is the security level of port p. This will be an integer. Security levels are defined at the time of cell and pathway installation. For every virtualMemory, M, M:level, is the security level of the virtualMemory M, also an integer. M:mode is the security mode associated with the message that is currently in M. The security mode is set at the time the message is written. The message in M can be delivered to a port p, only if p:level+M:mode≧M:level. Thus, normally the message in M will be delivered to a port only if its security level is not less than the security of M. However, if M:mode>0 and p:level+M:mode≧M:level then it is possible to deliver a message to a port p, even if p:level<M:level. The larger the value of M:mode, the less secure the port can be. The guard condition p:sC?( ) (‘sC?’ for ‘securityCheck?’) checks whether p satisfies the above security condition. One may add another variable, p: count, which counts the number of times messages were exchanged through port p. When this count is reached, the pathway connected to p is automatically removed, so that p could not exchange any more messages via that pathway.

As noted, we can dynamically install new ports and pathways. A pathway can be dynamically changed only if all the generalPorts connected to that pathway are in their send state, S. This indicates that there are no pending transactions at those generalPorts.

To dynamically update the pathway connected to a generalPort gᵢ, gᵢ:uN?( ) (‘uN?’ for ‘updateNeeded?’) is set to true. In this case, when gᵢ moves to its send state S (or while it is in state S), if gᵢ:uN?( ) is true, gᵢ will lock the agent tuned to it, if it was not already locked. Every generalPort in the group to which gᵢ belongs will do the same, when it moves to state S. The pathway at gᵢ will not be ready if gᵢ:uN?( ) is true. No message could be sent. The agent will be unlocked by whomever it is that did the updating, after the needed update had been completed.

[image]

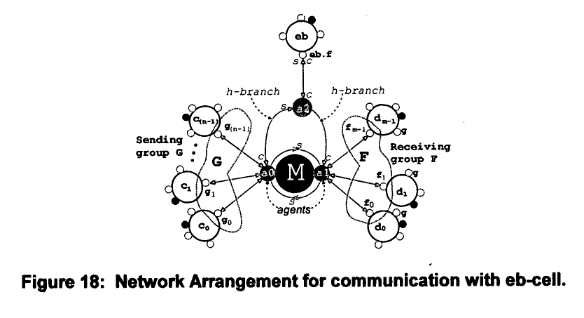

As shown in FIG. 18, let G be the generalPort group that is sending message and let gᵢ be a member of G. In the following, the guard a0:unLocked?*( ) checks whether agent a0 is unlocked. If it is locked, the port gᵢ waits for it to become unlocked. We use a0 to refer to the agent tuned to the generalPort group G, and use a1 to refer to its next agent, which is tuned to the functionPorts in F. Let n be the number of elements in G and m, the number of elements in F.

To account for the use of the delivery complete signal, a1:dC, and dynamic updating of pathways, the guard g:rfD? in (34) is modified as follows:

```
gᵢ:rfD?( ) =
    (gᵢ:tC?*( )&a0:unlocked?*( )){
          a1:dC?( ){a1:dC=false;} gᵢ:cᵢ →a0;
          return (gᵢ:selected?( ) & a0:AP1?*(c₀,c₁,...,cₙ₋₁);)} (44)
```

At the beginning of message transmission this waits for a0 (please see FIG. 18) to become unlocked and sets a1:dC=false if it is not already false.

In FIG. 18, the message is being delivered to a functionPort group F with m elements fᵢ for 1≦i≦m. The method, a0:swm( ) switches the read/write memories of agent a0, for a port, p, p:aC?( ) (‘aC?’ for ‘activatedCell?’) checks whether the parent cell of p has been activated, and a1:aC(p) activates the parent cell of port p. The list of indices of ports tuned to agent a1, to which it is secure to deliver the message in virtualMemory is saved in the variable, a1:SL(‘SL’ for ‘SecureList’). The method a1:addToSL(i) adds index i to a1:SL.

About Event Monitoring and Partially ordered event sets: As we shall see in Section 10, only the ice request sending/receiving events at generalPort groups are significant events in a TICC™-network. The activity in a TICC™-network may be represented by an activity diagram, that shows the temporal ordering of all message sending/receiving events at all generalPort groups in the network. This diagram is used by the self-monitoring system to identify patterns of event occurrences that indicate malfunctions and alerts.

Events in an activity diagram form a partially ordered set, (E, ≦), where E is the set of message sending/receiving events at generalPorts, and s is a partial ordering relation of the events in E: for any two events e₁ and e₂ in E, (e₁≦e₂) holds if the event e₁ always occurs before or at the same time as event e₂, and e₁ and e₂ are incomparable if neither (e₁≦e₂) nor (e₂≦e₁) holds true. The structure of this (E, ≦) is called the Allowed Event Occurrence Pattern, Alleop for short. We will have more to say about Alleop in Sections 10 and 11.

For our purposes here, it is sufficient to know that the event monitoring system associated with an Rtas will contain two kinds of cells: eb-cells (event builder cells) and ea-cells (event analyzer cells). Eb-cells cells are used to build the activity diagram and ea-cells are used to analyze the activity diagram and identify situations that cause alerts. To build the activity diagram, agent tuned to each generalPort group G, is associated with a unique event builder cell, eb-cell, as shown in FIG. 18, where the functionPort ab.f of eb-cell eb is connected to agents a0 and a1 in the pathway via a third agent a2, using h-branches. branches. The agent a0 will signal the eb-cell via agent a2 when message sending/receiving events occur at the generalPort group G, and both a0 and a1 will coordinate the signaling.

The eb-cell, eb, will be in the same multiprocessor as the one in which a0 and a1 are located. In FIG. 18, the functionPort eb.f is tuned to agent a2, and a2 is tuned to a0 and a1, through h-branches. branches. A given eb-cell eb may be associated with several distinct pathways through different functionPorts, eb.fᵢ.

In FIG. 18, a0 sends start signal s to a1, at the time it dispatches a message. At the same time, it also sends s to a2. This signal reaches eb.f via a2. When eb has finished updating the activity diagram in response to the receipt of this signal, it sends a completion signal c to agent a1 via eb.f and a2. The agent a1 uses this completion signal in the same way as it would use one received from a port that is tuned to it, at the time of checking agreement protocol.

When a0 receives a start signal from a1, it would indicate that a response message is being sent back to the generalPort group G. Thus, when so broadcasts s to all ports tuned to it, it sends s also to a2. When a2 senses this s, it sends completion signal c to eb.f, since this marks the end of a message exchange transaction at the port group G. On sensing this completion signal c, the eb-cell updates the activity diagram and sends back a completion signal to a0 via eb.f and a2. When a0 sends the next service request, it will use this completion signal received from a2 in its agreement protocol checking, and thus the cycle will continue.

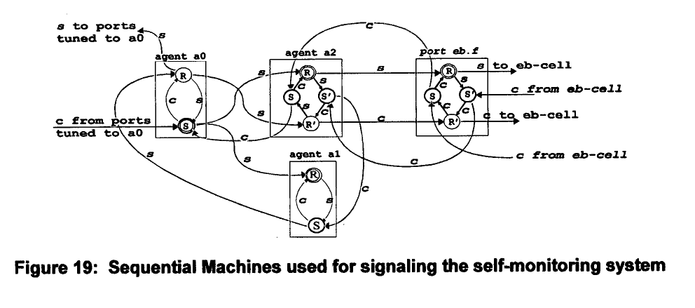

Signal exchanges and interactions between the port and agent sequential machines in FIG. 18 is shown in FIG. 19. The sequential machines for agent a2 and port eb.f are 4-state sequential machines similar to the ones in FIG. 10. Every time the agent a0 sends out a message, it causes a start signal s to be delivered to eb.f with the time stamp, eb.f:timeStamp( ). This time stamp specifies the local time at eb.f at which the signal was delivered. The eb-cells are synchronized to real time. Thus, the times associated with the message sending and receiving events in an activity diagram will be the real times.

[image]

With these preliminaries, the group-to-group shared-memory protocol may now be stated as described below; m here is the size of the receiving functionPort group.

```
gᵢ:rfD?( ){a0:AP2(c₀,c₁,...,cₙ₋₁) → a0; [symbol]
        a0:h?( ){a0:r?( ){a0:swm( );} a0:s → a1;
                    loop[i | 0≦i<m]{
                        /*if port fᵢ is secure adds its index i to a1:SL
                        and activates its parent cell.
                        Else, an exception is generated.*/
                        fᵢ:sC?( ){a1:addToSL(i); [symbol]
                                fᵢ:aC?( ){a1:aC(fᵢ);}}
                                }else true{<exception>}
                  }//end of loop.
                  //informs eb-cell about message dispatch if a1:SL is
                  not empty [symbol]
                  a1:SL:empty?{a0:s→a2:s→eb.f;
                              eb.f:setTimeStamp( );}
                  //now delivers message to all fⱼ for j in a1:SL.
                  loop[j | j∈a1:SL]{
                    a1:s→ fⱼ; fⱼ:setTimeStamp( );}
              }//End of [symbol] a0:h?( )
                  //if a0:h?( ) is true, resets pathway and variables to
                  initial states.
              else {resetPathway( );}/*End of [symbol] a0:h?( )*/
        a1:dC = true;//Message delivery has been completed
        }
        else {a1:dC?*( ){ }} //End of protocol. (45)
```

This protocol sets time stamps at the time of message delivery to each port, and signals the eb-cell with time stamps about message dispatch and delivery. Ports gᵢ for which gᵢ:rfD?( ) evaluates to false immediately go to the else-clause (last line above) and wait for message delivery to be completed before proceeding to poll their next ports.

Message delivery to m ports takes only as much time as is needed to set up a time stamps. This is in the nanoseconds range per port in a gigahertz computer. Thus, messages are delivered almost simultaneously, and each parent cell in G proceeds to poll its next port almost simultaneously, after message had been delivered to all recipient ports. Communicating with the eb-cell takes about the same time as the time needed for message delivery to a recipient port. We refer to this as synchronized real time message delivery and synchronized polling.

The protocol for the response message is similar to this, except that the agreement protocol functions expect to receive completion signals only from the ports whose indices are in a1:L and from agent a2. Again, a0 communicates with eb.f to inform the cell that a response has been received (transaction completed) by sending a start signal s to agent a2 who sends a completion signal c to eb.f with time stamp on receipt of this s.

It should not be hard to see how every protocol described in Section 5 may be thus augmented. The 350 nanoseconds latency for point-to-point shared-memory message delivery, in a 2 gigahertz CPU with 100-megabits/sec memory bus, was measured for an augmented protocol like the one shown above. This latency does not include time needed to activate the message receiving cell.

Let us now consider some examples of Rtas and simple parallel programs.

### 7 EXAMPLES OF TICC™-Rtas AND PARALLEL PROGRAMS

Three examples of Rtas are presented in this section: (i) sensor fusion, (2) image fusion and (3) an automobile fuel cell power transmission system. In all cases, the TIPs and CIPs specify the organization at an abstract level independent of the pthreads used to perform intended computations. Two examples of parallel programs are presented: One the Producer/Consumer problem solution and the other FFT (Fast Fourier Transform). We will discuss scalability issues and activity diagrams for these examples in Section 12.

7.1 Examples of Rtas

[image]

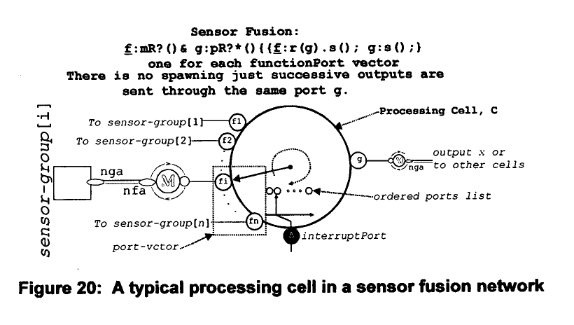

We begin with collecting data from sensors for sensor fusion. We assume sensors are distributed over a wide geographical area. The sensors in each neighborhood are organized into local groups. Sensors in a local group jointly communicate with their designated processing cell using group-to-point communication. Ports in a processing cell may be organized using port-vectors, so that the cell jointly processes signals received by all ports in a port-vector from different sensor groups. Cells that process different local groups may communicate with each other to coordinate their activities. The organization of a cell, processing signals received from a cluster of local groups, is shown in FIG. 20.

A sensor signal processing system may contain any number of cells like the one in FIG. 20. Each cell processes messages received at its input port-vectors in an order that might be based on time stamps or on computational contingencies dependent on events that occur in an activity diagram. The system will schedule itself, based on receipts of real-time messages, ordered according to either the time-stamps or computational contingencies. There are no scheduling, coordinating or communication mechanisms, other than the fusion network itself. Obviously, it makes no difference if communication between sensors and processors is over a landline or a wireless medium. The TIP used by the fusion cell is shown in top of FIG. 20. These simple descriptions capture the essence of TICC™ fusion network organization and implementation. A variety of variations are possible.

[image]

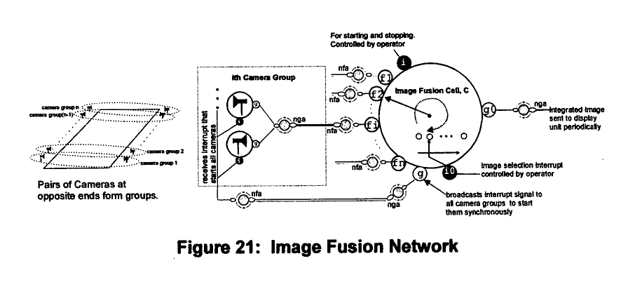

FIG. 21 shows a fragment of the image fusion TICC™-net. (This example is based on the problem discussed in [5].) Cameras are distributed around a football stadium in pairs on opposite sides of the field as shown in FIG. 20. Each pair forms a group that sends joint images to the image fusion cell as a group. Again, one may assume communications through landlines or a wireless medium.

The CIPs for the image fusion cell and the cameras are shown below. Comments in the definitions should make them self-explanatory. We use C++ conventions wherever convenient.

CIP of Image Fusion Cell, C:

```
/*we assume cameras will follow the ball automatically and send an image
only if the ball is with in its range*/
void Fusion_Cell::CIP( ){
    /*broadcasts interrupt message to cameras to start all of them.*/
    initialize?( ){g:s( );initialize=false}
    //zooming is specified by the fuseImg(g0) method, as needed.
    While( [symbol] stopPolling){
      /*sorts ports fi, with pending messages, in the order of time
      stamps, and puts fi into the sortedPortsList; */
      ScanAndSortPorts( );
      for (int i=1; i≦sortedPortsList.size( ); i++;){
          /*Fuses received images from each camera group in sorted
          order, and sends it to display unit via g0. If fuseImg(g0) finds
          that change in zooming is necessary, then zooming?( ) will
          be true and new zooming parameters for the camera group is
          sent back, else an empty acknowledgement is sent back. The
          new zooming parameter will take effect in the next images sent
          by that group.*/
          sortedPorts[i]:fuseImg(g0); g0:s( );
          zooming?( ){sortedPortsList[i]:z( ).s( );}
                      else {sortedPortsList[i]:s( );}
          }//End of for (int i=1; i≦sortedPortsList.size( ); i++;)
          /*If there is an interrupt signal at interrupt port
          i, then sends interrupts to terminate all cameras via
          port g, and acknowledges interrupt receipt via port
          i. Termination is controlled by operator.*/
          i:mR?( ){stopPolling=true; g:s( );
                      prepareToTerminate( ); i:s( );}
    }
}
```

CIP of Each Camera:

```
void Camera::CIP( ){
  /*acknowledges receipt of signal, which activated this camera, via
  interrupt port i.*/
  initialize?( ){i:s( ); initialize=false;}
  while ( [symbol] stopPolling){
    /*g:z( )resets the zoom if message at g is not empty.*/
    g:mR?( ){g:z( );}
    /* The guard, ball?*( ), will be true only if the ball is in the range of
    the camera. When pathway at port g becomes ready snaps pictures
    when the ball comes in its range; writes images into virtualMemory
    of port g and sends it out. */
    g:pR?( )& ball?*( ){g:snapPictures( ).s( );}
    /*terminates on receipt of interrupt at port i.*/
    i:mR?{stopPolling=true; prepareToTerminate( ); i:s( )}
  }
}
```

The system is again self-scheduling based on real-time messages, time-stamps, or interrupt signals based on events in the activity diagram or the operator.

[image]

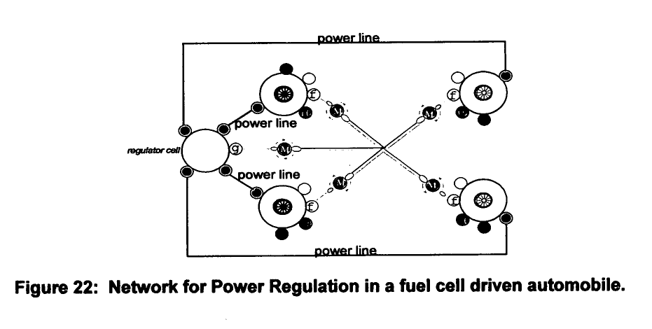

We now consider a control system. The TICC-network for automobile power transmission is shown in FIG. 22. In a conventional mechanical system, an automobile engine transmits power to the wheels via the transmission. Here physical connections between the engine, transmission and the wheels eliminate the need for messaging with time stamps. Suppose the transmission was replaced by a signaling system, as it may happen with fuel cells with electric motors on the wheels. One option for the power distribution system, which may depend on feed back from wheels on traction, speed, acceleration, load, curvature of the road, traffic, etc., is to receive data from the wheels with time stamped messages with a global real time for correct real time operation, and schedule the power regulator to respond correctly in a coordinated fashion to the data it receives from the wheels. This complexity is required if the signaling system uses asynchronous messaging with message buffers.

However, if the signaling system used real time asynchronous messaging with parallel buffers, as in TICC™ message dispatches from wheels will be properly synchronized, in every transaction and a second transaction will begin only after first message had been completed. In this case, there is no need to use time stamps or scheduling. Such a system will operate correctly so long as reaction times and communication latencies are consistent with physical requirements.

FIG. 22 shows the TICC™-net structure for doing this. Initially the regulator cell sends a service request message to start the wheels rolling, while applying the power through the power transmission lines. These power transmission lines are physical links connected to the motors on the wheels. They are not a part of the TICCNET™. In response to the starting message sent by the regulator cell, the response messages from wheels are delivered in sequence through the multiplexed response message arrangement in the TICCNET™. This response message will contain all information needed for the regulator cell to control the power delivered to each wheel. When the cell has received responses from all wheels, it adjusts the power based on a control algorithm implemented as a thread. The regulator cell sends the next service request message to get the next cycle of data from the wheels. Each cycle of message exchange and power regulation will take only a few milliseconds. Reaction to power transmitted to the wheels will, of course, be controlled by inertia, momentum, weight, load, friction, inclination and several other factors. The TIPs for the regulator cell and each wheel will simply be
Regulator_Cell: g:pR?*( ){g:start( ).s( )}//to start the wheels rolling
Wheels: f:mR?*( ){f:r( ).s( )}//feedback to regulator
Regulator_Cell: g:mR?*( ){g:r( ).s( )}//regulates power based on feedback

An essential feature of this network that is needed for coordination is synchronization of communications from the wheels. In each cycle, the regulator cell adjusts the power and responds only after receiving responses from all the wheels. This does the necessary synchronization. Service requests from the regulator cell are always broadcast in parallel to all the wheels. As long as cyber system response times are consistent with the physical reaction times and there are no consistently positive or negative feedbacks, this control scheme will work correctly in real time, with no need for externally imposed scheduling and coordination.

Instead of using one regulator cell to control all wheels, one could have a group of four regulator cells, one to control each wheel. All cells in this group will receive the same data sent by all the wheels in each cycle of their operation and respond to the received data synchronously.

7.2 Examples of TICC™ Parallel Programs

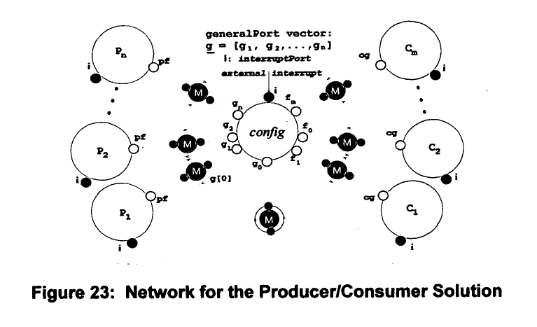

Producer/Consumer Problem Solution: Consider the simple scheme presented in FIG. 23, containing n producers P₁ through Pₙ and m consumers C₁ through Cₘ. The config orders products from producers during initialization and uses them to distribute to consumers, using g:K( ).s( ); at its generalPort vector. The CIPs for the various cells are shown below: Port cg is the generalPorts of a consumer, and ports pf is the functionPort of a producer.

[image]

In the initialization, PC-Config, acknowledges its own activation, activates all producers and consumers and puts in orders for products. Thereafter, looks for requests from consumers, waits for at least one generalPort, gⱼ, to have a ready product, sends the product to consumer and puts in a replacement order.

```
void PC-Config::CIP( ){
  initialize?( ){i:s( ); g₀:s( ); g:x( ).s( );initializeFlag = false;}
  while ( [symbol] stopPolling){
    pollAndSortPorts( );//sorts only functionPorts
    for (int i; i < sortedPortsList.size( ); i++;){
      /*Port gⱼ in the following is the port at which Vg:mR?*( ) evaluated
      to true.*/
      sortedPortsList[i]:mR?( ) & Vg:mR?*( ){
        sortedPortsList[i]:r(gⱼ).s( ); gⱼ:x( ).s( );}
    }
    i:mR?( ){stopPolling=true; i:s( ); prepareToTerminate( );}
  }}
void Producer::CIP( ){
  initialize?( ){i:s( ); initializeFlag = false;}
  while ( [symbol] stopPolling){
    pf:mR?( ){pf:produce( ).s( );}
    i:mR?( ){stopPolling=true; i:s( ); prepareToTerminate( );}
  }}
void Consumer::CIP( ){
  initialize?( ){i:s( ); cg:request( ).s( ); initializeFlag = false;}
  while ( [symbol] stopPolling){
    cg:mR?( ){cg:consume( ).usedUp?*( ){cg:request( ).s( );}
    i:mR?( ){stopPolling=true; i:s( ); prepareToTerminate( );}
  }}
```

Producer acknowledges activation and thereafter looks for an order, produces a product and sends it out. The Consumer acknowledges activation and puts in a request for a product. Thereafter, looks for receipt of product, consumes it and puts in a new request after the old one is used up. Pc-config uses parallel buffering to hold products until they are needed; products would be preserved in virtualMemories until they are used.

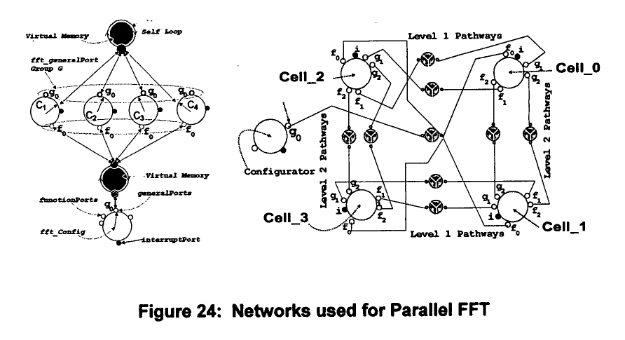

Parallel FFT: Please see [25] for details on parallel FFT (Fast Fourier Transform). We used the two networks shown in FIG. 24. The one on the left is non-scalable, since efficiency will decrease as the number of cells in the group increases. The one on the right is scalable because it does not have this problem. We will see precise reasons for scalability in Section 12.

Four cells were used in our test run. The program is written for using n=2^{k} cells. In both the non-scalable and scalable versions, the fft-config starts all cells by broadcasting input sample points to port f₀ of each cell. These sample points are preserved in the virtualMemory of f₀, to be used repeatedly 1000 times for 1000 identical FFT computations. The time taken for 1000 computations is divided by 1000 to get the average time per FFT computation. Each cell starts its FFT computations by performing the level-0 Butterfly computation, β, at f₀:β( ). After this point, the non-scalable and scalable versions differ in what they do.

[image]

In the non-scalable version, at every level of Butterfly computation each cell writes its outputs for starting computations at the next level into the writeMemory of its port, g₀, in an area of the writeMemory designated for that cell and sends it off. The agent on the self-loop pathway coordinates message dispatch. The message is sent only when all cells had completed writing their respective outputs into the writeMemory of g₀. When this message is sent over the self-loop pathway on the left side of FIG. 24 the read/write memories are switched and message is delivered in a synchronized fashion to the same port-group that sent the message. When the parent cells of ports in the port-group sense the arrival of a new message, they perform the next level of Butterfly computation at g₀:β( ) and repeat the cycle. For n=2^{k} cells the self-loop computations are repeated 2^{k-1} times. No message transmission is necessary for performing Butterfly computations at the remaining levels, since after level 2^{k-1} each cell will have in its designated area of the virtualMemory all data needed to perform Butterfly computations at the remaining levels [see 25 for details]. For n=4, messages are exchanged twice via the self-loop.

FFT power spectra computed by each cell are written by the cell into the writeMemory of the virtualMemory of port f₀. After doing this, each cell starts the next cycle of FFT computations on the same input sample points in the readMemory of f₀, by executing f₀:β( ) again. Inputs received earlier at f₀ would be preserved in the virtualMemory of f₀, since response to the received message is sent only at the end of 1000 FFT computations. The rest of the FFT computations follow. This cycle is repeated 1000 times and at the end, the results written into the writeMemory of f₀ is sent back to fft-config. On receipt of this, the fft-config prints out the results, cleans up the network and then terminates itself. Notice, response to the message broadcast by fft-config at the beginning of computations, is sent back only at the end of the 1000 FFT computations.

In the scalable version, shown on the right in FIG. 24, at each level of the Butterfly computation, each cell sends its output via the a priori established pathway to the next cell that should do the next level of Butterfly computation. Start and termination in the two cases are identical. Both FFTs used identical pthread definitions. Obviously, initializations were different, since the networks are different.¹⁰
¹⁰ Just as the same sequential program may be run on different suitably defined data structures, the same TICC™ pthreads may be run on different networks with suitable initializations. The diagrams in FIG. 24 are black and white copies of color diagrams produced by TICC™-GUI.

We had problems with cache memory. There were cache incoherence problems and too much time was spent by parallel programs in cache replenishments. Efficiencies ranged from 12.5% at 8 input sample points per cell, to 200% at 4096 sample points per cell, since at high sample point numbers, sequential programs spent more time caching than the parallel programs. Above 8192 sample points per cell, efficiency started to decrease, since cache replenishments in the parallel program started to increase. The program took about 1.6 milliseconds to compute double precision complex FFT-spectra for 16,384 sample points with four 2 gigahertz CPUs. This amounts to about 133 microseconds per Butterfly computation. We could not measure the amount of time that was spent on cache replenishment. Thus, we could not get reliable efficiency figures. Nevertheless, the proof of concept prototype TICC™-Ppde worked as expected.

The CIPs for the two networks in FIG. 24 are shown below: They both use the same configurator and same cells, but ports and pathways are different.

```
void FFT-Config::CIP( ){
  /*Initializes and activates all cells by sending sample points.*/
  initialize?( ){initialize( );g₀:x( ).s( ); initializeFlag = false;}
  while ( [symbol] stopPolling){
    g₀:mR?*( ){printOutputs( );cleanUpNetwork( );
    prepareToTerminate( );
        stopPolling = true;}}
}
Non-scalable
void FFT-Cell::CIP( ){
  initialize?( ){initialize( ); initializeFlag = false;}
  int nCycles = 0;
  /*Uses input sample points received at f₀ to perform level-0β.*/
  while (nCycles < MaxCycles){//MaxCycles = 1000.
    /*Writes level-0 outputs into virtualMemory at g₀*/
    f₀:mR?( ){f₀:β(g₀); g₀:s( );}
    /*Repeats self-loop computations n/2 times*/
    for (int i = 1; i ≦ n/2; i++){g₀:mR?( ){g₀:β( ).s( );}
    /*Performs β computations at remaining levels and writes result into
    the virtualMemory of f₀*/
    g₀:mR?( ){g₀:β*(f₀).s( );}
    nCycles++;/*repeats cycle until terminated*/
  }
  f₀:s( );/*sends results to fft-config at the end of computation*/
  prepareToTerminate( );
}
Scalable
void FFT-Cell::CIP( ){
  initialize?( ){initialize( ); initializeFlag = false;}
  int nCycles = 0; int i;//used in for-loop
  /*Uses input sample points received at f₀ from fft-config to perform
  level-0 Butterfly computation, f₀:β( ).*/
  while (nCycles < MaxCycles){//MaxCycles = 1000.
    /*Receives responses at ports gⱼ for 1≦j≦n/2. This synchronizes
    all cells at the start of each FFT.*/
    for (int j = 1; j ≦ n/2; i++;) {gⱼ:pR?*( ){ }}
    /* Sends output at each level i via gᵢ₊₁ for 0≦i<n/2.*/
    for (i = 0; i < n/2; i++;){fᵢ:mR?*( ){fᵢ:β(gᵢ₊₁); gᵢ₊₁:s( );}
    /*Performs computations at remaining levels at port fᵢ₊₁ and writes
    result into the virtualMemory of port f₀*/
    fᵢ₊₁:mR?*( ){fᵢ₊₁:β*(f₀);}
    //sends back responses to ports gⱼ via ports fⱼ for 1≦j≦n/2.
    for (int j = 1; j ≦ n/2; i++;) {fⱼ:s( );}
    nCycles++;//repeats cycle until terminated
  }
  f₀:s( );/*sends results to fft-config at the end of computation*/
  prepareToTerminate( );
}
```

In both cases, synchronization and coordination are automatic within each FFT computation. In the non-scalable version, group-to-group communication does the synchronization. In the scalable version, network dependencies do synchronization using synchronous TIPs. It is not necessary, that all cells start β-computations at each level at the same time. Each cell starts its computation when it has the necessary data. There is no need for barrier [17] synchronization between successive levels. In the scalable version, at the beginning of each new cycle, synchronization is done by checking that all generalPorts had received their responses. These examples are analyzed in Sections 10 and 12.

Synchronization methods available in TICC™-Ppde to explicitly synchronize different events in an Rtas or any parallel program, are presented in the next section.

### 8 EXPLICIT SYNCHRONIZATION AND COORDINATION IN TICC-NETS

TICC™ mechanisms for synchronizing events that occur in an Rtas, and synchronizing them with external events (like clocks) are introduced here. The use of the ‘deliveryComplete?’ guard, a1:dC?*( ) in the last line of protocol in (45), may be used in other contexts: One is in the context of message polling and the other is in cell activation. Synchronizations occur to very close tolerances. Facilities for maintenance and dynamic updating of parallel programs are introduced next. The section concludes with mechanisms for coordination of atomic (indivisible) actions and synchronized execution of messages received by a functionPort group.

Synchronization in message Dolling: In (44) and (45) we saw how the message sending agent coordinates message transmission using the ready-for-dispatch guard, gᵢ:rfD?( ). We noted there that message delivery would be almost simultaneous as the delivery to receiving ports, fⱼ, is separated only by nanoseconds. If there are m receiving ports, then one may use the guard a1:dC?*( ) to guarantee that none of the receiving ports fⱼ poll and begin servicing the received message before the message has been delivered to all of them. This may be done by simply replacing the guard, fⱼ:mR?( ) in TIPs by [fⱼ:mR?( ) & a1:dC?*( )], where al is the agent that delivered the message, or by incorporating a1:dC?*( ) into the definition of fⱼ:mR?( ) for all ports fⱼ. This useful feature makes it possible to fine tune synchronizations with little overhead.

Synchronization in Cell Activation: It takes about 2.5 microseconds in TICC™ to activate a cell.¹¹ However, cells have to be activated only once. When parent cells of ports in a port-group are first activated this may cause an unacceptable spread in the activation times of the cells in the group: For examples, if there are 10 cells in the group then the spread will be as large as 25 microseconds. With grain sizes of the order of 10 microseconds, this is clearly unacceptable. The use of the delivery-complete guard avoids this problem.
¹¹ The TICC™ subsystem for cell activation was implemented by Mr. Rajesh Khumanthem by cloning the process activation mechanisms in LINUX Activation could not be aster than the time LINUX takes to start a process. TICC™ does all of its own processor assignments and cell activations.

Normally, when a cell is activated it starts executing its CIP. Instead we can cause the cell to start executing a different method, called, say, startCell( ), which is defined as follows. (Be aware we are using ‘*’ in two different context here, one in C++ context and the other in TIP-guard context.)
void Cell::startCell(Agent*a1){a1:dC?*( ){CIP( );}}, (46)
where a1 is the agent that activated the cell. In this case the cell waits until a1:dC?*( ) becomes true, before beginning to execute its CIP. Each cell in the group does this in parallel, and keeps checking a1:dC?*( ) in parallel. This causes all the cells in the group to start executing their respective CIPs almost simultaneously (within a few nanoseconds of each other). This feature is also useful for fine-tuning synchronizations in an Rtas with little overhead.

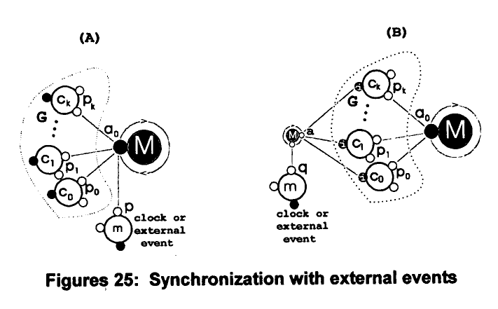

Synchronization of Two or more events in an Rtas: In any Rtas, one may encounter a situation where certain events occurring in the Rtas, that were not automatically synchronized, should be explicitly synchronized with each other, or should be synchronized with an external event or clock. FIG. 25 illustrates how this kind of synchronization and coordination is accomplished in TICC™. All the pathways used in this section were first formulated by Das [15]. Their application to synchronization of parallel processes is new.

[image]

In FIG. 25A, the monitor cell, m, is tuned to the same agent a₀ to which the group G is tuned. The group dispatches its message only after the cell m also sends its completion signal. The cell in issues the completion signal only at a time that is determined by a clock or an external event signal received through its interrupt port, after all the cells in G send their completion signals. This synchronizes the message dispatch with the clock or the external event. The monitor m here may be used to read the message in the virtual memory, inspect and modify it, save it to disc or print it in order to facilitate debugging or verify security checks.

In FIG. 25B the clock or the external event triggers m to broadcast an interrupt message to all the cells in the group G. This causes all the cells in G to be activated in synchrony with the clock or the external event signal.

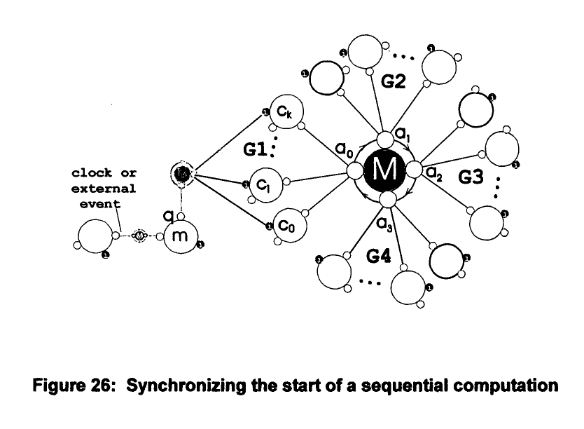

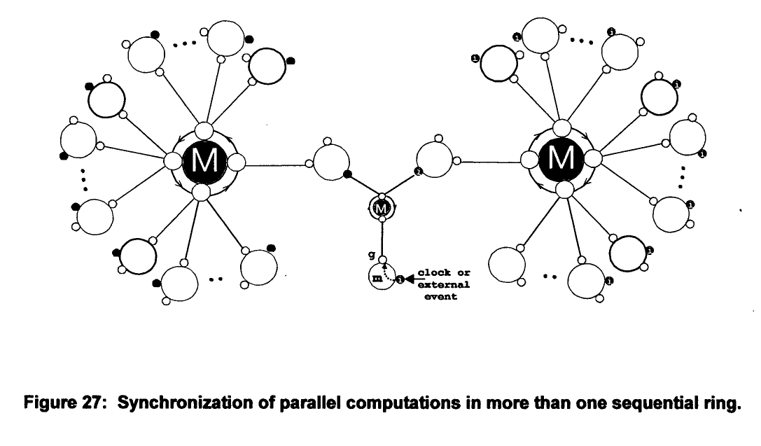

In FIG. 26, the clock or the external event triggers the start of computations in the group G1. Each group around the virtualMemory M here sends message to its next group, in clockwise direction, and sequential computations in the ring occur cyclically in a synchronized fashion until it is stopped, all synchronized with the external event. In FIG. 27, below, a similar arrangement causes parallel computations in two sequential rings to be synchronized with the external event.

Synchronization facilities may be installed as an after thought, after a design had been completed. These kinds of synchronization facilities are unique to TICC™. Synchronizations occur with close tolerances and little interference with ongoing computations.

[image]

Synchronized servicing of ports in a functionPort group: So far, we have presented techniques for synchronized starting of computations in different cells. Once started the cells will begin polling and servicing pending messages at their respective ports, and two ports in two different cells, belonging to a functionPort group, may not get serviced at the same time. Let F be a functionPort group and let c be the group of parent cells of ports in F. It is sometimes important that all cells in c begin servicing the ports in F at the same time. This may be accomplished as follows:

Let n be the number of ports in F. Define an n-bit vector and place it in the scratchPad of the common virtualMemory used by all cells in C. Each cell sets a bit in this vector to 1 when it is ready service its port in F. The cells in C begin servicing the pending messages at F only when they find that all bits in this bit vector have been set to 1. Servicing of ports in F will then be synchronized.

Coordinating atomic operations: When a cell group services a message, each cell in the group may use the scratchPad to communicate with other cells in the group and coordinate their activities. Here we consider situations where a pthread-lock may have to be used to implement coordination.

Suppose each cell in a cell-group, consisting of parents of ports in a port-group, updates a common variable while executing pthreads. All cells in the group would use the same virtualMemory and the updated variable should be in this commonly shared virtualMemory. For example, consider an integer, i, that is incremented by the cells in the group. The classic problem here occurs when two cells simultaneously access the current value of the variable i, each increments its value and updates it, and the new value for the variable shows up as (i+1) instead of (i+2).

This kind of anomalous behavior may be prevented by associating a pthread-lock with the variable i, thus allowing only one cell in the group to update the variable at any given time. This pthread-lock coordinates only the pthreads executed by parent cells of ports in the port-group, while they are jointly responding to a pending message delivered to them.

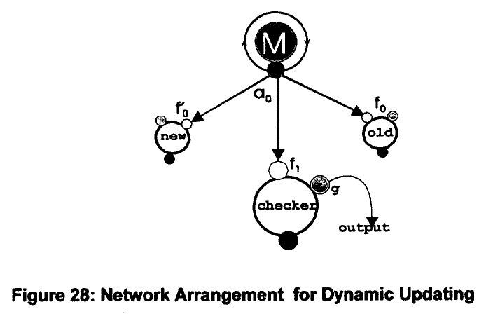

Software Maintenance and Dynamic Network Updating: The objective here is to replace an old cell with the new updated version of that cell. The new cell has to be tested and verified in the same network context in which the old cell functions. The arrangement for doing this is shown in FIG. 28. We call this in situ testing. This is a variant of the arrangement first proposed by Das [15].

The checker and the new cell in FIG. 28 may be dynamically attached to agent a₀ without interfering with the ongoing operations of the system, except for adding certain delays. The old and new versions of the cell and the checker all receive the same input message. The old and new each compute the response and write it into the writeMemory of the virtualMemory M in non-overlapping memory areas. The checker monitors agent a₀ to check whether a₀ has received completion signals from both old and new. When it does, the checker will know that both old and new had written their responses into M.

At that point, the checker checks the two responses, with each other and against its own calculations on the input message it received, to find out whether the responses of old and new are acceptable for the given input message, and sends out its findings. The findings may be saved in a file or observed dynamically by an observer. After doing this, the checker removes from the writeMemory the message written there by the new cell and then sends its own completion signal, c, to the agent a₀. At this point, Dynamic Updating the message in the writeMemory is sent to its intended recipients. The recipients would not know that a test is being conducted and computations would proceed uninterrupted.

[image]

After a sufficient number of such checking, the checker may declare the new cell acceptable, at which point the old cell and the checker may be disconnected from a₀ and the network will continue functioning with the new cell in place of the old one. Again, this switching of cells may be done dynamically without interrupting ongoing computations in the network, except for the introduction of some delays.

Clearly, this kind of in situ testing will change the timing characteristics of a real time system, and therefore it may not be possible to dynamically update an Rtas in this manner. However, using this scheme an Rtas may be tested and updated while it is working in a test mode.

It is now time to summarize the significant characteristics of TICC™. This is done in the next section.

### 9. SIGNIFICANT CHARACTERISTICS TICC™-Ppde

In our discussions below, we assume that the data security feature in protocols is turned off. The arguments below would not hold if the security feature is included, since one could not then reliably predict activities that might occur at different cells in a network.

Lemma 1: At each port of a Ticc-network, the order in which messages arrive at the port is the order in which the messages are serviced at that port.

Proof: If the port is a functionPort, the Lemma follows from the fact that a functionPort can receive a second service request only after it had responded to the first one. If the port is a generalPort g, then the message received by g should be a response to a service request it sent earlier, and no two port vectors in a cell may spawn new computations using the same generalPort. In this case, the parent cell of g will be ready to send the next service request via g only after it had completed using the response received through g.

[symbol]

It should be noted, two different ports of a cell, may service pending messages in an order different from the order in which messages arrived at the ports.

Definition 1: Pthread or Protocol Interference: Two pthreads or two protocols are said to interfere with each other if execution of one may block the execution of the other, when they are executed in parallel.

Lemma 2: No two protocols will interfere with each other.

Proof: Execution of the protocol of a pathway causes variables associated with the components of the pathway to be set or reset and causes signals to travel along the pathway from one component of the pathway to another. No two pathways share components (software or hardware), variables or any other resources in common. Thus, execution of one protocol cannot interfere with the execution of the other.

[symbol]

Theorem 2: The number of messages that may be exchanged at any give time in a TICC™-network is limited only by the number of cells in the network and the capacity of the TICCNET™ (the number of pathways in the TICCNET™).

Proof: Each cell in a TICC™-network runs in a distinct CPU or microprocessor and each cell executes the protocol needed to send a message. It is never possible to send more messages across a TICCNET™ than what the capacity of the net allows. Theorem follows from Lemma 2.

[symbol]

Lemma 3: Messages are always sent immediately after they become ready to be sent. Both message dispatch and message delivery are synchronized and guaranteed in group-to-group message exchanges. Latency for message delivery is precisely the time needed to execute the message exchange protocol. No time is wasted on synchronization sessions, or waiting for a recipient to become ready.

Proof: Every port is connected to only one unique pathway at any time, and every port holds the protocol for message transmission via pathway attached to it. Protocols are executed and message transmissions are started by the same cells that send messages, immediately. after the message is ready. TIPS are so structured that at the time any cell attempts to send a message, the pathway for sending the message would be ready. Synchronized group-to-group message delivery is guaranteed by the protocols, as discussed in Sections 5 and 6. No synchronization sessions are needed and thus no time is wasted on synchronizations.

No pathway from generalPort group F to a functionPort group F can be changed after G had sent out a service request message and before G had received the response message, and the response message is always sent via the same functionPort through which service request was received. Hence, Lemma 3 follows from Lemma 2.

[symbol]

Lemma 4: No virtualMemory will hold more than one pending message at any time.

Proof: A generalPort group G cannot send a second service request message before it had received a response to the first one it sent, and no pathway connecting a generalPort group G to a functionPort group F can be changed before G had received the response message. Thus, no other port can send a second service request before the pending message in the virtualMemory had been responded to.

[symbol]

These are the essential characteristics of real time messaging.

Lemma 5: Real Time Messaging Lemma: No two pthreads will interfere with each other and execution of every pthread will complete after a finite amount of time.

Proof: If two pthreads are executed in parallel then it should be that they are executed by different cells in a TICC-network. In this case, they are executed in parallel by distinct CPUs or microprocessors. All data used by a pthread at a port are provided to them by the message in the virtualMemory of the pathway connected to the port, and local data stored in the parent cell of the port.

In the middle of its computation, no pthread ever waits for a new message to arrive from another pthread, or send a message to another pthread, since no pthread contains send/receive statements. Therefore, if a pthread uses shared data, either the data is already in the virtualMemory of the pthread, or a new service request is sent, using TIPs of the form (5a) and (7a), in which case the pthread suspends itself and resumes later when the service request receives a response. The same holds true if the pthread uses any other shared resource. If two pthreads have to use the same shared resource (data or peripheral devices), then while one is using the resource, the resource will be locked and not made available to another. Deadlocks may be avoided here, as described below.

Managing Shared Resources: All shared resources local to a multiprocessor Y[i] in a grid are managed by the local configurator Y[i].config. The leader of a TICC™-grid is responsible to manage shared resources that are common to all multiprocessors in a grid. This includes data in a shared database, and data that may be obtained from sources outside the grid. Communication between the configurator L.config of the leader, and configurators Y[i].config in other multiprocessors occur, using the dedicated pathways of TICCNET™ shown in FIGS. 15.

As mentioned earlier, every cell group has a leader. Let C be the cell group in Y[i] that needs a shared resource and let c be the leader of c. Then c sends a service request for the resource to Y[i].config, via the pathway shown in FIG. 16B. After request for the shared resource has been sent, c suspends its activities. Other cells in c coordinate their activities with the leader c. After suspending their respective current activities, all cells in c proceed to service the next port in their respective ordered ports lists.

If Y[i].config cannot satisfy the request sent by c by itself, then it forwards the request to L.config via the dedicated pathways shown in FIG. 15, with a tag associated with the request. This tag could be for example the identity of the port that sent the request to Y[i].config.

Locks on shared resources common to a TICC™ computing grid, are managed by L.config. L.config places each request for a shared resource in a queue, and services the queue in the order the requests appear in the queue, or based on data (resource) availability. No priority scheduling is used. A request in the queue is cleared only when the cell that made the request had completed its transaction using the requested shared resource, and had sent back to L.config an appropriate response. As soon as lock on a requested resource is released, L.config places appropriate new lock on the requested resources using tags associated with the requests, and sends them to the Y[i].config that requested the resource, via the same pathway through which the request was received. Y [i].config forwards the data to the leader of the cell group that requested it. The leader of the cell group may then cause all the cells in the group to resume their suspended activities by broadcasting a suitable message to them, or by using the scratchPad. When a transaction is successfully completed, updated data is communicated back to the shared database using the same pathway that was used to fetch the data. This will mark the end of transaction and cause the request to be removed from the queue in L.config.

Since all locks are set by one centralized resource, namely L.config, it is possible to identify potential deadlocks and avoid them, or restart computations, when necessary, thus eliminating deadlocks. Restarting of computations will occur as follows:

Suppose port g₁ requested data1 and port g₂ requested data2 and both were available. Then L.config sets lock (g₁,data1) and lock (g₂,data2), and sends the data to the ports. Later, suppose g₁ requested data2 and g₂ requested data1. This is the classic deadlock situation. L.config will notice the deadlock situation here when it receives the requests. Suppose, the request from g₂ was received ahead of the request from g₁, i.e. g₂ appeared ahead of go in the queue that L.config maintains. In this case, L.config will respond to go with a message requesting it to restart its computations, release lock (g₁,data1), set lock (g₂,data1) and send data1 to g₂. When g₁ receives the restart message, it will suspend its computations. The input message received by the function port f in the parent cell of g₁, that cause the request for data1 and data2 to be sent, will still be in its virtualMemory of f. Later, when locks on both data1 and data2 are released, L.config will lock both of them with the tag g₁ and send them to g₁. At that point, f will restart its computations from the beginning. Notice, all of these happen not through interrupts, but through programmed suspensions of computations using TIPs of the form (5a) and (7a).

Throughout these operations, the position of g₁ in the L.config queue will be preserved. This guarantees eventual scheduling of resources for every port that requested shared resources. Priority driven scheduling is forbidden because a greedy pthread may then block one or more other pthreads from ever getting started. Lack of priority driven scheduling should be acceptable, since grain size of computations in TICC™-Ppde are small.

Since no pthread execution can be interrupted in the middle and no pthread will be blocked out, execution is deterministic and allocation of requested shared resource is guaranteed for every port, execution of all pthreads will complete after a finite amount of time.

[symbol]

It is best to submit requests for all shared resources needed for a transaction at one time, if possible, instead of in sequence, one after the other, causing intermittent suspension of pthread executions. Using and protecting shared data (resource) is the most time consuming operation in TICC™ with multiple message exchanges via TICCNET™. However, since message exchange latencies over TICCNET™ are small this should be acceptable. Cells manage coordination of activities during shared data and resource allocations, by executing TIPs of the form described in (5a) and (7a).

Theorem 3: Real Time Execution Theorem: For every service request sent by every generalPort group G in a TICC™-network, G will receive a response message, as long as spawning at every generalPort vector stops after a finite number of iterations. The delay for getting this response is precisely the time needed to execute the pthreads, to fetch shared resources, to execute all spawned computations, and execute protocols for message exchanges.

Proof: By assumption, no CIP ever misses sensing a pending request at any of its ports, no cell is interrupted while it is executing a pthread, and in each polling cycle a cell may clear its sorted ports list, only after all ports in the list had been serviced. Thus, if every spawning stops after a finite number of iterations, the theorem follows from Lemmas 1, 2, 3, and 5.

[symbol]

We refer to this as real time execution theorem. Real time messaging and real time execution are the two cardinal features of TICC™-Ppde from which all other characteristics follow.

Definition 2: Synchronized ports: A set of ports in a TICC™ is said to be synchronized if no port in the set could service its (n+1)^{st} message until all ports in the set had completed servicing their respective n^{th} messages.

Clearly, ports in any functionPort port-vector are synchronized, and so are the ports in any port-group. Synchronized activities among other ports may be enforced using the synchronization mechanisms discussed in Section 6. Notice, ports in a synchronized set may not all evaluate their respective n^{th} messages at the same time. However, each port in a synchronized set of ports will execute its (n+1)^{st} message only after all ports in the set have executed their n^{th} message.

Definition 3: Behavior Π of a TICC™-network: The behavior, Π, of a TICC™-network is a set of paths in the Alleop (discussed in Sections 10 and 11) of the TICC™-network.

In simple cases, paths in Π may be specified by regular expressions of node names. More generally, Π is a set of paths specified by a computable function on the set of node names. An Rtas is said to work correctly if its activity diagram never violates the patterns in Π.

Definition 4: A TICC™-network is well-synchronized if all required synchronizations for correct operation of an Rtas are incorporated into that network.

Definition 5: Race Condition: A race condition is said to exist in a TICC™-network if the behavior of an Rtas depends on the order in which two ports in the network process their messages, and by synchronizing those two ports this anomalous behavior is eliminated.

Identifying race conditions in a given design is not easy. First of all, because it may not be possible to identify race conditions before all pthreads had been defined and the integrated system with CIPs is run several times. Even then, some race conditions may be missed. We do not know of any systematic method for testing an integrated system to identify race conditions.

Identification of race conditions requires knowledge of the required Rtas system behavior in its physical environment and its related structures, and the structure of the TICC™-network. Often it is possible to identify from known behavior of an Rtas and its physical structure, which ports in a network should be synchronized. It is best to incorporate all appropriate synchronizations during the design phase and try to avoid race conditions, rather than attempt to find race conditions after the design has been completed.

Methods for identifying required port synchronizations to avoid race conditions are beyond the scope of this paper, because it depends on how an Rtas system behavior is stated, before the system design begins. We thus assume, our networks are free of race conditions.

Definition 6: Well coordinated Networks: A TICC™-network of a parallel program is well-coordinated under the following conditions: No port misses messages and if m1, m₂, . . . , mₙ, . . . is the sequence of all messages received at a port, or sent by a port, then the order in which messages appear in the sequence guarantee correct operation of the parallel program. This holds true for all ports in the network.

Clearly then,

Theorem 4: Every well-synchronized TICC™-network of a parallel program that is free of race conditions is well coordinated.

Proof Follows from Definitions 2, 3, 4, 5 and 6, since by assumption no cell misses a pending message at any of its ports

[symbol]

We now turn to an informal discussion of the structure of parallel computations in TICC™, event lattices, complete partial ordering of events, and organization of the self-monitoring system. The concepts introduced in the next section are formalized in Section 11.

### 10 STRUCTURE OF PARALLEL COMPUTATIONS IN TICC™: INFORMAL INTRODUCTION

10.1 Simple Computations

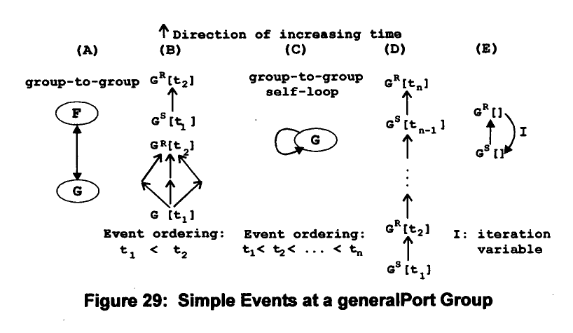

The simplest operation that can occur when a service-request message is sent by a generalPort group is that the functionPort group that receives this message responds to it without spawning any new computations. Here, the TIP at a generalPort g in G may have the form, g:pR?( ){g:( ).S( );}, and the TIP at a functionPort f in F will have the form, f:mR?( ){f:r ( ).s( );}. This computation is represented by the ordering of events shown in FIG. 29B. G^{S}[t₁] is the message-sending event at the generalPort group G that occurred at time t₁. G^{R}[t₂] is the response message receiving event at G, which occurred at time t₂, where t₁<t₂=t₁+δ, as indicated by the arrow connecting the two, and δ, is the finite time delay. In FIG. 29B, G^{S}[t₁] does a fork operation distributing computations and G^{R}[t₂] does a join operation, and the double arrows are merged together to get the diagram on top of 29B.

[image]

FIG. 29C, shows a self-loop pathway from a generalPort group G to itself. The TIP at each general Port gᵢ in G that received this message may have the form, gᵢ:{gᵢ:r( ).s( );}. The self-loop iterates until it is stopped. Loop is started by initializing the virtualMemory of the pathway and activating the cells in G. Of course, any of these TIPs may be synchronous TIPs. Iteration of the loop is represented in FIG. 29D by the sequence of events one on top of the other, terminating at tₙ. In these two cases, all the events are totally ordered.

We refer to graphs of the kind shown FIGS. 29B and 29D as activity graphs. If G=[g₁,g₂, . . . ,gₙ] then G^{S}[t₁]=[g₁^{S}[t₁], g₂^{S}[t₁], . . . , gₙ^{S}[t₁]] is the instance of G^{S}[t₁] and G^{R}[t₂]=[g₁^{R}[t₂], g₂^{R}[t₂], . . . , gₙ^{R}[t₂]], t₁<t₂, is the instance of G^{R}[t₂] in an activity diagram. We will refer to G^{S}[ ] and G^{R}[ ], with the timing information removed, as the Alleop nodes and write the Alleops for the event structures as shown in FIG. 29E, where I is the iteration variable, and say G^{S}[ ]≦G^{R}[ ] holds, where ≦ is a reflexive, anti-symmetric and transitive ordering relation.

The graphs show when different events occurred. We refer to each G^{S}[t₁] and G^{R}[t₂] in the graphs as grounded nodes, and each directed arrow as a link. We refer to G^{S}[ ] and G^{R}[ ] Alleop nodes. A path is a sequence of nodes in which successive nodes are connected by a link. When the ending node of a path is connected to its beginning node by a link we get a loop. We will refer to this link as the looping link. Loops occur only in Alleops, not in activity diagrams.

The graphs in 29B and 29D are both simple paths. Clearly, nodes in simple paths are totally ordered in some ordering relation, ≦. For each node nᵢ in a simple path, any node nⱼ in a path containing nᵢ, such that nⱼ≦nᵢ is a lower bound of nᵢ. In this case, nᵢ is an upper bound of nⱼ. The greatest lower bound of nᵢ is the greatest element in the set of all lower bounds of nᵢ. The least upper bound of nᵢ is the smallest element in the set of all upper bounds of nᵢ. A graph in which every subset of nodes has an upper bound in the subset is said to be a directed graph. A graph in which every subset of nodes has a least upper bound and greatest lower bound is said to be a lattice. Every totally ordered finite set with the ordering relation ≦ is a lattice. More complicated situations than this simple total ordering occur when events in an activity diagram are partially ordered.

As mentioned in Section 3, we refer to ‘G^{S}[ ]→’ and ‘→G^{R}[ ]’ as icons. They represent potential events that may occur in an activity diagram. By definition, the event, ‘G^{S}[ ]→’, occurs in every parent cell of every functionPort that receives the message sent by G. This definition is valid because every message sent by a generalPort is delivered to a functionPort without fail. The event, ‘→G^{R}[ ]’ occurs in every parent cell of every generalPort in G that receives a response.

10.2 Parallel Computations with Spawning

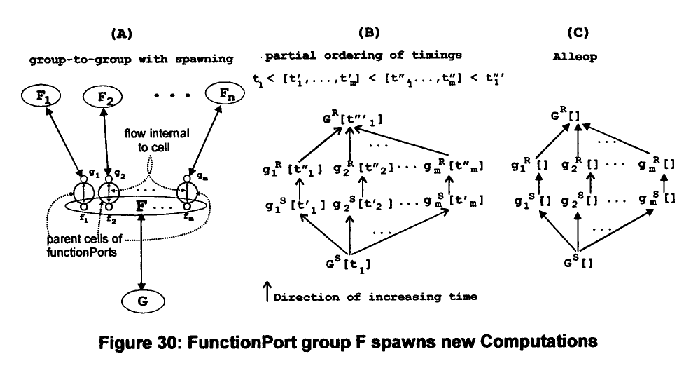

In FIG. 30A, spawning occurs at the ports of a functionPort group F=[f₁,f₂, . . . ,fₘ] where each functionPort fᵢ belongs to a distinct cell, and all of them receive the message broadcast by the generalPort group G. Each fᵢ in F spawns new computations by broadcasting a message through a generalPort gᵢ of its parent cell to another functionPort group, Fᵢ, shown at the top of FIG. 30A. In FIG. 30, it has been assumed that these other functionPort groups Fᵢ would each send back a response message to each gᵢ without further spawning. In this case, the TIP at the functionPorts fᵢ in F will have the form, fᵢ:mR?( ){fᵢ:r(gᵢ); gᵢ:s( );} and the TIP at the generalPort gᵢ will have the form, gᵢ:mR?( ){fᵢ:r(gᵢ).s( );}. The partial ordering of events corresponding to this is shown in FIG. 30B. Partial ordering occurs because no ordering exists for the time instances [t′₁, . . . ,t′ₘ] and [t″₁, . . . , t″ₘ] at which the ports gᵢ, for i=1, . . . , m send and receive messages. After all the ports, gᵢ, have received their response messages the generalPorts in G receive the joint response message broadcast by ports in F. Again, a fork operation is followed by a join operation.

[image]

Note that in the partial ordering in the activity diagram shown in FIG. 30B, there are m paths. The greatest lower bound of any subset of nodes appearing in more than one path is G^{S}[t₁], and their least upper bound is G^{R}[t′″₁]. It is also true that every subset of nodes in 30B have a least upper bound, a greatest lower bound. FIG. 30C shows the Alleop associated with this spawning. As defined above, this graph is a lattice.

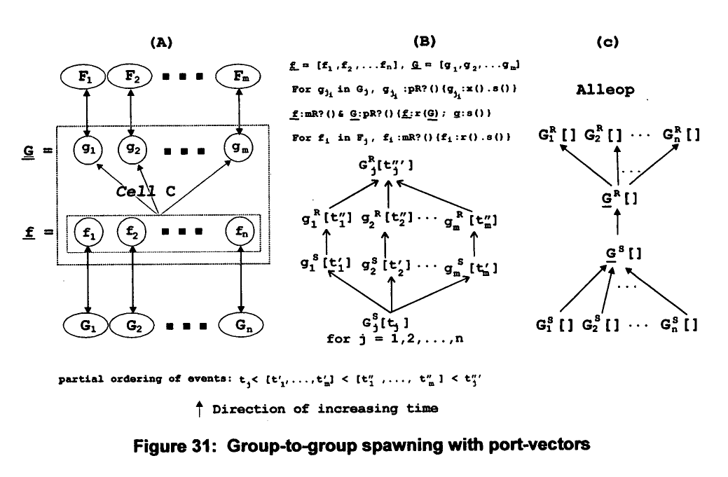

FIG. 31 shows a network with port-vectors and its associated lattice. Here also the lattice may grow if spawning is iterated. TIPs associated with the ports in FIG. 31 are shown in the figure itself. Spawning may be iterated in different ways, by functionPort groups Fᵢ or by the functionPorts fⱼ in the port-vector f. In the Alleop shown in FIG. 31C, G is the generalPort vector. FunctionPorts here cause join and fork operations. Notice, in FIG. 30 the generalPorts that spawned computations did not constitute a generalPort vector.

The graphs with root node G^{S}[t₁] in FIG. 30B, and root node G^{R}ⱼ[tⱼ] in FIG. 31B have the following characteristics: Each graph is the smallest graph containing its root and top nodes, with all paths that fork at the root and join at the top. In each case, the activity diagrams satisfy the same partial ordering relation as the Alleops. These notions are made more precise in Section 11.

[image]

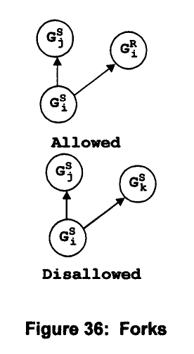

FIGS. 32A and 32B shows a complex interaction among cells in a network and their associated Alleop. Here, the port vectors are f₁=[f₁ᵢ,f₁ⱼ,f₁ₖ], f₂=[f₂ᵢ,f₂ₖ], and f₃=[f₃ᵢ,f₃ⱼ]. The group Gₖ just above the bottom in the figure broadcasts to the functionPort group, [f₁ₖ,f₂ₖ]; Gᵢ broadcasts to the functionPort group, [f₁ᵢ,f₂ᵢ, f₃ᵢ]; and Gⱼ broadcasts to the functionPort group, [f₁ⱼ,f₃ⱼ]. Thus, different functionPorts in different functionPort vectors receive inputs from different generalPort groups. New computations are spawned by intermediate generalPort groups, which contain different generalPorts from different parent cells of functionPorts mentioned earlier. All of these combine at the top. In FIG. 32A the spawning may grow one on top of another each with an arbitrary number of finite iterations (as shown in FIG. 36) and ultimately converge at the top. The Alleop for event flow in FIG. 32A is shown in FIG. 32B, where each link represents information flowing from one node to another. Thus, in general links may converge and diverge at the nodes in an Alleop with cross-links among various components of an Alleop,

It may be noted, in general, successive spawning may occur at successive generalPort vectors, \tilde{g}₁^{S}[ ]→\tilde{g}₂^{S}[ ]→ . . . \tilde{g}ₙ^{S}[ ] followed by successive joins →\tilde{g}₁^{R}[ ]→\tilde{g}₂^{R}[ ] . . . →\tilde{g}ₙ^{R}[ ] or through successive pairs of fork/join operations at the same generalPort vector, as in \tilde{g}₁^{S}[ ]→\tilde{g}₁^{R}[ ]→\tilde{g}₁^{S}[ ]→\tilde{g}₁^{R}[ ]→ . . . →\tilde{g}₁^{S}[ ]→\tilde{g}₁^{R}[ ], or any combination there of. The pair (\tilde{g}₁^{S}[ ],\tilde{g}₁^{R}[ ]) in a path is called a matching pair. In every such matching pair, both the sending and receiving events should contain the same subgroup of ports from g.

Let us now consider the Alleops for the examples presented in Section 7.

10.3 Alleops for the Examples in Section 7

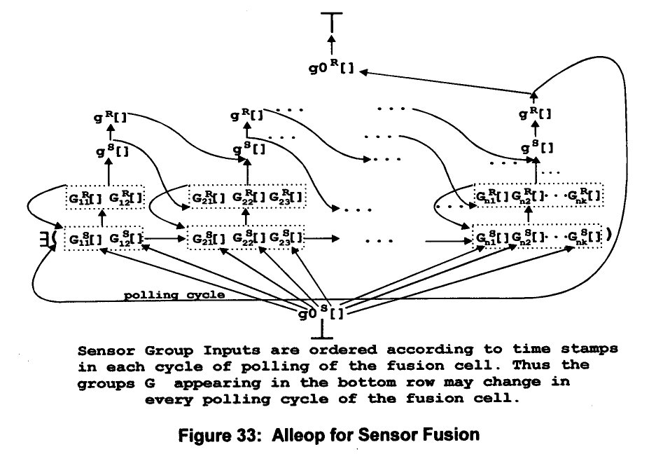

Alleop for Sensor Fusion: The Alleop for sensor fusion is shown in FIG. 33. The fusion cell is started first. It activates all the sensor groups by broadcasting an interrupt signal to all of them from its generalPort g0. The G^{S} and G^{R} nodes inside rectangular boxes with dotted lines, are synchronized by functionPort vectors. Each generalPort group inside a box sends/receives its (n+1)^{st} message only after all the groups inside the box had received/sent their, respective, n^{th} responses. This restriction does not apply across vectors of generalPort groups: In other words, a generalPort group in one vector may not be synchronized with another generalPort group in another vector. Boxed nodes indicate a join operation: data at those nodes are jointly processed.

[image]

The vector of sensor groups [G₁₁, G₁₂] sends data to a functionPort vector f₁; the vector [G₂₁, G₂₂, G₂₃] sends data to another functionPort vector f₂; and similarly with the other vectors of sensor groups. The fusion cell sorts the functionPort vectors based on time stamps, and processes them in the sorted order in each one of its polling cycles. The existential quantifier indicates that in different polling cycles, nodes in boxes could be different, and some nodes would exist before execution starts. The scope of this quantifier is all the nodes in all the boxes.

When the system terminates, the interruptPorts of all the sensor groups send termination signals back to generalPort g0, and the fusion cell stops. The diagram does not show the source from which g0^{R} received its response. It only shows the temporal ordering. By our convention, it is from the same ports to which g0^{S} sent the message. Thus, links in an Alleop always show temporal ordering and sometimes it may show both temporal ordering and data flow.

In the diagram shown in FIG. 33, we have folded the graph to fit into space. The reader may verify that when it is unfolded the diagram is a lattice, if the feedback loops are removed and instead the sub-graphs are suitably iterated. The big loop in FIG. 33 represents polling cycles of the fusion cell, and the smaller ones represent iteration with in the sensor groups.

It should be clear; the Alleop for image fusion example is also a single path lattice, with data flowing from camera groups to the fusion cell, and the fused image going out via a generalPort of the image fusion cell. All computations are done essentially by one cell. For the fuel cell power control example also, the lattice is a single path lattice, since here also the power control cell does all the work; the wires through which power flows is not a part of the computational system. We get some interesting cases in the Producer/Consumer and FFT examples.

[image]

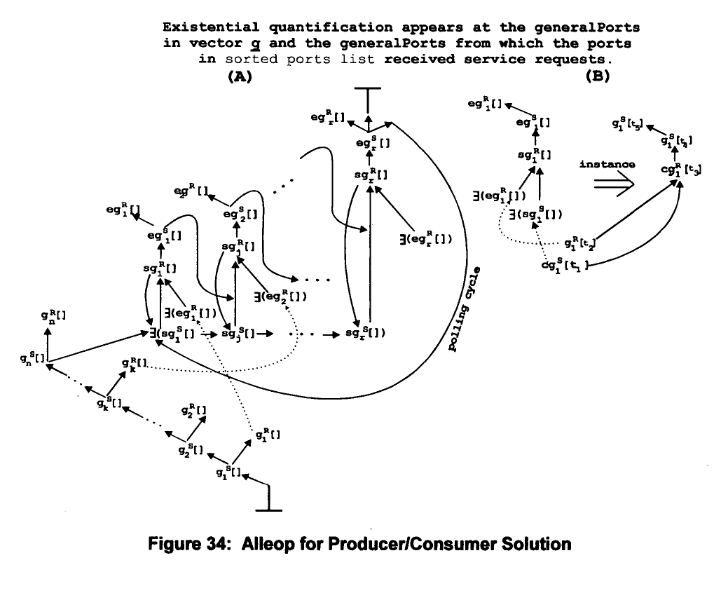

Alleop for Producer/Consumer. The Alleop for the Producer/Consumer network in FIG. 23, is shown in FIG. 34. See TIPs described in Section 7.2 for this example. The config in FIG. 23 sends requests for resources by executing g:x( ).s( ) during initialization: g:s( )≡g₁:s( ).g₂:s( ) . . . gₙ:s( ), where n is the number of ports in g, and thus, g^{S}→≡g₁^{S}→g₂^{S}→ . . . gₙ^{S}→. This is shown in the diagonal path on the lower left side of FIG. 34A. The response messages for these come at different times with no required order among them. Thus, at each gₖ^{S}→ the diagram forks to a →gₖ^{S} for 1≦k≦n.

While polling, as shown in FIG. 34A, the configurator sorts the requests it had received through its functionPorts into a sorted ports list and services them one by one in the sorted order. It waits until at least one of the generalPorts gⱼ in the generalPort vector g had received a product, sends this product to the customer who requested it, and then places an order for a replacement product. In any one cycle, we do not know the identity of the customer that was serviced and generalPort gⱼ from which the product was obtained. Thus, existential quantifiers are used to refer to the nodes.

Existential Icons: There two kinds of existential icons: We use prefix, ‘e’ (‘e’ for ‘exists’) or ‘s,’ (‘s’, for ‘source’) to mark the existentially quantified variables. We assume that all such variables used in an Alleop would be distinct.
(i) ∃(eg^{R}εg): This ranges over a generalPort vector g of a cell. Typically, this is used to pick up and use a priori provisioned resources. These provisions would be responses received by the generalPorts in g for service requests sent earlier, as in the producer/consumer example. The responses would be preserved in the virtualMemories of the ports in g until they are used.

This icon is always linked to a node which has some other links also connected to it, as it happens in FIG. 34.
(ii) ∃(eg^{S}εgf(C))→: This is used to refer to nodes in the sorted ports list of a cell. It ranges over the functionPorts of a cell. However, since we do not use functionPorts in an Alleop we refer to the generalPort groups that send messages to those functionPorts. We use gf(C) to refer to the generalPort groups, which may send messages to cell c. The existential variables here are bound to items, which sent messages to ports in sorted ports list, in each cycle of polling, in the order they appear in the list.

These are the only kinds of existential icons used in Alleops. The range of possible bindings is always localized to one cell. Computations may proceed only if bindings existed for the existential icons. Wherever the range is obvious, one may omit mentioning it in the icon, as we have done in the producer/consumer example. The TIPs make sure that bindings would always exist. Of course, if a cell goes into livelock then there would be no computations.

Consider for example, the left most vertical path in FIG. 34A. This has two arrows joining at the node sg₁^{R}[ ]: one is the arrow from sg₁^{S}.[ ]→ and the other is the arrow from ∃(eg₁^{R})→; thus, ∃(eg^{R})→ appears as a branch in a join operation. In this case, the scopes for bindings of the existential quantifiers are unique. It is the generalPort vector in the cell for ∃(eg^{R})→, and generalPorts of consumers for ∃(sg₁^{S})→. Suppose, ∃(eg₁^{R}) was bound to g₁^{R}[ ], as shown by the dotted arrow in FIGS. 34A and 34B, and the consumer generalPort, cg₁^{S} was bound to ∃(sg₁^{S})→. The resulting Alleop instance is shown in 34B. The quantifier disappears and in its place, the binding appears, and the same binding is substituted wherever the same quantified variable appears in the Alleop. The scope of an existential quantifier may always be determined from the TIPs in a CIP. We assume, all quantified variables will be separated out (distinct).

After servicing one customer, the config proceeds to service the next customer in its sorted ports list. Meanwhile, the replacement orders arrive at the generalPorts of the port vector. Every time a customer is serviced, the config waits for an order to arrive, if one was not already available.

The diagram in FIG. 34A, with all looping links cut, is not a lattice. However, if all the resources were used up, then it would be a lattice. Resources are incorporated into the parallel program only when they are used. Otherwise, they just remain hanging in the activity diagram. In all cases, an Alleop with all looping links cut would be a complete partial order. An Alleop with no unused resources and with all looping links cut would be a lattice. When computation is terminated in the producer/consumer example, the customers serviced and the products not distributed would be different in each computation, giving rise to non-determinism. This is the only kind of non-determinism that can arise in TICC™-Ppde programs.

Of course, one may make sure that all the unused resources are either destroyed or sent back to their source, before termination. Alternatively, one may simply choose to ignore the unused resources. This will guarantee that the resulting activity diagram would be a lattice.

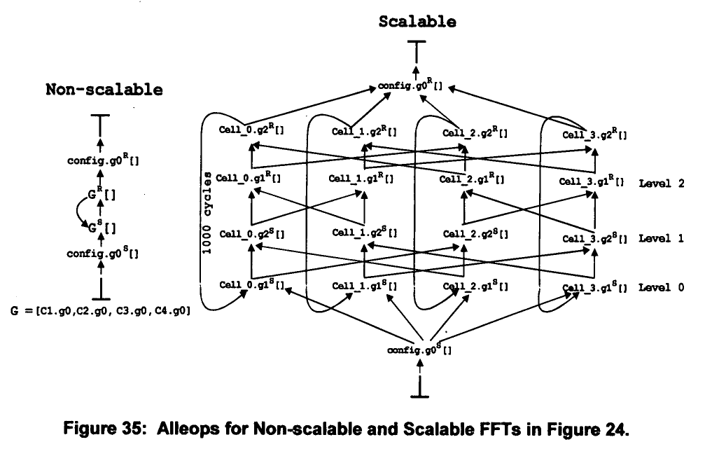

Alleops for FFT: Let us now consider the Alleop for the FFT, for the two cases illustrated in FIG. 24. The Alleop is shown in FIG. 35. The point to note in the Figures in 35 is that there are no synchronization sessions between different levels of FFT computations. In the non-scalable version, group-to-group message exchange synchronizes successive sessions automatically. In the scalable version, synchronization is done automatically by the service request messages received by functionPorts between successive levels of computation. At the beginning of each cycle of FFT computation, synchronization is done by response messages received by generalPorts. Butterfly pattern is seen in the scalable version, but is hidden in the data structure of message in the virtualMemory in the non-scalable version.

[image]

Comments: Alleops describe possible activity diagrams that a parallel program can give rise to. Thus, Alleops contain existential quantification and loops. The quantifications are such that if TIPs are written appropriately, there will always be candidates available to satisfy the quantifications in each run. In TICC™-Ppde there is only one kind of non-determinism: it arises, when resources (responses) received at one or more generalPorts are not used by the parent cells of the generalPorts. Thus, they are not incorporated into parallel computations and are left hanging at the end of the computations. If advanced provisioning of resources is avoided or unused resources are clean up before termination, then computations will be deterministic and the resultant Alleops without loops will be lattices. Thus, for example, in the producer/consumer example one could have placed orders for products after requests had been received. In this case, consumers would have to wait until the product is received. Clearly, this is not be always feasible.

Let us now proceed to present a formal definition of Alleop and establish the denotational fixed-point semantics of TICC™-Ppde, as well as show how the self-monitoring system for an application may be automatically generated by TICC™-Ppde from the definition of the application.

### 11. SEMANTICS OF TIMED INTERACTIVE TICC™-Ppde

11.1 Structure of Alleops

We have already seen an informal discussion of the structure of Alleops. A formal definition is given here. As in Section 9, in our discussions below, we assume that the security feature in protocols are turned off. Our objective is to characterize computations in a TICC™-network, if all computations occur as planned, without unpredictable disruption, which security enforcement could introduce. We will first define the semantics [26] of TICC™-Ppde when no dynamic modifications of pathways are allowed, and then extend the results to the case when dynamic modifications are allowed.

Let X₁, X₂, . . . , Xₙ, . . . be a potentially infinite sequence of generalPort groups, Gᵢ, and generalPort vectors, G₁, in a TICC™-network. In our discussion below in most cases G, may be replaced by G in assertions and the assertions would still hold. Therefore, for convenience we will only use G, unless use of G was necessary.

There are three kinds of events represented by icons, ‘Gᵢ^{S}[ ]→’, ‘→Gᵢ^{R}[ ]’ and ‘Gᵢ^{R[ ]}→’: ‘Gᵢ^{S}[ ]→’ sends out a service request, ‘→Gᵢ^{R}[ ]’ receives a response and ‘Gᵢ^{R}[ ]→’ causes a new event to occur after receiving a response. This new event cannot be a ‘→Gⱼ^{R}[ ]’ event, unless it was possible for the two arrows to merge, as defined in Definition 11 below. As mentioned earlier, the event ‘Gᵢ^{S}[ ]→’, occurs in the parent cells of functionPorts that receive the message sent by Gᵢ, and events ‘→Gᵢ^{R}[ ]’ and ‘Gᵢ^{R}[ ]→’ occur in the parent cells of the generalPorts in Gᵢ. Thus, for each icon there is a well-defined notion of where the event represented by the icon occurs. Same events may occur several times while a parallel program is running because of spawning iteration.

We refer to icons with the arrow, →, in their suffix as open icons; they are open for new events to occur, and icons with arrow prefix as closed icons.

Each port-group contains one or more ports, each from a distinct cell. Our group-to-group communication protocol, guarantees, whatever event occurs at one port in a port-group, would occur at all orts in that group in a synchronized fashion. Therefore, to identify and analyze events that may happen at port-groups Gᵢ, it is enough if we considered events that may happen at any one port in Gᵢ.

This does not always hold true for generalPort vectors G. All ports in a generalPort vector belong to the same cell. For every assertion of the form ‘∀(gεG) [symbol] . . . ’ that holds true for a generalPort group, the corresponding assertion, ‘∃(gεG)& . . . ’ would hold true for a generalPort vector. As we have already seen, events in a TICC™-network depend on both the network structure and TIPs that are defined at ports and port-vectors of a cell. In all the cases below, the reader should focus on what happens at any one generalPort belonging to a group or vector.

We ignore functionPorts, because every service request sent by a generalPort g, it is guaranteed to receive a response, by Theorem 3 in Section 9. Thus, functionPorts are driven by generalPorts. By focusing on events occurring at generalPorts, we can consider all computations that may occur in a TICC™-network.

These considerations simplify the definition of Alleop for a TICC™-network.

The following are Alleop icons of a TICC™-network: We have already seen these icons. They are introduce below for convenience.

Definition 7: Alleop Icons:
(a) ‘G^{S}[ ]→’, Event: ‘∃(gεG) [symbol] g^{S}→’: g sends out a message.
(b) ‘→G^{R}[ ]’, Event: ‘∃(gεG) [symbol] →g^{R}’: g receives a response.
(c) ‘G^{R}[ ]→’, Event: ‘∃(gεG) [symbol] g^{R}→’: g may spawn anew computation, or cause a response to be sent back to another G^{R}. Notice the use of existential quantifier in the interpretation of the events. It is always true that whatever happens to one port in a port-group happens to all of them. However, ports in a port group belong to distinct cells, and we are here interested in what happens to a port g in any one cell.
(d) ‘∃(sgεfg(C))(sg^{S}[ ])→’ & ‘∃(egεG)(eG^{R}[ ])→’ is the cell identifier. An existential icon ending with ‘(eg^{R}[ ]→’ always appears as a branch joining at a node in some path. They never appear in-line with a path. Those ending with ‘(eg^{S}[ ]→’ may appear in-line.

Definition 8: Valid Icon: An icon is valid if there is a pathway in the TICC™-network though which the event associated with the icon can occur and the TIP has the requisite structure to allow the event to occur, as described in Section 3.

Clearly, if ‘G^{S}[ ]’ in is valid then so is ‘→G^{R}[ ]’, since the same pathway is used both for sending service requests and for receiving responses, and no pathway may be changed before the response is received. We consider only valid icons. For convenience in describing well-formed paths in an Alleop, since paths have the structure of balanced parentheses, let us use the following notation:
‘(ᵢ’: denotes ‘Gᵢ^{S}[ ]→’, ‘Gⱼ^{S}[ ]→’, ‘∃(sGᵢ^{S}[ ])→’ or ‘∃(sGⱼ^{S}[ ])→’.
‘)ᵢ’: denotes ‘Gᵢ^{R}[ ]→’, ‘Gⱼ^{R}[ ]→’ or ‘∃(eGᵢ^{R}[ ])→’, and
‘]ᵢ’: denotes ‘→Gᵢ^{R}[ ]’, →‘Gⱼ^{R}[ ]’ or ‘→∃(eGᵢ^{R}[ ])’.
   It should be noted, these parentheses always denote events at a single port of a cell that belongs to the referenced port-group or port-vector: ‘(ᵢ’ denote send operations and ‘)ᵢ’ denote receive operations, and ‘]ᵢ’ represents closure nodes, nodes that terminate a path. All other nodes are open nodes, nodes that leave room for some other event to occur.

Definition 10: Well-formed node concatenations:
(a) Disallowed concatenations:
   ‘(ᵢ(ᵢ’: successive service requests cannot be sent by the same generalPort
   ‘)ᵢ)ᵢ’: successive responses cannot be received at the same generalPort
   ‘(ᵢ)ⱼ’: for i≠j: gⱼ cannot receive response for gᵢ's service request.
   These are the only disallowed concatenations.
(b) Concatenations below are well-formed only if they do not violate (a) and pathways and TIP structures support the composite events (see Section 3):
   ‘(ᵢ)ᵢ’ is well formed; If S is well formed the so is (ⱼs)ⱼ; If S₁ and S₂ are well formed then so is S₁S₂. Linked pairs that appear in a well-formed path have the following interpretations as successive events:
   Case (i) ‘(ᵢ)ᵢ’: ‘(ᵢ’ sends service request & receives response immediately, and is ready to send another service request.
   Case (ii) ‘(ᵢ(ⱼ’: ‘(ᵢ’ sends service request to a functionPort in the parent cell of ‘(ⱼ’, and the parent cell spawns new computation through ‘(ⱼ’.
   Case (iii) ‘)ᵢ(ⱼ’: On receipt of response at ‘)ᵢ’ parent cell of ‘)ᵢ’ spawns new computations through ‘(ⱼ’; i=j is possible.
   Case (iv) ‘)ᵢ)ⱼ’: On receipt of response at ‘)ᵢ’ parent cell of ‘)ᵢ’ uses the response at ‘)ᵢ’ to cause a response to be sent to ‘)ⱼ’.
(c) In any well-formed path, for any j, nodes in icon pairs, ‘(ⱼ,)ⱼ’, form a matching pair. In every matching pair, ‘(ⱼ,)ⱼ’, the same generalPort that sent a service request would receive the response.
(d) All paths defined in (b), and (c) are open paths, since all end with the arrow, ‘→’. A closed path is a well-formed path that does not end with the arrow, and its last node is a ‘]ⱼ’ node. Closed paths are also well-formed paths and are produced by using the merge operation, defined in Definition 11. In any well-formed path, for any j, ‘(ⱼ,]ⱼ’ is a matching pair.
(e) These are the only well-formed paths.

Lemma 6: In any well-formed path, the segment of the path between any two matching pairs including the matching pair is a well-formed path.

Proof: Follows from Definition 10.

[symbol]

Definition 11: Closure of Alleop Paths:
(a) ‘(ᵢ’ and ‘]ᵢ’ may merge to form the matching pair, ‘(ᵢ]ᵢ’: Here, a functionPort that receives a service request message from ‘(ᵢ’, sends back the response message without spawning.
(b) Merging ‘(ᵢ→’ with ‘→]ⱼ’ for i≠j is disallowed: ‘]ⱼ’ cannot receive the response message for a service request sent by ‘(ᵢ’.
(c) Merging ‘)ⱼ→’, with ‘→]ₖ’ for j≠k: allowed when receipt of response at ‘)ⱼ’ causes a response to be sent back to ‘]ₖ’. In this case, a matching ‘(ₖ^{S}→(ⱼ^{S}→’ should appear before ‘→)ⱼ→]ₖ’ in the path containing ‘)ⱼ→)ₖ→’.

Definition 12: Fork Operations ‘(ᵢ’ represents a fork operation if Gᵢ(Gᵢ) has more than one generalPort in it. Allowed forks of the form shown in FIG. 36 may occur in an Alleop. A fork distributes tasks to different cells that work in parallel.

Allowed forks of the kind shown in FIG. 36 represent situations where a cell sends out a service request and proceeds to do something else, while the response for the service request reaches the cell sometime later. TIPs in (5a), (7a), (9a), (9b), (11), (12), and (17a) would cause this kind of forks. The cell may use the received response, when need arises. It is possible that the response was never used by the cell, as it happened in the produce/consumer solution. A response is incorporated into parallel computations only when it is used.

Definition 13: Join Operations: ‘)ᵢ’ and ‘]ᵢ’ are join operations if the referenced generalPort group or vector has more than one port in it. A set of valid icons, {‘(₁’, ‘(₂’, . . . , ‘(ₙ’}, defines a join operation if each ‘(ᵢ’ for 1≦i≦n, sends message to its corresponding functionPort, fᵢ, in a functionPort vector f=[f₁,f₂, . . . ,fₙ]

[image]

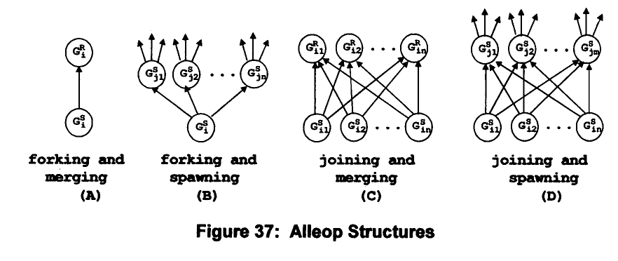

After a fork, a join and merge can occur immediately to produce the matching pair, ‘(ᵢ]ᵢ’, as shown in FIG. 37A. Here, the functionPort group that received the service request sends back a reply without spawning. Alternatively after a fork, a spawning can occur as shown in FIG. 37B. After a join, merging can occur as shown in 37C, or spawning can occur as shown in 37D. Structures of the kind shown in FIG. 37 are called Alleop subnets. Every path in a subnet should be a well-formed path.

[image]

Definition 14: Looping Operation: Any icon ‘(ᵢ’ of any well-formed path in any Alleop subnet may be linked to its matching ‘)ᵢ’ in the path by a looping link with an iteration variable, I, as its weight. The integer value of the iteration variable will specify the maximum number of times spawning may occur at ‘(ᵢ’.

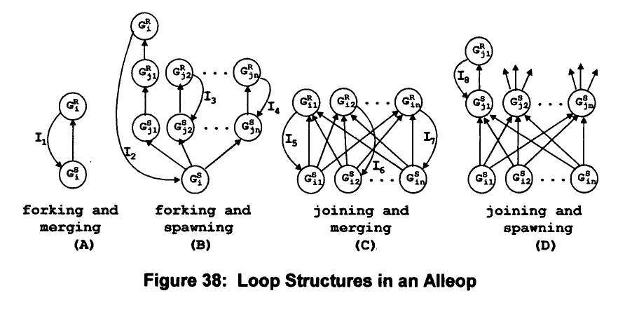

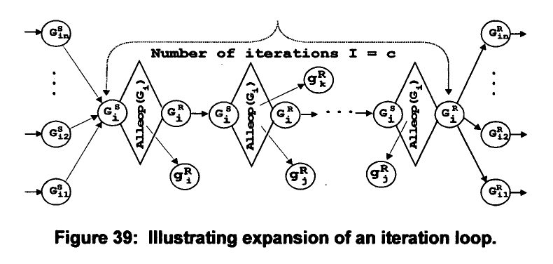

Looping indicates iterated spawning, as shown in FIGS. 38 and 39.

Lemma 7: The path bracketed by a loop will always be a well-formed path.

Proof: Follows from Lemma 6 and Definition 14.

[symbol]

[image]

Definition 15: Alleop of a TICC™-network. An Alleop is a graph of nodes connected by directed links containing no open path. It is constructed using valid merge, concatenation, fork, join and looping operations of valid icons of the TICC™-network satisfying Definitions 10 through 14. It may contain nodes with existential quantification and weighted looping links.

Theorem 5: Alleop of a TICC™-Network may be automatically constructed from the structure of the network and the structure of TIPs of cells in the network.

Proof: Construct first the set of all valid icons of the TICC™-network, then combine them using concatenation, merge, fork, join and looping operations according to the TICC™-network and TIP structures. In each cell focus on activities that may occur at its ports, and how they correspond with activities in other cells because of port-groups in the network. Define Alleop(G) for each generalPort group G (generalPort vector G) and link them together.

A node with existential quantification is used in an Alleop only in two situations, as described in Section 10.

[symbol]

[image]

Let ALLEOP(N)[I₁,I₂, . . . ,Iₙ] denote the Alleop of a TICC™-network, N, with looping variables, [I₁,I₂, . . . ,Iₙ]. Let ALLEOP(N)[c₁,c₂, . . . ,cₙ] be the Alleop of N in which all the well formed paths bracketed by each loop with iteration variable Iⱼ is replaced with cⱼ iterations of the path, as shown in FIG. 39. We will refer to ALLEOP(N)[c₁,c₂, . . . ,cₙ] as the loop-free Alleop or expanded Alleop.

Definition 16: For any generalPort group G, Alleop(G) is the Alleop subnet of ALLEOP(N)[1, 1, . . . , 1], containing all well formed paths between G^{S} and G^{R}, all forks and all joins at every icon ‘(ᵢ’ and ‘)ᵢ’ (or ‘]ᵢ’) appearing in those well-formed paths. This is always possible since every ‘(ᵢ’ will have a matching ‘)ᵢ’ (‘]ᵢ’) (Theorem 3, Section 9). Definition holds also when G placed by G.

The parts in diamond boxes in FIG. 39 represent Alleop(G₁)[c] (Alleop(Gᵢ)[c]), where iteration occurs c times. The arms projecting out of each Alleop (Gᵢ)[1] in FIG. 39 mark the unused resources acquired by Alleop(Gᵢ) during its computations.

Definition 17: Let S(N) be the set of all nodes in ALLEOP(N)[c₁,c₂, . . . cₙ] and let ≦ be reflexive, anti-symmetric and transitive relation on the elements of S(N), defined as follows: For every pair of nodes nᵢ,nⱼεS(N), if ‘nᵢ→nⱼ’ appears in ALLEOP(N)[c₁,c₂, . . . ,cₙ], then nᵢ≦nⱼ.

Theorem 6: If S(X)[c₁,c₂, . . . ,cₖ] is the set of all nodes in Alleop(X)[c₁,c₂, . . . ,cₖ] for X=G or G, then (S(X), ≦) is a complete partial order (also referred to as inductive partial order [26]). S(X)[c₁,c₂, . . . ,cₖ] is a lattice if it has no unused resources. This holds for any combination of finite integer values of constants cⱼ for 1≦j≦k.

Proof: Every path in S(x) should begin at X^{S} and end at X^{R}. Thus, S(X) has a bottom and every directed path in S(x) has a least upper bound. If S(x)[c₁,c₂, . . . ,cₖ] had no unused resource then all of its resources would have been incorporated into one of the paths connecting X^{S} and X^{R}. In this case, every subset of S(x) will have a bottom and a least upper bound. Changing the values of constants cⱼ for 1≦j≦k only changes the number of iterations of Alleops associated with groups or vectors appearing in Alleop(X), as shown in FIG. 39. These preserve the complete partial order (or lattice) structure.

[symbol]

[image]

Theorem 7: (S(N), ≦) is a complete partial order for any ALLEOP(N) [c₁,c₂, . . . ,cₙ] for any combination of finite integer values of constants cⱼ for 1≦j≦n. If ALLEOP(N)[c₁,c₂, . . . ,cₙ] had no unused resources then (S(N), ≦) is a lattice.

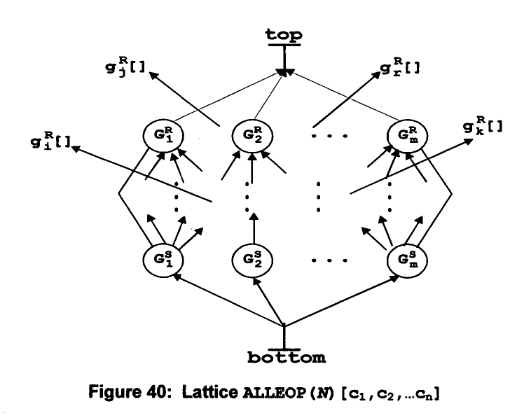

Proof: ALLEOP(N)[c₁,c₂, . . . cₙ] will have the structure shown in FIG. 40, where G₁^{S}, G₂^{S}, . . . ,Gₘ^{S} just above the bottom spawn computations based on inputs received from the environment. The nodes G₁^{R}, G₂^{R}, . . . ,Gₘ^{R} just below the top receive response messages and send this response to the environment. Here bottom and top represent the environment. Proof follows from Theorem 6, the structure of iterations shown in FIG. 39 and the structure in FIG. 40.

11.2 Activity Diagram

Definition 16: Instance of an Alleop Icon: At any give time, t, for all t₁≦t and for any icon ‘(ᵢ[ ]’ in an Alleop, ‘(ᵢ[t₁]’ is a grounded instance of ‘(ᵢ[ ]’, and it represents a message sending event that occurred at time to with appropriate bindings for existential variables. A grounded instance ‘)ᵢ[t2]’ or ‘]ᵢ[t2]’ of an icon, ‘)ᵢ[ ]’ or ‘]ᵢ[ ]’, represents a message receiving event occurred at time t2 with appropriate bindings for existential variables; ‘(ᵢ[?]’, ‘)ᵢ[?]’ and ‘]ᵢ[?]’ are floating instances indicating that the existential variables have not been bound yet or events associated with the icons had not yet occurred as of time t.

Let us refer to any two nodes in an Alleop connected by a link, as a linked pair.

Definition 17: Completely Grounded instance of a linked pair: At any given time t, an instance, ‘nᵢ[t₁]→nⱼ[t₂]’ is a completely grounded instance of a linked pair, ‘nᵢ[ ]≦nⱼ[ ]’ (same as ‘nᵢ[ ]→nⱼ[ ]’) in an Alleop, if both nodes are grounded instances else it is a partially grounded instance.

This definition is naturally extended to all Alleop subnets.

Lemma 6: At any given time, t, if ‘nᵢ[t₁]→nⱼ[t₂]’, t₁,t₂≦t, is a completely grounded instance of ‘nᵢ[ ]→nⱼ[ ]’ then t₁<t₂=t₁+δ≦t for a finite δ.

Proof: There are four cases to consider. We will use δ₀ for the time taken to execute a message transmission protocol. As discussed in sections 5, 6 and 9, δ₀ is finite. By Lemma 5, execution of any pthread takes only a finite amount of time. Let δ₁ denote the time taken to execute a pthread.
Case (i): The linked pair is ‘(ᵢ[t₁]→(ⱼ[t₂]→’:
   Here the sending event, ‘(ᵢ[t₁]→’ causes ‘(ⱼ[t₂]→’ to send a message. This will happen if the functionPorts that received the message from ‘(ᵢ’ at time t₁ spawned a new computation through ‘(ⱼ’ at time t₂. The time taken for this is the time needed to execute the pthread that constructed the message at ‘(ⱼ’, plus the protocol execution time: t₂=t₁+δ where δ=δ₀+δ₁.
Case (ii): The linked pair is ‘(ᵢ[t₁]→]ᵢ[t₂]’ or ‘(ᵢ[t₁]→)ᵢ[t₂]→’:
   Here ‘(ᵢ[t₁]’ sends a message at t₁ and gets a response at time t₂ with no spawning. Here t₂=t₁+δ, where δ=δ₁+2δ₀, reckoning that the time taken to send the service-request and the time taken to receive the response would be the same.
Case (iii): The linked pair is ‘)ᵢ[t₁]→)ⱼ[t₂]→’ for i≠j:
   Receipt of response at ‘)ᵢ’ cause some functionPort to generate and send a response to ‘)ⱼ’ for a service request received earlier from ‘(j’: t₂=t₁+δ where δ=δ₀+δ₁.
Case (iv): The linked pair is ‘)ᵢ[t₁]→(ⱼ[t₂]→’: (i=j) is possible.
   Receipt of response at ‘)ᵢ’ causes new spawning at ‘(ⱼ’; t₂=t₁+δ where δ=δ₀+δ₁, where δ₁ is the time for constructing the service request at ‘(ⱼ’.

[symbol]

Definition 18: Activity Diagram AD[N][c₁,c₂, . . . ,cₙ]: The activity diagram AD[N][c₁,c₂, . . . ,cₙ] of an ALLEOP(N)[I₁,I₂, . . . Iₙ] is a completely grounded instance of ALLEOP(N)[c₁,c₂, . . . ,cₙ] for Iⱼ=cⱼ≧0 for 1≦j≦n, where cⱼ is a finite integer.

Let S(AD) denote the set of all nodes in an activity diagram, AD[N][(c₁,c₂, . . . ,cₙ]; S(N), the set of nodes in ALLEOP[N][c₁,c₂, . . . ,cₙ] is the domain of computations. Note that |S(AD)|≦|S(N)|, since S(AD) will not contain any existential quantifier.

Theorem 7: If Φ is the mapping, Φ:S(N) [symbol] S(AD), then Φ is monotonic and (Scott [24]) continuous and therefore Φ has a least fixed point, which is the least upper bound of {Φⁿ(⊥)|nεNatural Numbers}. This fixed point will be unique if AD[N][c₁,c₂, . . . ,cₙ] is a lattice, else it may not be unique.

Proof: That Φ is monotonic and (Scott) continuous follows from Definitions (16), (17), Lemma 6 and Definitions (18). Proof for the existence of fixed-point follows from the classic fixed-point theorems [24] [26]. For uniqueness when AD[N][c₁,c₂, . . . ,cₙ] is a lattice, note that in every case of Lemma 6 and time t, the cell C, referred to by the icon, computes a function,
p(m, t, S^{C}(t))=[m′,S^{C}(t+δ)] (47)
where p=[p₁,p₂, . . . ,pₙ], n≧1, is a functionPort or generalPort vector at a cell C, m=[m₁,m₂, . . . ,mₙ] is the vector of messages received at the ports in p, t is the time at which all messages were received (or sent) at the ports in p, S^{C}(t) is the state of cell C at time t, m′ is the vector of output messages produced and δ is the time delay defined in Lemma 6.

If AD[N][c₁,c₂, . . . ,cₙ] is not a lattice, then the state, S^{C}(t), will depend on the resources used (not used). This may lead to different results at different times. In this case, the result will be a member of the power set of S(AD) and will be non-deterministic.

[symbol]

Automatic Construction of Self-monitoring System: AD[N][c₁,c₂, . . . ,cₙ] is almost a copy of loop-free ALLEOP(N)[c₁,c₂, . . . ,cₙ] containing grounded instances of all nodes in ALLEOP(N)[c₁,c₂, . . . ,cₙ], but for the existential nodes being replaced by their respective bindings. Thus, one may begin with a copy of ALLEOP(N)[0, 0, . . . , 0] as the initial activity diagram, AD[N][0, 0, . . . , 0]. This could be installed at the time of initialization. One may assign each eb-cell to manage events associated with a designated set of generalPort groups and vectors. As events unfold, each eb-cell will install bindings for existential variables and timing data into the time slots of nodes in AD[N], which it manages. When spawning curs at a node ‘(ᵢ[ ]→’ at time, tᵢ, a new copy of loop-free Alleop (‘(ᵢ’) with the grounded node ‘(ᵢ[tᵢ]→’ at the root may be inserted between appropriate nodes in the growing AD[N], with appropriate existential bindings for the node ‘(ᵢ’, if any.

At any time t, the growing AD[N] will specify the structure of future events that may occur in that activity diagram. Any departure from that structure may be construed as an error and an alert may be generated with a pointer to the generalPort groups (vectors) that caused that error to occur. This may be used to start a self-diagnosis and repair session, if appropriate pitheads for doing so had been already defined. By placing upper bounds on times at which response messages should be received, this scheme can be used to detect and report even unanticipated errors.

A significant characteristic of such TICC™-networks is that only the CPUs that run the eb-cells that construct AD[N] need be synchronized to real time. All other CPUs may run in their own local times, unless absolute time was needed for some functions computed by them. This simplifies implementation of distributed real time applications.

The computing networks needed for this kind of self-monitoring system (eb-cells and ea-cells) are independent of an application system. They depend only on the Alleop structure and thus may be predefined and made a part of TICC™-Ppde. By Theorem 5 ALLEOP(N)[I₁,I₂, . . . ,Iₙ] may be automatically constructed from the definition of CIPs and the TICC™-network for an Rtas. Communication between the self-monitoring system and an application occurs using the signaling scheme shown in FIGS. 18 and 19. Thus,

Theorem 8: TICC™-Ppde can automatically generate the self-monitoring system from the definition a parallel program.

[symbol]

Denotational Semantics under dynamic changes: If the TICC™-network changes dynamically at any time, t, the only nodes that will be affected by this change will be the nodes in AD[N], which are floating or nodes which are in the send state, s. New links and nodes reflecting the changes that were made may be introduced into Alleop[N] and AD[N], and links and nodes associated with floating instances that are no longer needed may be removed. The changed Alleop[N] and AD[N] would still maintain their complete partial order or lattice structure, since all dynamic changes may be made only after response messages had been received at generalPort groups, at which changes might have been made. Thus, Theorem 7 holds even when a TICC™-network is dynamically changed.

To dynamically establish a pathway a cell will send out a service request to the configurator in its multiprocessor, or to a designated cell called Communication System Manager (CSM), associated with the cell. A cell may request a pathway only between one of its own ports and some other ports in a network. A cell may establish a pathway only if it had the requisite privilege to do so. Privileges are set at the time a cell is installed in a network. Each CSM may service several cells. CSM will respond to the cell positively or negatively depending on whether a requested pathway was established or not. Similarly, a cell may also request its CSM to install new cells in a network. Only the configurator will have the privilege to establish pathways between any two groups of cells and install any new cell as needed.

In the next section, we consider conditions for scalability of a TICC™-network.

### 12. SCALABILITY OF TICC™-NETWORKS

Without loss of generality, we will assume that in FIG. 40 there is only one node, G^{S}, just above the bottom. Let us call it the source node. Arguments below hold for any number of source nodes. Let us assume, the lattice with G^{s} at the bottom is the expanded loop-free lattice. Let us call it E-Alleop(G). Let us refer to the TICC™-network associated with G as network (G).

If E-Alleop(G) is replicated n times at the root ⊥ of FIG. 40, then the number of inputs it receives will be n times the number of inputs received by G and it will contain n times as many cells and pathways. However, there will be no cross-linking between nodes of one such replicated lattice and another. In this case, if enough resources are available then clearly the program can be arbitrarily scaled. We will refer to n as the scaling coefficient.

Interesting scalability issues arise when the replicated lattices contain cross-linked nodes, where nodes in one replicated unit are linked to nodes in other replicated units. In this case, the number of pathways in the n-times scaled-up version will be larger than n-times the number of pathways in each E-Alleop(G). Let us refer to the additional pathways so added to the scaled-up version as cross-linking pathways. As the scaling coefficient n is increased, the number of cross-linked pathways will also increase.

Each cross-linked pathway should be connected to ports that are newly introduced into the cells of network(G). This may also increase the number of ports in a cell, and/or the number of ports in port-groups. Consequently cells in the scaled-up network may contain more ports than what they had in network(G), with attendant increase in polling, servicing and group-to-group message transmission times. The essence of the scalability theorem is that, if the ratio of this increase in polling and servicing times to the total time required by G to complete its parallel computation, is small, then the TICC™-network for an application is scalable. Let us refer to the ports introduced to install the cross-linking pathways as cross-linking ports.

We use N to refer to a TICC™ parallel program with TICC™-network H. When the program is completed it will come with all CIPs, pthreads and message classes defined for it. Let |N| be the number of cells (CPUs) in N. Let T(N, D) be the time taken to compute whatever it is that N computes, for input data D. Let SP be the best sequential program that one could write, running in one CPU, to compute the same for the same input data, D. Let T(N, D) be the time taken to complete the sequential computation. Let n [symbol] N denote the scaled up version of N with the scaling coefficient n. Then the number of cells (CPUs) in |n [symbol] N|≧n|N| would hold, since one may have to use additional cells to coordinate activities in the replicated networks. However, these additional cells will always operate in parallel with the cells in N. Thus, extra time added by them will be minimal. We will thus ignore them and set |n [symbol] N|=n|N|, assuming that the number of cells added for coordination is likely to be small compared to the number of cells in |N|.

Definition 17: Efficiency & Speed-up: Speed-up,
ψ(N, D)=T(SP, D)/T(N, D), and efficiency,
ξ(N,D)=ψ(N,D)/|N|.

With a scaling coefficient n, if there were no cross-linking then, clearly efficiency will not change, but speed-up will increase n-fold. With cross-linking, speed-up will be less than n-fold. We attempt here to quantity this.

Definition 18: Degree of cross-linking: For a scaled-up version n [symbol] N, the degree of cross-linking, η, is the following: If xP(C)≧0, is the number of cross-linking ports that a cell C in S(N) uses in any one of polling cycles, then η=Maximum{xP(C)|CεS(N)}.

Definition 19: Scalability Term: η [symbol] τ is the scalability term, where [symbol] and τ are defined as follows: If ν(xp) is the number of times a cell c uses its cross-linking port, xp, in a parallel computation (from its art to end), then

[symbol]

=Maximum{ν(xp)|∃C∃xp [(xp attacheadTo C) & (Cε(N))]},

and τ is the maximum time needed to service a cross-linking port.

In other words, in any parallel computation, before the computation is completed each cell will spend at most η [symbol] τ units of time servicing its cross-linking ports. The cells in a network will all do this in parallel.

Definition 20: Network Bottleneck: The scaled-up version, n [symbol] N of a network N has a bottleneck if one or more of the following holds true: (i) the number of ports in a port-group in n [symbol] N increases in proportion to n, or (ii) the scalability term η [symbol] τ increases in proportion to n.

When there is no network bottleneck one may assume that the scalability term η [symbol] τ is independent of e scaling coefficient n.

Definition 21: Grain size: Grain size of a cell c in N is the average amount of time spent by c responding to a message it received. Grain size of N is the average of grain sizes of all cells in the network.

We will use γ(N) to denote the grain size of the network N. Let |D| be the size of input data.

Definition 22: scalability: N is scalable if the scalability term, η [symbol] τ, is independent of the scaling coefficient n and for all scaled-up versions, n [symbol] N, the following holds true: ∀D∃D′ (γ(N)=γ(n [symbol] N)) [symbol] ξ(n [symbol] N, D′)=ξ(N, D)(1−ε), for |D′|=n|D|, and the coordination coefficient, ε=[η [symbol] τ/T(N, D)], 0≦ε<<<1, is small.

Theorem 9: Scalability Theorem: Every well-coordinated network N without network bottleneck is scalable if the scalability term is small.

Proof: Since there is no network bottleneck, we will assume that the scalability term η [symbol] τ is independent of the scaling coefficient n. Since the network is well coordinated, no message will be missed and every message will be serviced. Let t₀ be the time at which computations in network N started. One may choose toto be the time at which the source nodes just above the bottom of the lattice in FIG. 40 sent out their service-request messages. Let us assume, they were all synchronized to send out the service request at the same time. Since the grain size of n [symbol] N is equal to that of N all for the computations that occur in any replicated N will take roughly the same time as the time taken in N, except for the computations associated with the cross-linking ports.

No matter when a message is sent out via a cross-linking port, its parent cell has to spend extra time to complete the computation associated with it. By the scalability term, this extra time is at most η [symbol] τ. Since cells operate in parallel with each other, in each replication of N the total time spent on processing cross-linked nodes by all cells will be only η [symbol] τ. Thus, the total time spent on a parallel computation by (n [symbol] N) will be
T(nN, D′)=T(N, D)+η [symbol] τ.

Thus, the speed-up for the scaled-up network (n [symbol] N) will be,
ψ(nN, D′)=T(SP, D′)/(T(N, D)+η [symbol] τ)

Setting ε=η [symbol] τ/T(N,D) we get,
ψ(nN, D′)=(T(SP, D′)/T(N, D))(1/(1+ε)) and
T(SP, D′)=σ(n)T(SP, D′),

where σ(n)≧n, since |D′|=n|D|. Hence,
(T(SP,D′)/T(N,D))=σ(n)[(T(SP,D)/T(N,D)].

Substituting ψ(N,D) for (T(SP,D)/T(N,D)) we get

$$\begin{matrix}ψ ( n ↑ N , {D}^{′} ) = σ ( n ) [ ψ ( N , D ) ( 1 / 1 + ɛ ) ] \\ = σ ( n ) [ ψ ( N , D ) ( 1 - ɛ + {ɛ}^{2} + … ) \\ \approx σ ( n ) [ ψ ( N , D ) ( 1 - ɛ ) for small ɛ . Therefore ,\end{matrix}$$

$$\begin{matrix}ξ ( n ↑ N , {D}^{′} ) = ψ ( n ↑ N , {D}^{′} ) / \vert n ↑ N \vert \\ = σ ( n ) [ ψ ( N , D ) ( 1 - ɛ ) ] / n \vert N \vert \geq ξ ( N , D ) ( 1 - ɛ ) . •\end{matrix}$$

Let us consider scalability for our Producer/consumer and FFT solutions as per results obtained above.

Scalability of the Producer/Consumer Solution: The solution is shown in FIG. 23. Clearly, this network is not scalable, because Config here creates a bottleneck. One may have to introduce multiple distribution layers, with warehouses (coordinators), the number of warehouses being much less than the scaling coefficient. New cross-linking pathways between producers and warehouses are necessary. Values of variables in the scalability term, η [symbol] τ, may be adjusted to get good efficiencies.

Scalability of the FFT Solutions: The network on the left side of FIG. 24 is clearly not scalable, since the number of ports in the ports group will grow linearly with the scaling coefficient. This creates a bottleneck. For the network on the right of FIG. 24, if the network is scaled up n times, then the number of cells in the diagram will be an, and the number of generalPorts (functionPorts) in each cell will grow to 2n. Thus, it would seem that this network is also not scalable. However, in each FFT computation each functionPort and each generalPort is used exactly once, no matter what the scaling coefficient is. Thus, η= [symbol] =1, and the scalability term η [symbol] τ=τ is independent of the scaling coefficient, and thus the network is scalable.

### 12. CONCLUDING REMARKS

We have described here a new methodology for developing parallel programs, using TICC™-Ppde. The programs are self-scheduling and run in real-time with real-time message exchanges. The message exchange latencies are very small and the system provides the virtualMemory framework to allocate physical memories suitably to minimize memory contention in each shared-memory environment The number of messages that may be exchanged in parallel at any time is limited only by the number of active cells in the system and the capacity of the TICCNET™. Messages may be exchanged asynchronously with no need for synchronization sessions. Parallel buffering at each cell eliminates buffer contentions. Under appropriate a priori known conditions, the networks are scalable.

For each parallel program application defined in this new framework, TICC™-Ppde automatically builds a self-monitoring system to detect malfunctions and issue alerts when necessary. TICC™-Ppde provides, in addition facilities to dynamically install monitoring cells in a system. Such dynamically attached monitors may be used for dynamic debugging. TICC™-Ppde provides a rich variety of synchronization methods, to synchronize events in a system with events occurring elsewhere. The design methodology proposed here simplifies testing, verification, maintenance and updating of parallel programs.

The programmatically controlled signaling system provided by CCPs makes it possible the use the same programming framework for all distributed parallel programs, whether they are real time programs, programs for embedded systems, or just ordinary parallel programs. In all cases, the network is the computer that executes the programs.

The denotational fixed-point semantics of the programming system established here, explains the structure of computations performed in TICC™-networks, and uses this structure to automatically implement a self-monitoring system that can detect even unanticipated errors. An understanding of this structure may help readers to design programs using the methods proposed here. This brings to focus the immediacy of theory and its application to practice that this programming methodology brings to software engineering.

To date, we have designed a distributed memory TICCNET™ that interconnects 512 shared-memory multiprocessors, where each multiprocessor may have 32 or more CPUs in an integrated multi-re chip. We have implemented a proof of concept prototype TICC™-Ppde that works in shared memory environments. In both shared-memory and distributed memory environments, always messages are exchanged immediately, as soon as there are ready. In distributed memory environments message exchanges occur through direct memory-to-memory data transfers. All group-to-group communications occur in a self-coordinated and self-synchronized manner. Message exchange latencies are small, because pathways are established in advance, and all agents and ports on a pathway are always tuned to each other. No synchronization sessions are necessary before sending a message, thus enabling real-time messaging.

Messages are always sent asynchronously with no need for sequential buffers. Parallel buffers used by each cell eliminate buffer contentions and allow messages to be responded to flexibly in an order that may be dynamically determined by the cell itself. All time stamps are local to cells, except for the eb-cells and ea-cells. The synchronization facilities used in group-to-group communications may be used in a variety of other situations, as described in Section 8, to synchronize events that occur in a Rtas. No externally imposed scheduling and coordinating mechanisms are needed to run TICC™-Ppde programs. They are self-scheduling, self-synchronizing and self-coordinating.

The most important feature of the methodology proposed here is that the interaction structure among components in a parallel program may be specified easily at a level of abstraction, independent of pthreads and protocols used for parallel computations. This interaction structure may be automatically analyzed to identify the structure of event occurrence patterns in a system. The interaction structure may be executed, independent of the pthreads, with simulated pthread execution times to test, evaluate and verify the performance of a designed system, before the system is fully developed. This is a great advantage.

Each cell in the system is an autonomous self-regulating agent that is embedded into a TICC™-network. These cells may be modified and replaced after in situ testing as needed, enabling any TICC™-based system to evolve during its lifetime. To simplify development, we can encapsulate collections of cells, together with their associated shared-memory pathways, as components and store them in a library for use when designing new systems.

Since messages are exchanged at high speeds and operations are performed asynchronously based on message receipt in a self-scheduled manner, it should be possible to run programs at high-speeds in a TICC™-network with near 100% efficiencies even at low grain sizes. There are no overheads for synchronization, coordination and scheduling of parallel computations, and for communications.

The TICCNET™ provides unusual opportunities for massive high-speed data exchanges. CCPs provide a capability to programmatically communicate with any embedded hardware or software component, TICC™-Ppde programs particularly well suited for the new era of massive Data Intensive Computing Environments with supercomputers distributed in a grid. They are also well suited for the new era of personalized supercomputing with multi-core chips containing 32 to 128 or more processors, and for the development of embedded real time software.

The methods introduced here call for a reconsideration of our traditional approaches to software engineering, operating system design and machine design. The methods exhibit a structure for parallel programs, which is different from the traditional data-flow structure as will as traditional discrete event structure. The significance of these methods to the future of computation remains yet to be seen. It is possible that the age will not be too far away, when complex TICC™-based parallel programs are directly compiled into multicore chips. Such chips may be put together with the right interfaces to build systems that are yet more complex.

We have now reached a plateau in our current computing technology, in which we are being overwhelmed by software complexity. Increasing terraflops/sec hardware to femtoflops/sec hardware is not going to solve the problems caused by this software complexity. As terraflops/sec increases, software execution efficiencies keep plunging down. TICC™ solves this problem by splitting the design paradigm into four stages: (i) network definition; (ii) interaction definition and development of pthread and message specifications; (iii) message and pthread definitions; and (iv) integration, testing and certification. In each stage the definitions may be analyzed for correctness, independent of the other stages and the integrated system may then be checked and certified.

### 14. REFERENCES

1. Chitoor. V. Srinivasan, TICC™, “Technology for Integrated Computation and Communication” U.S. Pat. No. 7,210,145, patent issued on Apr. 24, 2007, patent application Number 102,655/75, dated Oct. 7, 2003, International patent application under PCT was filed on Apr. 20, 2006, International application No. PCT/US208/015305.
2. Edward A. Lee and Yang Zhao, “Reinventing Computing for Real Time in Proceedings of the Monterey Workshop 2006, LNCS 4322, pp. 1-25, 2007, F. Kordon and J. Sztipanovits (Eds.)© Springer-Verlag Berlin Heidelberg 2007. The 2006 Technical Report that preceded this publication.
3. Yang Zhao, Jie Liu and Edward A. Lee, “A Programming Model for Time-Synchronized Distributed Real-Time Systems”, in Proceedings of the 13th IEEE Real-Time and Embedded Technology and Applications Symposium (RTAS 07), Bellevue, Wash., United States, Apr. 3-6, 2007.
4. Ye Zhou and Edward A. Lee “Causality Interfaces for Actor Networks,” EECS Department, University of California, Berkeley, Technical Report No. UCB/EECS-2006-148, Nov. 16, 2006.
5. Xiaojun Liu and Edward A. Lee “CPO Semantics of Timed Interactive Actor Networks”, EECS Department, University of California, Berkeley, Technical Report No. UCB/EECS-2006-67, May 18, 2006.
6. E. Dijkstra, “Guarded commands, nondeterminacy and formal derivation of programs,” Comm. ACM 18, 8, 1975.
7. C. A. R. Hoare, “Communicating Sequential Processes,” Comm. ACM 21, 8, 1978.
8. R. Milner, J. Parrow, and D. Walker, (1992) A calculus of mobile processes, Parts I and II, Journal of Information and Computation, Vol 100, pp 1-40 and pp 41-77, 1992.
9. Carl Hewitt, (1976) “Viewing Control Structures as Patterns of Passing Messages”, A. I. Memo 410, M.I.T, Artificial Intelligence Laboratory, 545 Technology Square, 02139.
10. Gul Agha, (1986) “ACTORS: A Model of Concurrent Computation in Distributed Systems”, The MIT Press Series in Artificial Intelligence, Dec. 17, 1986.
11. Edward A. Lee, (2007) “Are new languages necessary for multicore?”, Position Statement for Panel, 2007 Internal Symposium on Code Generation and Optimization (CGO), Mar. 11-14, 2007, San Jose, Calif.
12. William D. Clinger (1981) “Foundations of Actor Semantics”, Paper back, publisher Massachusetts Institute of Technology, 1981.
13. Alan Turing, (1937), “On Computable Numbers, with an application to the Entscheidungsproblem” Proc. London Math. Soc., ser, 2, vol. 42, (1936-37), pp 230-265, “A Correction”, ibid, vol. 43 (1037), pp 544-546.
14. Bandamaike Gopinath and David Kurchan, “Composition of Systems of objects by interlocking coordination, projection and distribution,” U.S. Pat. No. 5,640,546, Filed Feb. 17, 1995.

15. Souripriya Das, “RESTCLK: A Communication Paradigm for Observation and Control of Object Interactions”, Ph.D. Dissertation, Department of Computer Science, Rutgers University, New Brunswick, N.J. 08903, January 1999. DCS-TR-450. Can be down loaded from http://www.cs.rutgers.edu/pub/technical-reports.
16. Edsger Dijkstra. Cooperating sequential processes. (1965). Reprinted in Programming Languages, F. Genuys, ed., Academic Press, New York 1968.
17. William Gropp, et al [1999] “Using MPI, Portable Parallel Programming with Message-Passing Interface, second edition”, The MIT Press, ISBN 0262-57134-X. Also see http://www-unix.mcs.anl.gov/mpi/
18. G. E. Kamiadakis and R. M Kirby II, “Parallel Scientific Computing in C++ and MPI: A Seamless Approach to Parallel Algorithms and Their Implementation,” Cambridge University Press, 2003.
19. A. Geist, et al, “PVM: Parallel Virtual Machine a Users' Guide and Tutorial for Networked Parallel Computing”, MIT Press, 1994.
20. SHMEM: http://www.csar.cfs.ac.uk/user_information/tools/comms_shmem.shtml
21. OpenMP: http://www.llnl.qov/computinq/tutorials/openMP/.
22. John von Neumann, [1963] Collected Works, Vol 5, Mac Millan, New York, 1963. The first von Neumann computer was built early in the 1950's.
23. Herman H. Goldstein and John von Neumann, [1963] Collected Works, Vol 5, Mac Millan, New York, 1963, pp 91-99. (The first paper that introduced the concept of flow charts and proving correctness of programs through assertions in late 1950's.)
24. B. A. Davey and H. A. Priestly, [1990], “Introduction to Lattices and Order”, Cambridge University Press, 1990.
25. Vipin Kumar, et al, “Introduction to Parallel Computing”, The Benjamin/Cummings Publishing Company, Inc., 1994, Chapter 10, pp 377406, ISBN 0-8053-3170-0.
26. G. Plotkin, [1976], “A powerdomain construction”, SIAM Journal on Computing, S(3):452-487, 1976.

### Appendix I: Proof of Theorem 1

Suppose there was a deadlock. In this case, it would be true that two ports, fᵢ, fⱼ, in two different cells, cᵢ and cⱼ, could each receive its message only after the other had completed its computations. Then, either fᵢ and fⱼ should be waiting for a message in order to complete their computations, in the case of synchronous TIPs, or they are being skipped over, in the case of asynchronous computations. This kind of deadlock will happen only if (i) some generalPort g never sent the expected messages to fᵢ or fⱼ, since no fᵢ directly communicates with any fⱼ, or (ii) some f failed to respond to a service request it received. By Theorem 3, Section 9, (ii) can never happen, unless, of course, there was a system breakdown or some spawning iterated indefinitely, in which case the self-monitoring system would identify and report it; this may be implemented by setting upper bounds on times needed to respond to service requests and setting the self-monitoring system to issue an alarm when this upper bound is exceeded.

Case (i) above might occur because, computations were such that no messages were needed. In this case, if synchronous TIPs were used at fᵢ, fⱼ then there will be a deadlock; these synchronous TIPs should then be replaced with suitably designed asynchronous TIPs. If both fᵢ, fⱼ used asynchronous TIPs their parent cells will never wait at these ports for message receipt, and if no messages were needed in the computation then this would not be a problem; their parent cells will simply ignore the ports, as they should be.

Therefore, the only cases to be considered are, (a) the expected messages did not arrive for some other reason or (b) one or more of the needed local data were not available and the messages could not be serviced. Condition (b) cannot occur if TIPs are properly structured. So only condition (a) remains a possibility.

A functionPort f will fail to receive a message from a generalPort g to which it is connected by a pathway for one of two mutually exclusive reasons: The first is that g did not send the message because the external event that was supposed to trigger the message sending did not occur. This will require that the external mechanism be fixed, or Rtas redesigned not to expect this externally triggered message. The second is that another functionPort, f′, that was supposed to spawn a new computation by sending a new message through a generalPort g, did not itself start its computation.

[image]

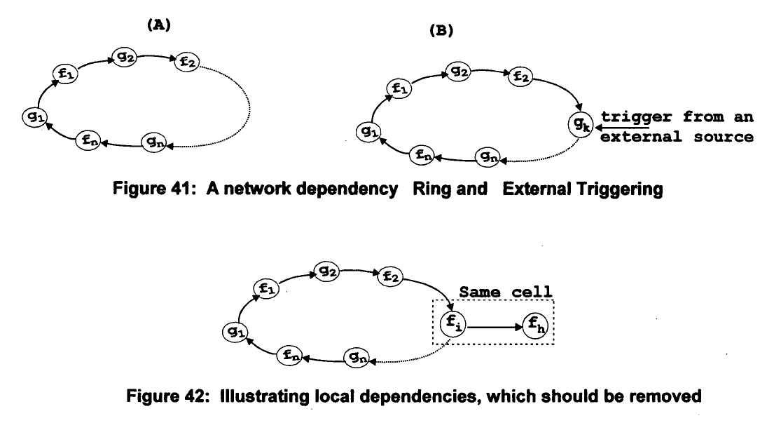

In this case, there will be a network dependency cycle of the form shown in FIG. 41A, in which each fₖ is dependent on message from gₖ, for 1≦k≦n, and the message sent out by g₁ is dependent on fₙ. The ports fᵢ and fⱼ mentioned earlier would both be included in this ring. Each functionPort fₖ in the ring will be dependent on a unique generalPort, since no two functionPorts of a cell could use the same generalPort to spawn a computation.

Computations in this closed ring will never get started if it always remained closed as shown in FIG. 41A. In this case, it may be necessary to start computations in the ring by injecting a message into the virtualMemory of some generalPort in the ring and triggering it through some external source as shown in FIG. 41B, and removing this trigger after the message had been sent.

Otherwise, the ring is superfluous and the entire ring may be removed from the network. It is quite possible that there were local data associated with the functionPorts in this ring, say functionPort fᵢ, which was used by fₕ:tip( ) of some other functionPort fₕ belonging to the parent cell of fᵢ, as depicted in FIG. 42. In this case, when the ring is removed, all local variables in the CIP associated with fᵢ should also be removed, and pthreads at fₕ should be defined to be independent of these local variables. This will allow fₕ to start servicing its pending messages without waiting for the local variables to become ready.

[image]

Once all such rings are thus taken care of, the network will be deadlock free.

This proof specifies a method to check a Ticc-network for possible deadlocks and remove them.

### Appendix II: Protocols in π-Calculus

One may wonder, since protocol has been reduced to a computation in TICC™ and all computations may be described in calculus, why not describe the protocol computations in π-calculus. We attempt to do this here.

We will focus only on the signal exchange a1:s→f that appears in statement (2), when message is delivered to the receiving port f, since there is no concept of memory in π-calculus. We use u as the name of the r-calculus port that sends signal s, instead of using the Ticc-agent, a1. Let A1 and A2 be the π-calculus agents. One may then describe this signal exchange in π-calculus by the statements, A1: u̅s.P(x) and A2:u(s).Q(w). Here the port u of agent A1 sends the signal s and proceeds to execute P(x) and the corresponding port u of agent A2 binds it, does the necessary substitution and then executes Q( v̅). Of course, the signal s would not appear in w and the name y that was substituted in statement (20) has not been exchanged yet. This name remains to be exchanged in yet another exchange, which again would require another signal s to be transmitted!

Alternatively, one may assume, after sending signal s the agent A1 sent the name y, and A2 did two bindings, one for the signal and the other for the name, where only the name was substituted into w, and the signal was ignored. This is similar to executing u:mR?( ){b (y)}. Yet alternatively, one may assume that in each name exchange a pair of symbols, p=(s, y), were exchanged and binding occurred through something similar to u: mR?( ){b(y)}. Thus, to complete the name exchange, two binding operations would be needed: one to bind the signal and the other to bind the name. One may, of course, instead think of each link as a pair, consisting of a signal line sL and a name-line dL, and accomplish the same task by sending the signal on the signal line and name on the data line simultaneously.

Fortunately, such signal exchanges are in fact implicitly built into the execution paradigm proposed for π-Calculus. One may assume, hidden ports in π-Calculus are prewired to signal each other when they exchange names. For all other ports, every agent with a port named y should be able to signal another agent with port named y, in order to prepare it to receive a name that is about to be transmitted. Since port names may themselves change dynamically this will be a complex process for systems containing millions of agents. For example, let us consider how synchronization among a group of agents may occur in π-Calculus.

Suppose we had n agents, Aᵢ, for 1≦i≦n communicating with n agents Bⱼ for 1≦j≦n. Let yᵢ be the name of the port of Aᵢ and yⱼ be the name of the port of Bⱼ. Let it be required that agent Bₙ has to respond only after it has received names from all agents Aᵢ. Let us assume n=3. Let
Aₖ≡ y̅ₖaₖ for k=1, 2, 3 (2.1)
Bₖ≡yₖ(bₖ) for k=1, 2 and (2.2)
B₃≡y₃(b₃).Q₃(w₃), (2.3)

Here Aₖ may send names in any order. Therefore, we have to define a B₁₁, which can receive the names in any order,
B₁₁≡B₁.(B₂.B₃+B₃B₂)+B₂.(B₁.B₃+B₃.B₁)+B₃.(B₁.B₂+B₂.B₁) (2.4)
where + is the non-deterministic selection operator in π-Calculus. In the different ordering permutations, B₁₁ will execute,
(a₁/b₁)(a₂/b₂)(a₃/b₃)Q₃(w₃) or (a₁/b₁)(a₃/b₃)(a₂/b₂)Q₃(w₃) or
(a₂/b₂)(a₁/b₁)(a₃/b₃)Q₃(w₃) or (a₂/b₂)(a₃/b₃)(a₁/b₁)Q₃(w₃) or
(a₃/b₃)(a₁/b₁)(a₂/b₂)Q₃(w₃) or (a₃/b₃)(a₂/b₂)(a₁/b₁)Q₃(w₃) (2.5)

Thus, in all cases Q₃(w₃) will be executed after all the names had been received. One may view this as enforcing synchronization and coordination. In the general case, one would need n! permutations. For more general agent expressions there are more complications. This may not thus be the most efficient way to write programs. However this shows, synchronization and coordination are, in principle, possible in π-Calculus. In a sense, parallel programming in π-Calculus is very much like sequential programming in Turing machines. Nevertheless, π-Calculus shows how parallel programs may be defined in terms of interactions.

Von Neumann [22] machines gave us a way of articulating computers in terms of well-defined components, instead of just viewing them as one large tape controlled by sequential machines, or a huge collection of π-Calculus agents. Goldstein and von Neumann [23] showed us how their machines may be programmed. These gave us practical ways to design computers and program them. Unfortunately, von Neumann and Goldstein formulated programs to compute functions and not to interact with hardware; compilers and operating systems took care of this interaction. Ever since then, we have been stuck with this view of programming. Introduction of CCPs changes this view.

TICC™ and TICC™-Ppde introduce the programming abstractions needed to define complex programs in terms of interactions and pthreads, using CCP-protocols to interact with both hardware and software.

What is claimed is:

1: In an Ticc-based Real Time Application Program Development and Execution platform, called. Ticc-Rtas, using patented Technology for Integrated Computation and Communication (hereinafter referred to as TICC™), a method for writing and executing parallel programs to perform intended real time computations. for an. application, hereinafter called the Real time application system (Rtas), consisting of programs that run in embedded cells, each running in its own processor or microprocessor (hereinafter called processor), the Rtas definition composed of software assess called. Cell, Port, VirtualMemory, Agent and Message and subclass thereof defined in an object oriented programming language, each Cell, Port, Agent, VirtualMemory and Message class and subclass in the application system containing. software data structures and sequential programs (hereinafter called pthreads—for parallel pthreads), the Rtas composed of software objects called cells, ports, virtualMemory, agents and mass which are instances of corresponding Cell, Port, VirtualMemory, Agent and Message classes and subclasses, each cell containing an arbitrary number of ports attached to said cell, no port being attached to more than one cell, the cell to which a port is attached called the parent cell of the port, all attached objects being able to access each others private data, while ports attached to different cells exchange asynchronous messages in real time via TICC™ pathways (hereinafter called pathways) that interconnect them, no port being connected to more than one pathway, there beg three kinds of ports, generalPorts which send out service request messages and receive responses, functionPorts which receive service request messages and respond to them, and interruptPort, a, special kind of functionPorts, which receive only interrupt messages and respond to them, pathways interconnecting generalPorts to functionPorts, each pathway containing exactly one virtualMemory in shared-memory environments and more man one virtualMemory in distributed memory environments, an arbitrary number of agents attached to each virtualMemory, no agent being attached to more than mm virtualMemory, virtualMemories of pathways holding messages that are transmitted over the pathways as well as providing execution environments for pthreads that are used to process and respond to the messages, each pathway being associated with a communication protocol (hereinafter referred to simply as protocol) which win executed will deliver the message in the virtualMemory of said pathway to its intended recipients connected to said pathway, it being possible for different pathways to have different protocols associated with them, it also being possible to simultaneously execute any collection of protocols assorted with distinct pathways in parallel by different cells in an Rtas, the collection of all cells and pathways interconnecting ports of cells being called the Rtas-network, each cell in the being automatically activated in real time by messages it receives, with no need for external scheduling, each cell when activated executing pthreads in order to respond to received messages in parallel with all other cells in the Rtas-network, each cell exchanging messages with other cells in the network in parallel via pathways connected to ports of said cell without using an operating system, messages being exchanged immediately as soon as they are ready, each cell being capable of receiving simultaneously several asynchronous messages in parallel, each cell running in a processor in such a manner that the times at which message sending and receiving events occur in the Rtas-network cause correct automatic coordination of the real time operation of the Rtas as per its specification, thus enabling realization of real time software Using real time asynchronous messaging, the method comprising the following steps of:
installing and modifying cells and pathways in the Rtas-network;
allocating real memories to virtualMemories in the network from memory areas of hardware memory units, which may be commonly shared by several processors, such memory units being called shared memories;
allocating real memories to virtualMemories from a collection of distributed hardware memory units interconnected by a local area communication network called TICCNET™, where each distributed hardware memory, may, be a, shared-memory unit, shared by a processor-group containing one or more processors, each processor in said processor-group being assigned to run a unique cell;
organizing cells into cell-groups, cells in a cell-group always receiving a common message and jointly processing the message, each cell in the cell-group rung in parallel with other cells in the said group, each in its own assigned processor, all cells in the cell-group always sharing the same virtualMemory, the real memory allotted to the said virtualMemory being always from the shared-memory all processors a to cells in the said cell-group;
enabling cells in a cell-group to share data with each other wile they are processing a common message in parallel in order to coordinate their activities;
allocating real memories to virtualMemories in pathways in a manner that minimize memory blocking and memory contention and thus contribute to scalability;
dynamically automatically allocating a processor to each cell in the network and real memories to virtualMemories in an Rtas-network, when necessary, so that cells in each cell-group are allocated to processors in corresponding processor group, and all said processors and cells have access to a common shared-memory unit;
causing generalPorts in a network to send out service requests when necessary and starting, stopping and suspending computations when needed by sending interrupt signals to the interruptPorts of cells;
tuning agents and ports on each pathway to each other so that each port/agent will be always ready to receive and immediately respond to signals sent by another agent/port on the same pathway, this being an important characteristic of pathways that enables high-speed message transmission with guaranteed message delivery without using synchronization session;
guaranteeing that messages would be delivered to their intended recipients asynchronously with in a priori specified and verified time delays in real time, the time delays being called message delivery latencies;
guaranteeing that messages would be delivered in the same temporal order in which said messages were sent;
dynamically forming port-groups, which can broadcast messages to each other, all ports in any port-group being either generalPorts, or functionPorts or interruptPorts, each port in a port-group belonging to a distinct cell and no two port-groups containing the same port, port-groups containing only generalPorts being cab generalPort-groups, port-groups containing only functionPorts being called functionPort-groups, port-groups containing only interruptPorts being called interruptPort-groups;
enabling ports in a generalPort-group to send out messages jointly written by parent cells of pats in the said port-group in parallel with each other, generalPort-groups sending out service request to functionPort-groups and functionPort-groups in turn sending back response messages to said generalPort-groups, there being always exactly one pathway inter each such generalPort-group to its corresponding functionPort-group;
using agents on a pathway connected to ports in a message sending generalPort-group to coordinate messages dispatch over a pathway, guaranteeing that said message would be dispatched only after all ports in the said generalPort-group have completed writing their respective contributions to the joint message in the virtualMemory of the pathway and the jointly sent message would be delivered to a receiving functionPort-group exactly once;
using agents on a pathway to synchronize message delivery to ports in a receiving port-group to which the message in the virtualMemory of said pathway is being delivered;
guaranteeing that messages would be always delivered to cells in an Rtas-network asynchronously, the number of messages that may be simultaneously so delivered in parallel to any such cell being limited only by the number of ports attached to that cell, the virtualMemory of each pathway connected to each port of said cell hoeing exactly one pending message to be serviced by said cell, the virtualMemories of all pathways connected to the ports of said cell thus providing for said cell a parallel buffering mechanism to hold pending messages to be serviced by said cell;
guaranteeing that a second message from any generalPort-group will be sent to its corresponding receiving functionPort-group via any pathway, only after the generalPort-group had received a response from the functionPort-group for the first message, sent via said pathway, signifying that the functionPort-group had fully completed processing the first message, thereby assuring that no virtualMemory of any pathway in an Rtas-network would ever hold more than one pending message at a time, even though messages are exchanged asynchronously;
guaranteeing that every computation that was started when a sending generalPort-group sent out a service request message to a receiving functionPort-group will eventually cause the sending generalPort group to receive a response message from the receiving functionPort-group to which said service request message was sent;
dynamically installing new cells, new ports to cells and new pathways in an Rtas-network, or dynamically removing cells, ports and pathways already existing in an Rtas-network and its associated TICCNET™ without service interruption and without loss of data;
developing automatically for each Rtas a dynamic self motoring event recognition and reporting subsystem (hereinafter referred to as the self-monitoring subsystem), that runs in parallel with the Rtas without interfering with the real time characteristics of the Rtas; and
developing self-diagnosis and self-repair facilities for the Rtas using the self-monitoring subsystem.

2: Method as recited in claim 1 further including steps for organizing and running parallel programs in the Rtas defined by a collection of pthreads satisfying specified real time constraints, there being greater than one of sod pthreads, each said pthread running sequentially, but in parallel with all other pthreads and all pthread together performing the intended parallel computations of the Rtas by employing the following additional steps:
distributing said pthreads among virtualMemories in the network at the rate of one or more pthreads per virtualMemory, pthreads assigned to a virtualMemory being called the pthreads of ports connected to the pathway that contains the virtualMemory, pairs of ports attached to a cell being said to be mutually independent if no one port in a pair of ports uses data generated by the other port in the same pair, each cell in a network containing one or more such mutually independent pairs of ports,
causing each cell to poll the ports attached to it, such polling causing said cell to receive and service at each polled port the message, if any, that had been already delivered to that port, by activating a pthread of said port, the pthread uniquely corresponding to said delivered message, messages delivered to said ports being serviced in the order determined by the time instances at which they were delivered to the ports of said cell or according to any other dynamically determined ordering criteria, at any time the activated pthread of a port of said cell uniquely corresponding to message received at said port, the activated pthread being called the active pthread of the parent cell of said port;
receipt of a message at any port of a cell causing automatically, without assistance from an operating system, execution by said cell of the activated pthread of said port, the activated pthread being the pthread that is needed to perform computations to process and respond to the received message, response being mandatory only for service request messages received at functionPorts;
enabling each cell in an Rtas-network to execute no more than one pthread at any time, said pthread being called the active pthread of said cell, pthreads of ports attached to each cell being activated one after the other in the order in which messages delivered to the ports of said cell were processed;
enabling each active pthread to complete its computations even if such computations were suspended before completion and later resumed, without assistance from an operating system, said computations being always the computations necessary to process and respond to a received message;
enabling each active pthread of a port to cause message to be sent by its parent cell, by invoking the protocol of the pathway attached to said port and causing the parent cell to execute the protocol, in parallel with all other active pthreads of other cells in an Rtas-network, without mutual interference and without invoking assistance from an operating system, the number of messages being sent at any one time in the Rtas-network being limited only by the number of active pthreads in the network at that time;
enabling functionPorts of a cell to spawn new computations by sending new service requests via generalPorts of said cell in order to complete computations that were started to process and respond to the service requests received at said functionPorts, it being not necessary for the functionPorts that so spawned new computations to wait for responses from the newly spawned computations, but instead the said functionPorts may suspend their current computations allowing the said cell to poll and service its other int ports, said functionPorts resuming their suspended computations after said generalPorts had received responses from said newly spawned computations;
guaranteeing that every generalPort that sent a service request will always receive a response, independent of the number of. times new computations were spawned during the service of that service request;
enabling active pthreads of different cells in an Rtas-network to perform computations in parallel and exchange messages in parallel, parallel computations terminating when all computations performed by all pthreads associated will all ports in the network terminate their respective computations and no pthread is activated again, causing the application system to perform precisely the intended computation of the application system, or parallel computations continuing forever with no termination, in case cells in a network are repeatedly activated by new messages received by them;
suspending and resuming computations performed by said pthreads, if necessary, based on received interrupt signals without loss of data and without invoking assistance from any operating system associated with the processors in which the said threads run;
enabling control flow of computations in an Rtas-network to be always isomorphic to message flow, with no need to specify activation scheduling, pthread synchronization and pthread coordination in parallel program execution;
specifying increasing level numbers to control increasing precision of timings, synchronization and coordination of parallel pthread execution, levels of said timing, synchronization and coordination being chosen by the application system programmer from an available pool of three level numbers; and
automatically enforcing application system data security and privilege specifications at times of message deliveries, cell and pathway installations and dynamic network reconfigurations.

3: Method as recited in claims 1 or 2, further including steps for establishing a distributed communication network called TICCNET™, enabling N>1 multiprocessors in a grid distributed over a geographical region, to exchange messages from one multiprocessor in the grid to a group of other multiprocessors in the same grid allowing messages amounts of data to be exchanged at a rate as high as a trillion bytes or more in 100 seconds over a 300 kilometer wide geographical region using 10 gigabytes/sec or more data transmission lines, the said method comprising of following steps:
building the TICCNET™ with network switches, routers and agents, agents exchanging one or two bit signals with each other and with the network switches to set up needed pathways between a data source, hereinafter referred to simply as source, and a collection of data destinations, hereafter referred to simply as destinations, it being possible to set up a very large number of mutually non-intersecting pathways in the TICCNET™ connecting sources to destinations, through all which messages can be exchanged in parallel at high-speeds;
dynamically removing established pathways and installing new pathways when needed;
specifying protocols for message exchange over established pathways from sources to destinations, with latency limited only by the speed of light, at which signal can travel the distance between sources and destinations over data transmission channels, thus enabling massive amounts of data/second to be exchanged over the pathways; and
specifying protocols such that sources and destinations connected by a pathway in the TICCNET™ and all agents and switches on said pathway would always be tuned to each other, each listening to the other to receive and immediately respond to signals on the pathway without having to come to prior agreement through synchronization sessions, thus enabling any source to send data to any destination connected by a pathway at any time, prod that the pathway is not already engaged in transmitting data at the said time.

4: Method as recited in claims 1, 2 or 3 further including steps for automatically installing and running an event monitoring system, consisting of one or more event activity builder calls and one or more event analyzer cells, the builder cells constructing the activity diagram of message sending and message receiving event occurrences at generalPort-groups in an Rtas, in parallel with computations being performed in the Rtas, the activity diagram representing the temporal order in which said sending and receiving events occur, timings at which any two such events occur being either in the order of one before the other (one causing the other) or said timing being incomparable to each other, the activity diagram thus being a partial ordering of message sending and message receiving event occurrences in the Rtas, the analyzer cells analyzing the activity diagrams as they are being built to recognize a priori defined observable events, observable events being defined as regular expressions in the alphabet of names of nodes in the activity diagram, the only events of significance to said analyzers' ability to recognize any observable event being the message sending and message receiving events at generalPort-groups in the Rtas network, the said method consisting of the following steps:
enabling each generalPort-group in an Rtas-network to send signals to a designated activity builder, every time the said generalPort-group sends or receives a message, indicating whether the event being reported to the said activity builder is a message sending event or a message receive event;
enabling activity builder cells to receive signals reporting occurrences of message sending and message receiving events from their respective designated generalPort-groups in an Rtas-network, all activity builders using said signals to build and periodically update a common activity diagram that uniquely represents occurrences of said events in. said Rtas, making sure that no two activity builder cells will interfere with each other while updating the common activity diagram;
enabling activity builder cells as a group to periodically inform the group of activity analyzers when the activity diagram of said Rtas is ready to be analyzed for recognition of a priori defined observable events;
enabling activity builders and activity analyzers to synchronize and coordinate their respective building/updating and analyzing activities;
enabling activity analyzers to make reports of recognized observable events and save them, or produce immediate ater as necessary;
enabling system designers to specify observable events as regular expressions in the alphabet of names of nodes that may appear in the activity diagram of an Rtas and assign to each activity analyzer the set of observable events that it should recognize and report;
enabling system designers to dynamically update observable event specifications as and when necessary; and
enabling the entire monitoring network consisting of all activity builders and all activity analyzers to run in parallel with Rtas without in any way interfering with activities of said Rtas or causing the Rtas to violate any of it's a priori specified timing and input/output constraints.

5: Method as recited in claims 1, 2, 3 or 4, further including steps of:
starting and stopping parallel programs;
specifying parallel breakpoints in pathways in an Rtas-network to temporarily suspend parallel computations in cells whose ports are connected to said pathways and examine data in virtual memories of said pathways, in order to dynamically debug said Rtas;
dynamically testing new versions of cells in an Rtas-network, in parallel with old versions, in the same Rtas-network context in which the old versions operate, and after satisfactorily completing the test, replacing the old versions with the new versions, without interfering with ongoing thus enabling dynamic evolution of said Rtas;
encapsulating any well-defined network, consisting of cells with attached ports connected to pathways with agents and virtual memories, in to a software component, which can be plugged into a larger network contain matching port interfaces, in a manner similar to the way a hardware module may be plugged into a larger hardware system using matching plug-in connections;
building a library of such components, said components being downloaded from said library and used to build new Rtas applications; and
dynamically displaying parallel outputs while an Rtas is running, without interfering with ongoing operations.

6: Method as recited in claims 1, 2, 3, 4 or 5 further including steps for
dividing Rtas design and development into three distinct stages: the first specifying cell interactions through message sending and receiving events, the second specifying and implementing pthreads used in computations for processing messages, the third integrating cell interaction specifications with pthread implementations and testing the integrated system for certification, the cell interaction specifications being the only ones that would contain programming statements specifying interactions among cells, it being true that no pthread in an Rtas would ever contain any such cell interaction programming statements, thereby guaranteeing that every pair of pthreads in an Rtas would be mutually independent of each other, cell interactions being specified at levels of abstractions chosen by system designer in an executable programming language, it being possible to execute cell interaction specifications with simulated pthread execution times before defining the pthreads in an Rtas, such simulated cell interaction executions being called design test and verification runs;
enabling system designers to use design test verification runs to modify Rtas design as necessary, to test and develop timing constraints for yet to be implemented pthreads of said Rtas, develop input/output characterizations of pthreads needed for said Rtas, and finalize the Rtas-network;
enabling system designers to define, test and verify that each pthread implementation satisfies the timing and input/output characteristics developed for said pthread, independent of all other pthreads of an Rtas;
enabling system designers to analyze an Rtas-network to find potential deadlocks and eliminate them;
enabling system builders to integrate cell interaction specifications with pthread definitions and run the integrated system for verification and certification of the fully implemented Rtas.

7: Method as recited in claims 1, 2, 3, 4, 5 or 6 further including steps for designing and implementing any distributed parallel program, whether it is an Rtas or not, employing the same methods described in claims 1 through 6.
